(19) United States
(12) Patent Application Publication
(10) Pub. No.: US 2026/0330693 A1
(43) Pub. Date: Oct. 22, 2026

(54) INFORMATION PROCESSING APPARATUS AND METHOD

(71) Applicant: Sony Group Corporation, Tokyo (JP)

(72) Inventors: Ryohei TAKAHASHI, Tokyo (JP); Mitsuhiro HIRABAYASHI, Tokyo (JP)

(73) Assignee: Sony Group Corporation, Tokyo (JP)

(21) Appl. No.: 19/113,940

(22) PCT Filed: Sep. 28, 2023
(86) PCT No.: PCT/JP2023/035354

§ 371 Date: Mar. 21, 2025

Related U.S. Application Data
(60) Provisional application No. 63/377,770, filed on Sep. 30, 2022.

(51) Int. Cl. G06T 9/00; G06T 15/04; G06T 17/00

(52) U.S. Cl. CPC G06T 9/001; G06T 15/04; G06T 17/00; G06T 2210/36

(57) ABSTRACT

The present disclosure relates to information processing apparatus and method that enable an increase in processing load related to reconstruction of 3D data including displacement vectors to be suppressed. A base mesh and attributes are encoded, displacement vectors are encoded for each of layers of levels of detail, a content file is generated, encoded data of the base mesh is stored in a base-mesh track of the content file, encoded data of the attributes is stored in an attribute track of the content file, encoded data of the displacement vectors for each of the layers is stored in mutually different displacement tracks of the content file, and association information for associating the displacement tracks with the layers is stored in the content file. The present disclosure can be applied to, for example, an information processing apparatus or an information processing method.

### TECHNICAL FIELD

The present disclosure relates to information processing apparatus and method and, more particularly, relates to information processing apparatus and method that enable an increase in processing load related to reconstruction of 3D data including displacement vectors to be suppressed.

### BACKGROUND ART

Conventionally, there has been V-DMC (Video-based Dynamic Mesh Coding) as a method of encoding meshes, which are 3D data that represent the three-dimensional structure of an object by means of vertices and connections (e.g., see Non-Patent Literature 1). In the V-DMC, a mesh as an encoding target (original mesh) is represented by a coarser (i.e., lower level of detail) base mesh, displacement vectors of division points obtained by subdividing the base mesh, textures, and atlas information used for reconstruction, and each of them is encoded. It should be noted that the displacement vectors can be layered in accordance with the level of detail (subdivision iteration count of the base mesh).

In recent years, it has been expected to establish a method to store and deliver this V-DMC encoded bitstream (also referred to as V-DMC bitstream) in ISOBMFF (International Organization for Standardization Base Media File Format) or other formats. The ISOBMFF is a file container specification of “MPEG-4 (Moving Picture Experts Group-4),” an international standard technology for video compression (e.g., see Non-Patent Literatures 2 and 3). For example, it can be assumed that the V-PCC delivery technology standard, ISO/IEC 23090-10 (e.g., see Non-Patent Literature 4), is extended and standardized. In that case, the V-DMC bitstream is stored in the ISOBMFF track.

### CITATION LIST

### Patent Literature

### Non-Patent Literature

Non-Patent Literature 1: Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m59281, April 2022
Non-Patent Literature 2: “Information technology—Coding of audio-visual objects—Part 12: ISO base media file format, TECHNICAL CORRIGENDUM 1,” ISO/IEC 14496-12:2015/Cor.1, ISO/IEC JTC 1/SC 29/WG 11, 2016 Jun. 3, 7th edition, 2022-01
Non-Patent Literature 3: “Information technology—Coding of audio-visual objects—Part 15: Carriage of network abstraction layer (NAL) unit structured video in the ISO base media file format,” ISO/IEC FDIS 14496-15:2014 (E), ISO/IEC JTC 1/SC 29/WG 11, 2014 Jan. 13, ISO/IEC 14496-15:2019, 5th edition, 2019-09
Non-Patent Literature 4: “Text of ISO/IEC FDIS 23090-10 Carriage of Visual Volumetric Video-based Coding Data,” ISO/IEC JTC 1/SC 29/WG 03 N00241, 2021 Aug. 20, ISO/IEC 23090-10:2022, 1st edition, 2022-05

### DISCLOSURE OF INVENTION

### Technical Problem

However, if the entire stream of displacement vectors (displacement video) is stored in a single track, it has been necessary to acquire and decode the stream of displacement vectors of all layers from the track when decoding the displacement vectors. This may unnecessarily increase the processing load related to reconstruction.

The present disclosure has been made in view of such circumstances to enable an increase in processing load related to reconstruction of 3D data including displacement vectors to be suppressed.

### Solution to Problem

An information processing apparatus according to an aspect of the present technology is an information processing apparatus including: an encoding unit that encodes a base mesh and attributes and encodes displacement vectors for each of layers of levels of detail; and a content file generation unit that generates a content file, stores encoded data of the base mesh in a base-mesh track of the content file, stores encoded data of the attributes in an attribute track of the content file, stores encoded data of the displacement vectors for each of the layers in mutually different displacement tracks of the content file, and stores first association information for associating the displacement tracks with the layers in the content file, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, and the displacement vectors are vector information indicating displacement of vertices obtained by subdividing the base mesh.

An information processing method according to an aspect of the present technology is an information processing method including: encoding a base mesh and attributes and encoding displacement vectors for each of layers of levels of detail; and generating a content file, storing encoded data of the base mesh in a base-mesh track of the content file, storing encoded data of the attributes in an attribute track of the content file, storing encoded data of the displacement vectors for each of the layers in mutually different displacement tracks of the content file, and storing association information for associating the displacement tracks with the layers in the content file, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, and the displacement vectors are vector information indicating displacement of vertices obtained by subdividing the base mesh.

An information processing apparatus according to another aspect of the present technology is an information processing apparatus including: an acquisition unit that acquires encoded data of a base mesh and encoded data of attributes from a content file and acquires, on the basis of first association information for associating displacement tracks with layers of levels of detail of a mesh, encoded data of displacement vectors from the displacement track corresponding to a desired layer of the layers of the content file; a decoding unit that decodes each of the acquired encoded data of the base mesh, the acquired encoded data of the attributes, and the acquired encoded data of the displacement vectors; and a reconstruction unit that reconstructs the mesh of the desired layer by using the base mesh, the attributes, and the displacement vectors that are obtained by the decoding, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, the displacement vectors are vector information indicating displacement of vertices obtained by subdividing the base mesh, and the content file includes a base-mesh track that stores the encoded data of the base mesh, an attribute track that stores the encoded data of the attributes, and a plurality of the displacement tracks that stores the encoded data of the displacement vectors of the mutually different layers.

An information processing method according to another aspect of the present technology is an information processing method including: acquiring encoded data of a base mesh and encoded data of attributes from a content file and acquiring, on the basis of association information for associating displacement tracks with layers of levels of detail of a mesh, encoded data of displacement vectors from the displacement track corresponding to a desired layer of the layers of the content file; decoding each of the acquired encoded data of the base mesh, the acquired encoded data of the attributes, and the acquired encoded data of the displacement vectors; and reconstructing the mesh of the desired layer by using the base mesh, the attributes, and the displacement vectors that are obtained by the decoding, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, the displacement vectors are vector information indicating displacement of vertices obtained by subdividing the base mesh, and the content file includes a base-mesh track that stores the encoded data of the base mesh, an attribute track that stores the encoded data of the attributes, and a plurality of the displacement tracks that stores the encoded data of the displacement vectors of the mutually different layers.

An information processing apparatus according to still another aspect of the present technology is an information processing apparatus including: an encoding unit that encodes a base mesh and attributes and encodes displacement vectors for each of layers of levels of detail; a content file generation unit that generates a content file, stores encoded data of the base mesh in a base-mesh track of the content file, stores encoded data of the attributes in an attribute track of the content file, and stores encoded data of the displacement vectors for each of the layers in mutually different displacement tracks of the content file; and a control file generation unit that generates a control file including control information for controlling delivery of the content file and stores first association information for associating displacement adaptation sets that manage the displacement tracks with the layers in the control file, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, and the displacement vectors are vector information indicating displacement of vertices obtained by subdividing the base mesh.

An information processing method according to still another aspect of the present technology is an information processing method including: encoding a base mesh and attributes and encoding displacement vectors for each of layers of levels of detail; generating a content file, storing encoded data of the base mesh in a base-mesh track of the content file, storing encoded data of the attributes in an attribute track of the content file, and storing encoded data of the displacement vectors for each of the layers in mutually different displacement tracks of the content file; and generating a control file including control information for controlling delivery of the content file and storing association information for associating displacement adaptation sets that manage the displacement tracks with the layers in the control file, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, and the displacement vectors are vector information indicating displacement of vertices obtained by subdividing the base mesh.

An information processing apparatus according to still another aspect of the present technology is an information processing apparatus including: a selection unit that selects, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file; an acquisition unit that acquires encoded data of the base mesh and encoded data of the attributes, which are stored in the content file, and acquires encoded data of the displacement vector, which is stored in a displacement track of the content file, the displacement track being managed by the selected displacement adaptation set; a decoding unit that decodes each of the acquired encoded data of the base mesh, the acquired encoded data of the attributes, and the acquired encoded data of the displacement vectors; and a reconstruction unit that reconstructs the mesh of the desired layer by using the base mesh, the attributes, and the displacement vectors that are obtained by the decoding, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, the displacement vectors are vector information indicating displacement of vertices obtained by subdividing the base mesh, the content file includes a base-mesh track that stores the encoded data of the base mesh, an attribute track that stores the encoded data of the attributes, and a plurality of the displacement tracks that stores the encoded data of the displacement vectors of the mutually different layers, and the control file includes a base-mesh adaptation set that manages the base-mesh track, an attribute adaptation set that manages the attribute track, and the displacement adaptation sets that manage the displacement tracks.

An information processing method according to still another aspect of the present technology is an information processing method including: selecting, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file; acquiring encoded data of the base mesh and encoded data of the attributes, which are stored in the content file, and acquiring encoded data of the displacement vector, which is stored in a displacement track of the content file, the displacement track being managed by the selected displacement adaptation set; decoding each of the acquired encoded data of the base mesh, the acquired encoded data of the attributes, and the acquired encoded data of the displacement vectors; and reconstructing the mesh of the desired layer by using the base mesh, the attributes, and the displacement vectors that are obtained by the decoding, in which the base mesh is a mesh that is generated by decimating vertices from an original mesh as an encoding target, the original mesh being constituted by vertices and connections representing a three-dimensional structure of an object, the mesh being lower in the level of detail than the original mesh, the attributes include textures that are applied to surfaces of the original mesh, the displacement vectors are vector information indicating displacement of vertices obtained by subdividing the base mesh, the content file includes a base-mesh track that stores the encoded data of the base mesh, an attribute track that stores the encoded data of the attributes, and a plurality of the displacement tracks that stores the encoded data of the displacement vectors of the mutually different layers, and the control file includes a base-mesh adaptation set that manages the base-mesh track, an attribute adaptation set that manages the attribute track, and the displacement adaptation sets that manage the displacement tracks.

In the information processing apparatus and method according to the aspect of the present technology, a base mesh and attributes are encoded, displacement vectors are encoded for each of layers of levels of detail, a content file is generated, encoded data of the base mesh is stored in a base-mesh track of the content file, encoded data of the attributes is stored in an attribute track of the content file, encoded data of the displacement vectors for each of the layers is stored in mutually different displacement tracks of the content file, and association information for associating the displacement tracks with the layers is stored in the content file.

In the information processing apparatus and method according to the other aspect of the present technology, encoded data of a base mesh and encoded data of attributes are acquired from a content file, encoded data of displacement vectors is acquired from the displacement track corresponding to a desired layer of the layers of the content file on the basis of association information for associating displacement tracks with layers of levels of detail of a mesh, each of the acquired encoded data of the base mesh, the acquired encoded data of the attributes, the acquired encoded data of the displacement vectors is decoded, and the mesh of the desired layer is reconstructed by using the base mesh, the attributes, and the displacement vectors that are obtained by the decoding.

In the information processing apparatus and method according to the still other aspect of the present technology, a base mesh and attributes are encoded, displacement vectors is encoded for each of layers of levels of detail, a content file is generated, encoded data of the base mesh is stored in a base-mesh track of the content file, encoded data of the attributes is stored in an attribute track of the content file, encoded data of the displacement vectors for each of the layers is stored in mutually different displacement tracks of the content file, a control file including control information for controlling delivery of the content file is generated, and association information for associating displacement adaptation sets that manage the displacement tracks with the layers is stored in the control file.

In the information processing apparatus and method according to the still other aspect of the present technology, on the basis of first association information for associating displacement adaptation sets with layers of levels of detail of a mesh, one of the displacement adaptation sets, which corresponds to a desired layer of the layers, is selected, the first association information being stored in a control file including control information for controlling delivery of the content file, encoded data of the base mesh and encoded data of the attributes, which are stored in the content file, are acquired, encoded data of the displacement vector, which is stored in a displacement track of the content file, is acquired, the displacement track being managed by the selected displacement adaptation set, each of the acquired encoded data of the base mesh, the acquired encoded data of the attributes, the acquired encoded data of the displacement vectors is decoded, and the mesh of the desired layer is reconstructed by using the base mesh, the attributes, and the displacement vectors that are obtained by the decoding.

### BRIEF DESCRIPTION OF DRAWINGS

FIG. 1 A diagram for describing a mesh.

FIG. 2 A diagram for describing V-DMC.

FIG. 3 A diagram showing a configuration example of a V-DMC bitstream.

FIG. 4 A diagram for describing layering of displacement vectors.

FIG. 5 A diagram showing an example of a V-DMC bitstream delivery method.

FIG. 6 A diagram showing an example of a main track configuration of a content file in a case where relative displacement vectors is included.

FIG. 7 A diagram showing an example of a main track configuration of a content file in a case where of absolute displacement vectors.

FIG. 8 A diagram showing an example of relative displacement vectors and absolute displacement vectors.

FIG. 9 A diagram showing an association information example.

FIG. 10 A diagram showing an example of type information and quality information.

FIG. 11 A diagram showing an association information example and type information.

FIG. 12 A diagram showing an MPD description example.

FIG. 13 A diagram showing an example of quality information.

FIG. 14 A diagram showing an MPD description example.

FIG. 15 A diagram showing an association information example.

FIG. 16 A diagram showing an association information example.

FIG. 17 A diagram showing an example of grouping information.

FIG. 18 A diagram showing an example of grouping information. [FIG. 19] A diagram showing an example of grouping information.

FIG. 20 A diagram showing an example of grouping information.

FIG. 21 A diagram showing an example of grouping information.

FIG. 22 A diagram showing an MPD description example.

FIG. 23 A diagram showing an MPD description example.

FIG. 24 A diagram showing an MPD description example.

FIG. 25 A diagram showing an association information example.

FIG. 26 A diagram showing an association information example.

FIG. 27 A diagram showing an MPD description example.

FIG. 28 A diagram showing an MPD description example.

FIG. 29 A diagram showing a configuration example of a Matroska media container.

FIG. 30 A block diagram showing a main configuration example of a file generation apparatus.

FIG. 31 A flowchart describing an example of a flow of file generation processing.

FIG. 32 A flowchart describing an example of the flow of the file generation processing.

FIG. 33 A block diagram showing a main configuration example of a playback apparatus.

FIG. 34 A flowchart describing an example of a flow of playback processing.

FIG. 35 A flowchart describing an example of the flow of the playback processing.

FIG. 36 A flowchart describing an example of the flow of the playback processing.

FIG. 37 A flowchart describing an example of the flow of the playback processing.

FIG. 38 A block diagram showing a main configuration example of a computer.

### MODE(S) FOR CARRYING OUT THE INVENTION

Hereinafter, modes for carrying out the present disclosure (hereinafter, referred to as embodiments) will be described. It should be noted that the descriptions will be given in the following order.

1. Documents, etc. that Support Technical Contents and Technical Terminology

2. V-DMC and Delivery Thereof

3. Playback Control for Each Layer of Displacement Vectors

4. Playback Control for Each Layer of Attributes

5. Matroska Media Container

6. First Embodiment (File Generation Apparatus)

7. Second Embodiment (Playback Apparatus) Appendix

### 1. DOCUMENTS, ETC. THAT SUPPORT TECHNICAL CONTENTS AND TECHNICAL TERMINOLOGY

The scope disclosed by the present technology includes not only the contents described in the embodiments, but also the contents described in Non-Patent Literatures below and the like which are well-known at the date of filing this application and the contents of other documents and the like referenced in Non-Patent Literatures below.
Non-Patent Literature 1: (mentioned above)
Non-Patent Literature 2: (mentioned above)
Non-Patent Literature 3: (mentioned above)
Non-Patent Literature 4: (mentioned above)

That is, the contents described in Non-Patent Literatures above, the contents of the other documents referenced in Non-Patent Literatures above, and the like are also the basis for determining support requirements.

### 2. V-DMC AND DELIVERY THEREOF

### <Mesh>

Conventionally, as 3D data representing a three-dimensional structure of a three-dimensional structural object (object with a three-dimensional shape), there has been a mesh that represents a three-dimensional shape of an surface of the object by forming polygons with vertices and connections (also referred to as edges).

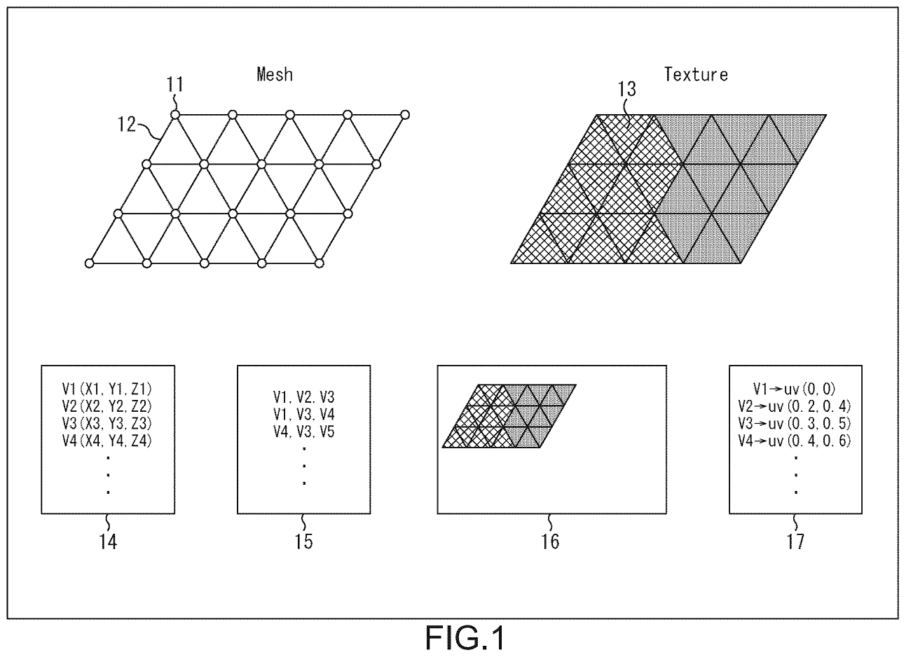

As shown in the upper left part of FIG. 1, in a mesh, polygonal planes (polygons) are formed by vertices 11 and connections 12 connecting the vertices 11 to one another. Hereinafter, the polygons will be described as triangles. The polygons (also referred to as faces) represent surfaces of an object having a three-dimensional structure, i.e., a three-dimensional shape of the object. It should be noted that a texture 13 can be attached (also referred to as applied) to each face of this mesh.

Data of the mesh is constituted by information as shown at the bottom of FIG. 1, for example. Vertex information 14, which is shown first from the left at the bottom of FIG. 1, is information indicating the three-dimensional position information (three-dimensional coordinates (X, Y, Z)) of each vertex 11 constituting the mesh. Connection information 15, which is shown second from the left at the bottom of FIG. 1, is information indicating each connection (edge) 12 constituting the mesh. A texture image 16, which is shown third from the left at the bottom of FIG. 1, is map information of the textures 13 that are attached to the respective faces. A UV map 17, which is shown fourth from the left at the bottom of FIG. 1, is information indicating a corresponding relationship between the vertices 11 and the texture 13. In the UV map 17, coordinates (UV coordinates) of each vertex 11 in the texture image 16 are shown.

### <V-DMC>

There has been V-DMC (Video-based Dynamic Mesh Coding), for example, as disclosed in Non-Patent Literature 1, as an encoding method for such a mesh.

In the V-DMC, the mesh as an encoding target (also referred to as an original mesh herein) is represented by a base mesh that is lower in level of detail (i.e., coarser) than the original mesh and displacement vectors of division points obtained by subdividing the base mesh, and the base mesh and the displacement vectors are encoded. For example, a dynamic mesh stream, which is non-registered mesh data generated by camera capture and whose structure changes every frame, is set as an encoding target.

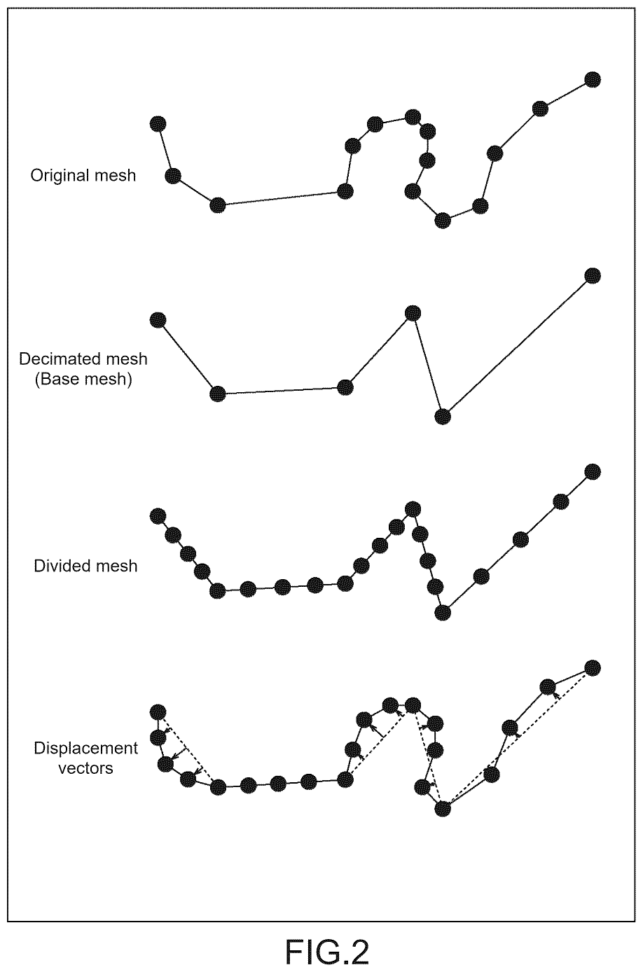

For example, it is assumed that the original mesh exists as shown in the top row of FIG. 2. In FIG. 2, the black dots show vertices and the lines connecting the black dots show connections (edges). As described above, a mesh originally forms plane (polygons) with vertices and edges in a space, but here, for the sake of description, it is assumed that it is a group of vertices connected in a line (in series) in the plane.

By decimating some of the vertices of the original mesh, a coarser (lower level of detail) mesh is formed as shown in the second row from the top in FIG. 2. This will be referred to as a base mesh.

By subdividing each polygon of the base mesh, vertices and edges are added as shown in the third row from the top in FIG. 2. For example, by this subdivision, as many vertices as the number of vertices decimated from the original mesh can be added. That is, by subdividing the base mesh, a mesh with the same number of vertices as the original mesh is obtained. Herein, the vertices added by such subdivision will be also referred to as division points.

However, since the connections are updated when the vertices of the original mesh are decimated and the division points are formed on these updated connections (edges), the shape of this subdivided base mesh (third row from the top in FIG. 2) is different from that of the original mesh (top row in FIG. 2). More specifically, as shown at the bottom row of FIG. 2, the positions of the division points (on the dotted line) are different from those of the original mesh. In other words, the original mesh can ideally be restored by moving (displacing) the positions of the subdivided base mesh's division points to the original mesh's vertex positions. Herein, such displacement (movement) of the division points, which is shown as vectors, will be referred to as displacement vectors.

That is, ideally, the original mesh can be represented as a base mesh and displacement vectors. The number of polygons (i.e., the number of vertices and edges) is reduced by representing the original mesh as a base mesh and displacement vectors in this manner. Thus, by encoding the base mesh and the displacement vectors instead of encoding the original mesh, a reduction in coding efficiency (increase in code amount) can be suppressed.

That is, in the V-DMC, V-DMC data including a base mesh, displacement vectors, textures, and atlas information is generated from the mesh data shown in FIG. 1, and the V-DMC data is encoded. The mesh data is converted into V-DMC data and encoded independently for each frame (mesh data representing the three-dimensional structure of a three-dimensional structural object at a certain timing). For example, in a case where the encoding target is a dynamic mesh stream, the mesh data in each frame is converted into V-DMC data and encoded. With such a configuration, an increase in code amount of each frame can be suppressed and a reduction in coding efficiency can be suppressed.

### <V-DMC Bitstream>

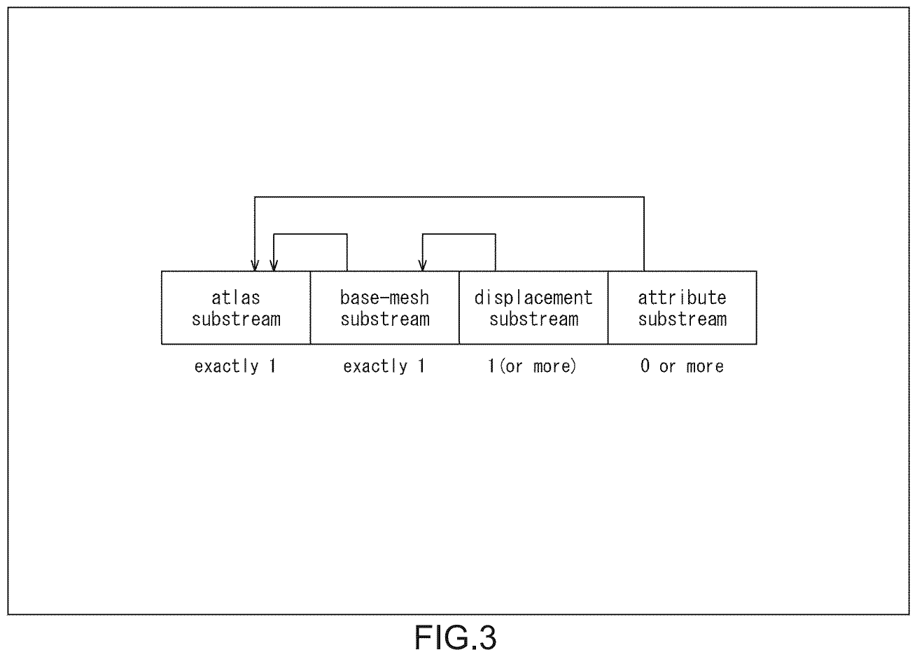

During encoding, the base mesh, displacement vectors, textures, and atlas information are each encoded to generate their respective bitstreams (encoded data). As shown in FIG. 3, a single bitstream (V-DMC bitstream) is generated with the stream of the base mesh, the stream of the displacement vectors, the stream of the textures, and the stream of the atlas information stream as substreams.

The atlas information is necessary for reconstruction of the mesh and includes, for example, information indicating relationships between the base mesh, displacement vectors, and textures corresponding to each other. The atlas information can include information for associating patches of the mesh with patches of attributes, such as the UV map 17 in FIG. 1. An atlas substream, which is a substream of the atlas information, is stored with V-PCC (Video-based Point Cloud Compression) syntax and semantics extended.

In a case of an intra-frame, the base mesh is constituted by a static mesh (vertices and connections). In a case of an inter-frame, the base mesh is constituted by motion vectors. That is, the base mesh can include static meshes and motion vectors. A base-mesh substream, which is a substream of the base mesh, is stored with a new data unit (vuh unit type==V3C MD) added to the V-PCC.

The displacement vectors are packed into a frame image and encoded as a moving image (also referred to as a displacement video) using an encoding scheme for moving images. A displacement substream, which is a substream of the displacement vectors (displacement video), is stored in geometry data of the V-PCC.

The attributes (textures) are packed into a frame image (texture image) and encoded as a moving image (also referred to as an attribute video) using an encoding scheme for moving images. An attribute substream, which is a substream of the attributes (attribute video), is stored in attribute data of the V-PCC.

During decoding, the bitstream is decoded by using a decoding method corresponding to the encoding method, and the atlas information, base mesh, displacement vectors, and textures are restored (generated). As described above, the mesh is reconstructed by subdividing the base mesh on the basis of the atlas information, applying the displacement vectors to the respective division points (i.e., displacing the displacement points), and applying the textures to the faces.

### <Layering of Subdivision>

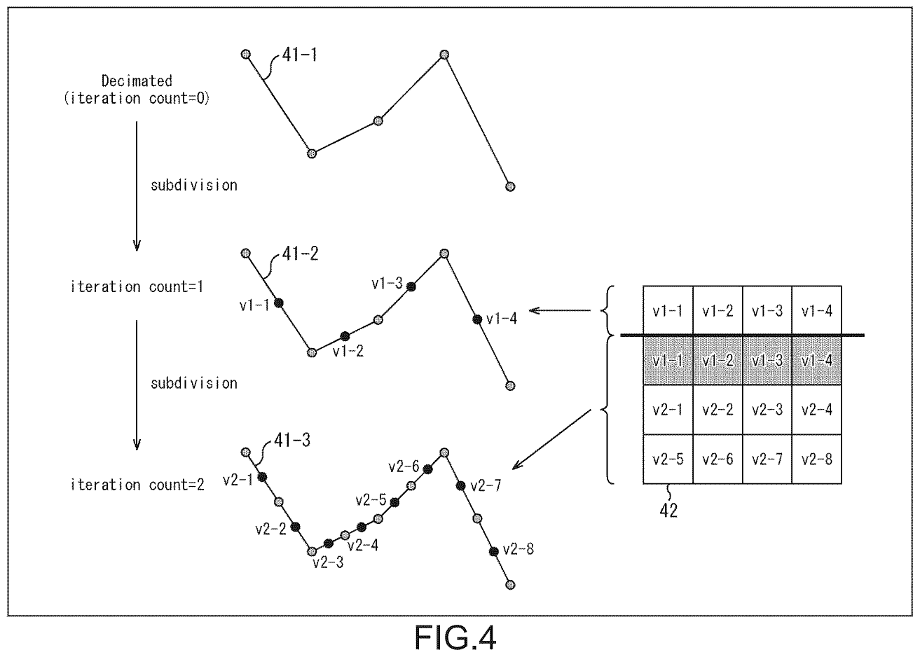

By the way, the subdivision of the base mesh can be iterative processing of subdivision at a predetermined percentage. For example, as shown in FIG. 4, one subdivision may divide an edge into two parts (one vertex is added for each edge), and the subdivision can be repeatedly executed. In this case, repeated subdivisions increase the number of division points and improve the level of detail of the mesh. In the example of FIG. 4, subdividing a base mesh 41-1 once generates division points v1-1 to v1-4, resulting in a mesh 41-2 (iteration count=1). Moreover, subdividing the mesh 41-2 once generates division points v2-1 to v2-8, resulting in a mesh 41-3 (iteration count=2). In this manner, with each repeated subdivision, the number of vertices and connections increases, and the level of detail improves.

In other words, the number of iterations of subdivision can control the level of detail of the resulting mesh. It should be noted that, in order to reconstruct the mesh of each level of detail, the displacement vectors of the division points at each level of detail are required. That is, by layering the displacement vectors in association with the levels of detail of this mesh in the V-DMC data, the repeated processing of subdivision as described above becomes possible, and the level of detail of the mesh to be reconstructed can be controlled. That is, the displacement vectors for each layer should be stored in each frame image in the displacement video.

In a case of the example in FIG. 4, the respective rectangles in a displacement video 42 denote displacement vectors of the respective division points. The symbol, “vn-m,” in the rectangle denote the division point to which the displacement vector corresponds. In the displacement video 42, the displacement vectors are layered, with displacement vectors in the first row from the top (above the thick line) being displacement vectors applied to the division points after the first subdivision, and displacement vectors in the second to fourth rows from the top (below the thick line) being displacement vectors applied to the division points after the second subdivision. It should be noted that the displacement vectors shown in gray in the second row from the top are relative displacement from the positions of the mesh 41-2 (iteration count=1) after applying the displacement vectors.

That is, in a case where the base mesh is subdivided once in reconstruction, the displacement vectors in the first row from the top of the displacement video 42 are applied to the division points v1-1 to v1-4, respectively. Moreover, in a case where the base mesh is subdivided twice in reconstruction, the displacement vectors of the first and second rows from the top of the displacement video 42 are applied to the division points v1-1 to v1-4, respectively. In addition, the displacement vectors of the third and fourth rows from the top of the displacement video 42 are applied to the division points v2-1 to v2-8, respectively.

That is, the displacement vectors of the division points after the first subdivision, the displacement vectors of the division points after the second subdivision, . . . , and so on, are generated after each subdivision, and the iteration count of this subdivision is used as a layer. With such a configuration, by applying the displacement vectors of the layer corresponding to the iteration count of the subdivision performed on the base mesh during reconstruction, a mesh with a level of detail corresponding to the iteration count can be reconstructed.

### <Delivery of V-DMC Bitstream>

In recent years, it has been expected to establish a method to store and deliver this V-DMC encoded bitstream (also referred to as a V-DMC bitstream) in ISOBMFF (International Organization for Standardization Base Media File Format) or the like. For example, as described in Non-Patent Literature 2 and Non-Patent Literature 3, the ISOBMFF is a file container specification of “MPEG-4 (Moving Picture Experts Group-4),” an international standard technology for video compression. In that case, for example, it can be assumed that ISO/IEC 23090-10, the V-PCC delivery technology standard, is extended and standardized, as described in Non-Patent Literature 4. In that case, the V-DMC bitstream is stored in the ISOBMFF track. For example, it is conceivable that substreams of the atlas information, base mesh, displacement vectors, and attributes are stored in the ISOBMFF track, respectively.

However, if the entire stream of displacement vectors (displacement video) is stored on a single track, it has been necessary to acquire and decode the stream of displacement vectors of all layers from the track when decoding displacement vectors. Therefore, even in a case where a mesh lower in level of detail than the original mesh is to be reconstructed (i.e., where the reconstructed mesh does not have the highest level of detail), for example, it has been necessary to acquire and decode the stream of displacement vectors of all layers from the track. That is, it has been necessary to also decode even unnecessary information, which may unnecessarily increase the processing load related to reconstruction. That is, the processing may become inefficient, for example, the performance requirements of the hardware needed to execute the processing may increase or the processing time may increase. Moreover, the inefficient processing may reduce the stability of the processing against external factors such as fluctuations in processing capacity.

### 3. PLAYBACK CONTROL FOR EACH LAYER OF DISPLACEMENT VECTORS

### <Method 1>

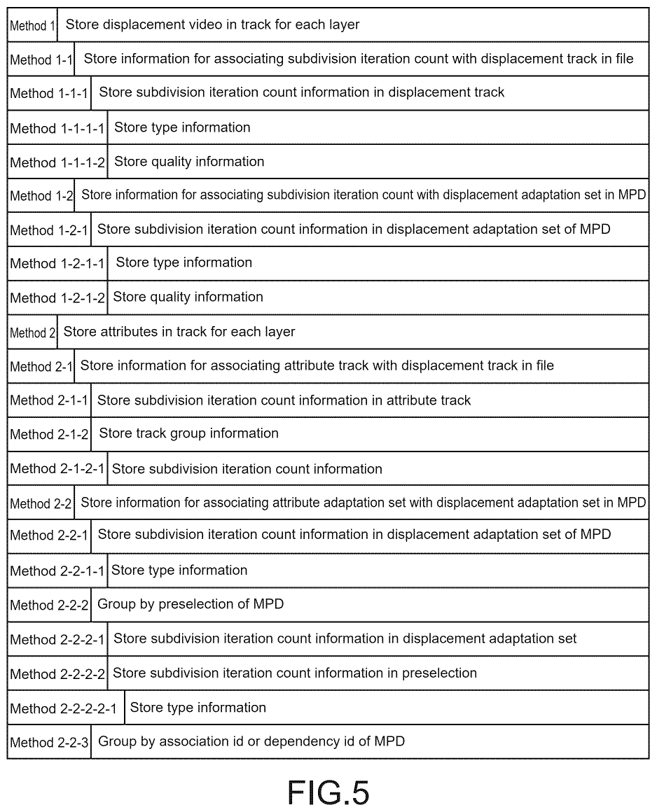

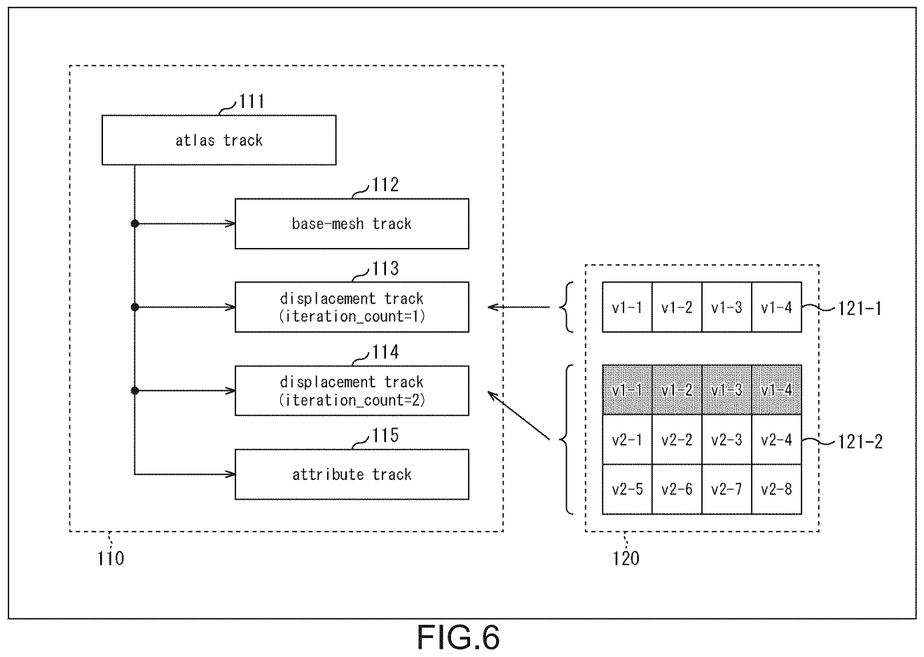

In view of this, a displacement video is stored in content file tracks for each layer as shown in the top row of the table in FIG. 5 (Method 1). For example, the configuration of the tracks is set to be a content file 110 in FIG. 6. As shown in FIG. 6, the content file 110 includes an atlas track 111, a base-mesh track 112, a displacement track 113, a displacement track 114, and an attribute track 115.

The atlas track 111 is a track that stores encoded data (substream) of the atlas information. The base-mesh track 112 is a track that stores encoded data (substream) of the base mesh. The attribute track 115 is a track that stores the encoded data (substream) of the attributes. The displacement track 113 and the displacement track 114 are tracks that store the encoded data (substream) of the displacement vectors. The displacement track 113 stores the displacement vectors of a layer with a subdivision iteration count of 1 (iteration count=1). The displacement track 114 stores the displacement vectors of the layer with a subdivision iteration count of 2 (iteration count=2). It should be noted that in this example, the number of layers of the displacement vectors is 2 and the two displacement tracks are employed, but the number of layers of the displacement vectors can be any number of layers as long as there is a plurality of displacement vectors. Since the displacement vectors for each layer are stored in mutually different tracks of the content file 110, the content file 110 has as many tracks as the number of layers of the displacement vectors. That is, the number of displacement tracks that the content file 110 has can be any number of displacement tracks as long as it is two or more.

In this manner, with each layer of the displacement vectors that are stored in the mutually different tracks of the content file 110, the acquisition (and decoding) of the encoded data of the displacement vectors can be controlled on a track-by-track basis during reconstruction. Thus, for example, the encoded data of the displacement vectors can be acquired and decoded from some displacement tracks. For example, it is possible to select a track that stores the displacement vectors necessary for reconstruction according to the level of detail of the mesh to be reconstructed, and acquire and decode the encoded data of the displacement vectors only from that selected track. Such control can suppress unnecessary acquisition and decoding of displacement vectors, such as acquiring and decoding displacement vectors of a layer higher in level of detail than the mesh to be reconstructed, thereby suppressing an increase in processing load related to reconstruction. Thus, an increase in performance requirements of hardware necessary for executing the processing can be suppressed, and an increase in processing time can be suppressed. That is, the processing related to reconstruction can be performed more efficiently. Thus, a reduction in processing stability can also be suppressed.

### <Relative Displacement Vectors and Absolute Displacement Vectors>

In a case of the example in FIG. 6, the displacement track 113 stores a displacement vector group 121-1 of displacement vectors in a displacement video 120, which are in a layer with a subdivision iteration count of 1 (iteration count=1). That is, the displacement vectors of the division points v1-1 to v1-4 generated in the first subdivision (iteration count=1) are stored in the displacement track 113. In contrast, the displacement track 114 stores a displacement vector group 121-2 of displacement vectors in the displacement video 120, which are in the layer with a subdivision iteration count of 2 (iteration count=2). That is, the displacement vectors of the division points v1-1 to v1-4 and the displacement vectors of the division points v2-1 to v2-8 generated in the second subdivision (iteration count=1) are stored in the displacement track 114. The displacement vectors of the division points v1-1 to v1-4, which are shown in gray, are relative displacement from the positions after the displacement vector group 121-1 is applied to the mesh after the first subdivision.

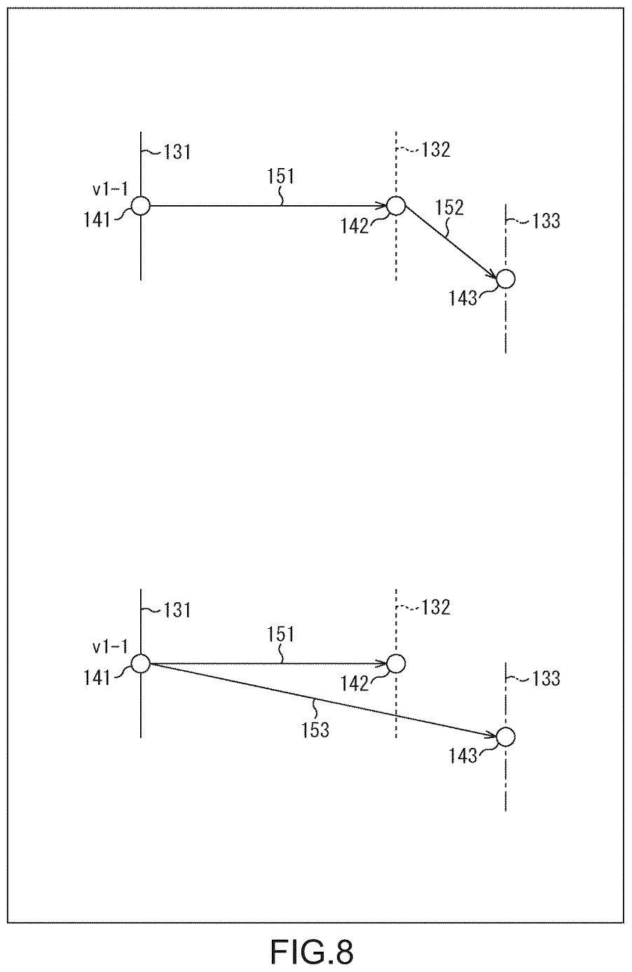

For example, it is assumed that the face of a base mesh 131 is formed as shown in the upper part of FIG. 8 as the solid line, the face of a mesh 132 after the first subdivision is formed as the dotted line, and the face of a mesh 133 after the second subdivision is formed as the single dotted line. Moreover, it is assumed that the first subdivision generates a division point v1-1 at the position of a white circle 141 on the face of the base mesh 131. Then, it is assumed that as a result of approximating the shape of the subdivided mesh to the original mesh, this division point v1-1 is displaced to the position of a white circle 142 on the face of mesh 132 and to the position of a white circle 143 on the face of mesh 133. In a case of the example in FIG. 6, the displacement vector corresponding to the first subdivision (iteration count=1) of this division point v1-1 is a displacement vector 151, which shows the displacement from the white circle 141 to the white circle 142, and the displacement vector corresponding to the second subdivision (iteration count=2) is a displacement vector 152, which shows the displacement from the white circle 142 to the white circle 143. The same applies to the displacement vectors of the division points v1-2 to 1-4. The displacement vectors of the division points v1-1 to v1-4, which are shown in gray in FIG. 6, are displacement vectors indicating displacement from the positions in one lower-level layer as in this displacement vector 152.

Thus, in order to determine obtain the position of the division point v1-1 (position of the white circle 143) on the face of the mesh 133, the displacement vector 151 and the displacement vector 152 are needed. That is, in this case, the encoded data of the displacement vectors is acquired and decoded not only from the track corresponding to the layer corresponding to the level of detail of the mesh to be reconstructed, but also from all the tracks corresponding to the layers lower in level of detail than that layer. For example, in a case of FIG. 6, when reconstructing a mesh with a subdivision iteration count of 1 (iteration count=1) with respect to geometry, the encoded data is read out and decoded from the base-mesh track 112 and the displacement track 113. In contrast, when reconstructing a mesh with a subdivision iteration count of 2 (iteration count=2), the encoded data is read out and decoded from the base-mesh track 112, the displacement track 113, and the displacement track 114.

Herein, a displacement vector indicating the displacement of a vertex from its position in one lower-level layer, such as the displacement vector 152, will be also referred to as a relative displacement vector. Moreover, a displacement vector indicating the displacement of a vertex from its position on the base mesh, such as the displacement vector 151, will be also referred to as an absolute displacement vector. For example, in FIG. 6, the displacement vectors constituting the displacement vector group 121-1 (displacement vectors of the division points v1-1 to v1-4) are absolute displacement vectors. Moreover, the displacement vectors of the division points v2-1 to v2-8 in the displacement vector group 121-2 are absolute displacement vectors.

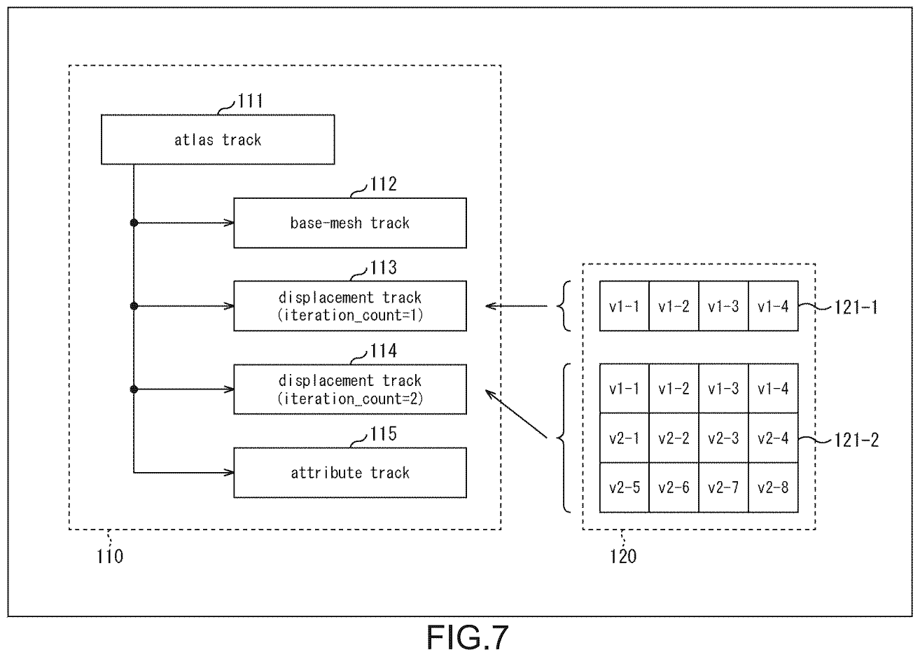

Although the relative displacement vectors can be stored in the displacement track as in the example of FIG. 6, only the absolute displacement vectors can be stored in each displacement track as shown in FIG. 7. In the example of FIG. 7, the displacement track 113 stores the displacement vector group 121-1 of the displacement video 120, as in a case of FIG. 6. In contrast, the displacement track 114 stores a displacement vector group 121-3 of the displacement video 120. In a case of the displacement vector group 121-3, the displacement vectors of the division points v1-1 to v1-4 are absolute displacement vectors, as in the displacement vectors of the division points v2-1 to v2-8. That is, as shown in the lower part of FIG. 8, the displacement vector of the division point v1-1, corresponding to the second subdivision (iteration count=2), is a displacement vector 153, which shows the displacement from the white circle 141 to the white circle 143. The same applies to the displacement vectors of the division points v1-2 to 1-4.

Thus, to determine the position of the division point v1-1 (position of the white circle 143) on the face of the mesh 133, only the displacement vector 153 is needed. That is, in this case, the encoded data of the displacement vectors is acquired and decoded only from the track corresponding to the layer corresponding to the level of detail of the mesh to be reconstructed. For example, in a case of FIG. 7, when reconstructing a mesh with a subdivision iteration count of 1 (iteration count=1) with respect to geometry, the encoded data is read out and decoded from the base-mesh track 112 and the displacement track 113 as in the example of FIG. 6. In contrast, when reconstructing a mesh with a subdivision iteration count of 2 (iteration count=2), the encoded data is read out and decoded from the base-mesh track 112 and the displacement track 114.

Each of the methods described below can be applied to either the storage method as in the example of FIG. 6 (where the relative displacement vectors can be stored in the track) or the storage method as in the example of FIG. 7 (where only the absolute displacement vectors are stored in each track).

### <Method 1-1>

In a case where Method 1 is applied and a displacement video is stored in content file tracks for each layer, it has been difficult to know which layer's displacement vectors are stored in which track simply by storing them, which may increase unnecessary processing.

In view of this, in a case where Method 1 is applied, association information between the layer of the level of detail (subdivision iteration count) and a displacement track may be stored in the content file as shown in the second row from the top of the table in FIG. 5 (Method 1-1). Then, during reconstruction, the encoded data of the displacement vectors may be acquired from a displacement track corresponding to a desired layer on the basis of that association information.

For example, a file generation apparatus (first information processing apparatus) that generates a content file that stores 3D data including displacement vectors may include: an encoding unit that encodes a base mesh and attributes and encodes displacement vectors for each of layers of levels of detail; and a content file generation unit that generates a content file, stores encoded data of the base mesh in a base-mesh track of the content file, stores encoded data of the attributes in an attribute track of the content file, stores encoded data of the displacement vectors for each of the layers in mutually different displacement tracks of the content file, and stores first association information for associating the displacement tracks with the layers in the content file.

Moreover, in a file generation apparatus (first information processing apparatus), a base mesh and attributes may be encoded, displacement vectors may be encoded for each of layers of levels of detail, a content file may be generated, encoded data of the base mesh may be stored in a base-mesh track of the content file, encoded data of the attributes may be stored in an attribute track of the content file, encoded data of the displacement vectors for each of the layers may be stored in mutually different displacement tracks of the content file, and association information for associating the displacement tracks with the layers may be stored in the content file.

It should be noted that the base mesh is a mesh that is generated by decimating vertices from an original mesh as an encoding target, the original mesh being constituted by vertices and connections representing a three-dimensional structure of an object, the mesh being lower in the level of detail than the original mesh. The attributes include textures that are applied to surfaces of the original mesh. The displacement vectors are vector information indicating displacement of vertices obtained by subdividing the base mesh.

By storing the first association information for associating the displacement tracks with the layers in the content file in this manner, the first information processing apparatus can cause a playback apparatus that plays back the 3D data to select the displacement track to acquire the encoded data of the displacement vectors on the basis of the first association information. Thus, the playback apparatus can more easily select the displacement track corresponding to the desired layer, and an increase in unnecessary processing can be suppressed. That is, the first information processing apparatus can suppress an increase in processing load related to reconstruction of 3D data including displacement vectors.

For example, a playback apparatus (second information processing apparatus) that plays back 3D data including displacement vectors may include: an acquisition unit that acquires encoded data of a base mesh and encoded data of attributes from a content file and acquires, on the basis of first association information for associating displacement tracks with layers of levels of detail of a mesh, encoded data of displacement vectors from a displacement track corresponding to a desired layer of the layers of the content file; a decoding unit that decodes each of the acquired encoded data of the base mesh, the acquired encoded data of the attributes, and the acquired encoded data of the displacement vectors; and a reconstruction unit that reconstructs the mesh of the desired layer by using the base mesh, the attributes, and the displacement vectors that are obtained by the decoding.

Moreover, in a playback apparatus (second information processing apparatus) that plays back 3D data including displacement vectors, encoded data of a base mesh and encoded data of attributes from a content file may be acquired, encoded data of displacement vectors may be acquired from a displacement track corresponding to a desired layer of the layers of the content file on the basis of association information for associating displacement tracks with layers of levels of detail of a mesh, each of the acquired encoded data of the base mesh, the acquired encoded data of the attributes, and the acquired encoded data of the displacement vectors may be decoded, and the mesh of the desired layer may be reconstructed by using the base mesh, the attributes, and the displacement vectors that are obtained by the decoding.

It should be noted that the base mesh is a mesh that is generated by decimating vertices from an original mesh as an encoding target, the original mesh being constituted by vertices and connections representing a three-dimensional structure of an object, the mesh being lower in the level of detail than the original mesh. The attributes include textures that are applied to surfaces of the original mesh. The displacement vectors are vector information indicating displacement of vertices obtained by subdividing the base mesh. The content file includes a base-mesh track that stores the encoded data of the base mesh, an attribute track that stores the encoded data of the attributes, and a plurality of the displacement tracks that stores the encoded data of the displacement vectors of the mutually different layers.

By selecting the displacement track to acquire the encoded data of the displacement vectors on the basis of the first association information for associating the displacement tracks with the layers, which is stored in the content file, in this manner, the second information processing apparatus can more easily select the displacement track corresponding to the desired layer. That is, the second information processing apparatus can more easily acquire the encoded data of the displacement vectors necessary for reconstruction and an increase in unnecessary processing can be suppressed. That is, the second information processing apparatus can suppress an increase in processing load related to reconstruction of 3D data including displacement vectors.

### <Method 1-1-1>

In a case where Method 1-1 is applied, subdivision iteration count information indicating the layer of the displacement vectors that are stored in the displacement track may be stored as the first association information as shown in the third row from the top of the table in FIG. 5 (Method 1-1-1). Then, during reconstruction, the encoded data of the displacement vectors may be acquired from a displacement track corresponding to a desired layer on the basis of that subdivision iteration count information.

For example, in the first information processing apparatus, the content file generation unit may store, as the first association information, information (subdivision iteration count information) indicating the layer of the displacement vectors that are stored in the displacement track, in the displacement track. Moreover, in the second information processing apparatus, the acquisition unit may acquire the encoded data of the displacement vectors on the basis of information (subdivision iteration count information) indicating the layer of the displacement vectors, the information (subdivision iteration count information) being stored in the displacement track as the first association information.

By referring to the subdivision iteration count information stored in the displacement track, the acquisition unit of the second information processing apparatus can easily determine a layer (subdivision iteration count) of the displacement vectors that are stored in the displacement track. Thus, the second information processing apparatus can more easily select the displacement track corresponding to the desired layer and acquire the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load for reconstructing 3D data including displacement vectors.

For example, in the first information processing apparatus, the content file generation unit may store the information (subdivision iteration count information) indicating the layer of the displacement vectors in SubdivIterationInfoBox provided in a sample entry of the displacement track. That is, in the content file, the information (subdivision iteration count information) indicating the layer of the displacement vectors may be stored in SubdivIterationInfoBox provided in a sample entry of the displacement track. In the second information processing apparatus, the acquisition unit may acquire the information (subdivision iteration count information) indicating the layer of the displacement vectors from SubdivIterationInfoBox provided in a sample entry of that displacement track.

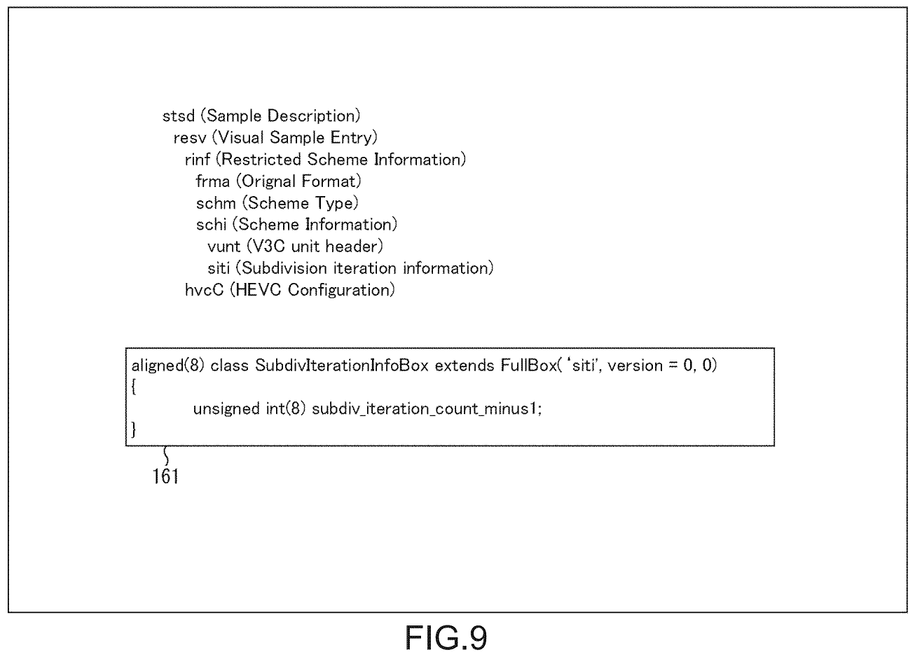

For example, as shown in FIG. 9, siti (Subdivision iteration information) is set below schi (Scheme Information), new SubdivIterationInfoBox is defined in the sample entry of the displacement track, and subdivision iteration count information is stored in the SubdivIterationInfoBox. A description example of the SubdivIterationInfoBox is shown in a rectangle 161. As shown in this description example, a variable subdiv_iteration_count_minus1 indicating the layer of the displacement vectors is stored in SubdivIterationInfoBox as subdivision iteration count information.

By referring to the subdivision iteration count information (variable subdiv_iteration_count_minus1) stored in this SubdivIterationInfoBox, the acquisition unit of the second information processing apparatus can grasp easily a layer (subdivision iteration count) of the displacement vectors that are stored in the displacement track. Thus, the second information processing apparatus can more easily select a displacement track corresponding to a desired layer and can acquire the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load related to reconstruction of 3D data including displacement vectors. It should be noted that the base-mesh track can be regarded as corresponding to iteration_count=0.

It should be noted that as described above, the displacement vectors that are stored in the displacement track may be relative displacement vectors or may be absolute displacement vectors. For example, in the first information processing apparatus, the content file generation unit may store encoded data of absolute displacement vectors of vertices obtained in the corresponding layer and relative displacement vectors of vertices obtained in a lower-level layer than the corresponding layer, in the displacement track. Moreover, in the content file that is supplied to the second information processing apparatus, in the displacement track, encoded data of absolute displacement vectors of vertices obtained in the corresponding layer and relative displacement vectors of vertices obtained in a lower-level layer than the corresponding layer may be stored. That is, in the second information processing apparatus, the acquisition unit may acquire encoded data of absolute displacement vectors of vertices obtained in the corresponding layer and relative displacement vectors of vertices obtained in a lower-level layer than the corresponding layer from the displacement track of the content file. It should be noted that the absolute displacement vectors are the displacement vectors indicating displacement of vertices from the base mesh, the vertices being obtained by subdividing the mesh. Moreover, the relative displacement vectors are the displacement vectors indicating displacement of vertices from positions in one lower-level layer, the vertices being obtained by subdividing the mesh.

Moreover, in the first information processing apparatus, the control file generation unit may store encoded data of absolute displacement vectors of vertices obtained in the corresponding layer and the absolute displacement vectors of vertices obtained in a lower-level layer than the corresponding layer, in the displacement track. Moreover, in the content file that is supplied to the second information processing apparatus, in the displacement track, encoded data of absolute displacement vectors of vertices obtained in the corresponding layer and the absolute displacement vectors of vertices obtained in a lower-level layer than the corresponding layer may be stored. That is, in the second information processing apparatus, the acquisition unit may acquire encoded data of absolute displacement vectors of vertices obtained in the corresponding layer and the absolute displacement vectors of vertices obtained in a lower-level layer than the corresponding layer from the displacement track of the content file. It should be noted that the absolute displacement vectors are the displacement vectors indicating displacement of vertices from the base mesh, the vertices being obtained by subdividing the mesh.

It should be noted that the subdivision iteration count information may be stored in a location other than the displacement track. For example, SubdivIterationTrackGroupBox may be provided and the subdivision iteration count information may be stored in it. In that case, a track group is formed with the base-mesh track and the displacement track. In particular, in a case where relative displacement vectors are stored in the displacement track, the encoded data of the displacement vectors can be acquired from a plurality of displacement tracks. By grouping such a plurality of displacement tracks, the acquisition unit of the second information processing apparatus can more easily identify the displacement track from which the encoded data of the displacement vectors should be acquired by the track group.

### <Method 1-1-1-1>

In a case where Method 1-1-1 is applied, it may be possible to select relative displacement vectors or absolute displacement vectors as displacement vectors that are stored in the displacement track for the vertices obtained in a lower level layer than the corresponding layer. In that case, type information specifying which of the relative displacement vectors or absolute displacement vectors are stored in the displacement track may be stored in the content file as shown in the fourth row from the top of the table in FIG. 5 (Method 1-1-1-1). Then, during reconstruction, the encoded data of the displacement vectors may be acquired from a displacement track corresponding to a desired layer on the basis of that type information.

For example, in the first information processing apparatus, the control file generation unit may further store type information indicating whether the displacement vectors are absolute displacement vectors or relative displacement vectors, in the displacement track. Moreover, in the second information processing apparatus, the acquisition unit may further acquire the encoded data of the displacement vectors on the basis of type information indicating whether the displacement vectors are absolute displacement vectors or relative displacement vectors, the type information being stored in the displacement track. It should be noted that the absolute displacement vectors are the displacement vectors indicating displacement of vertices from the base mesh, the vertices being obtained by subdividing the mesh, and the relative displacement vectors are the displacement vectors indicating displacement of vertices from positions in one lower-level layer, the vertices being obtained by subdividing the mesh.

By referring to the type information stored in the displacement track, the acquisition unit of the second information processing apparatus can easily identify whether the displacement vectors that are stored in the displacement track are the absolute displacement vectors or the relative displacement vectors. Thus, the second information processing apparatus can more easily select a displacement track corresponding to a desired layer properly and acquire the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

For example, in the first information processing apparatus, the control file generation unit may store the type information in SubdivIterationInfoBox provided in a sample entry of the displacement track. That is, in the content file, the type information may be stored in SubdivIterationInfoBox provided in a sample entry of the displacement track. In the second information processing apparatus, the acquisition unit may acquire the type information from SubdivIterationInfoBox provided in a sample entry of that displacement track.

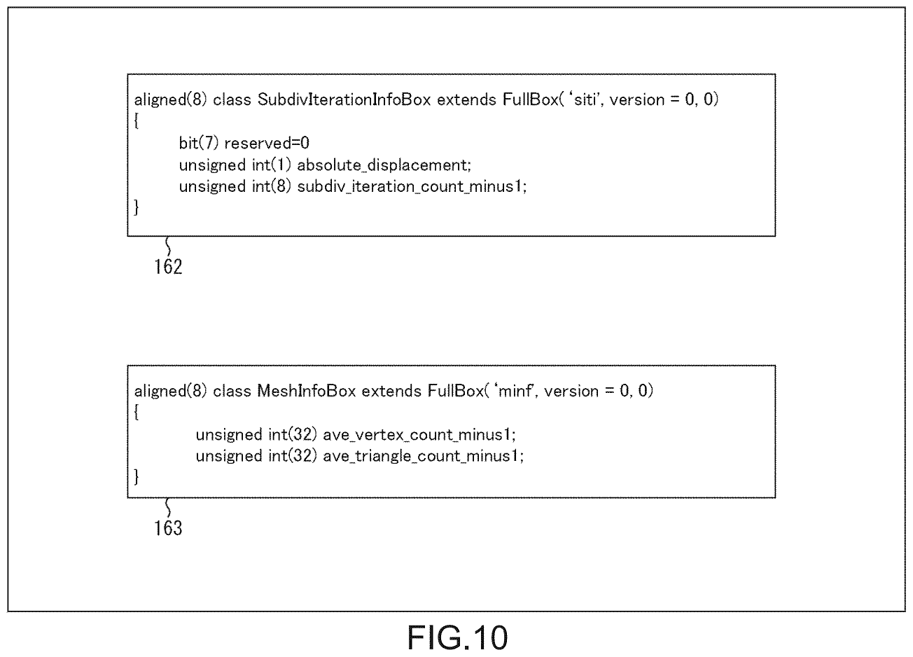

A description example of SubdivIterationInfoBox in that case is shown in a rectangle 162 in FIG. 10. In this example, a variable absolute_displacement is stored in SubdivIterationInfoBox as type information together with the variable subdiv_iteration_count_minus1 (subdivision iteration count information) indicating the layer of the displacement vectors. For example, in a case where the value of this variable absolute_displacement is “0,” it indicates that the relative displacement vectors are stored as the displacement vectors of the vertices obtained in a lower level layer than the corresponding layer. Moreover, in a case where the value of this variable absolute_displacement is “1,” it indicates that the absolute displacement vectors are stored as the displacement vectors of the vertices. It should be noted that this value example is an example. Not limited to this example, the variable absolute_displacement may have any value, and this value may indicate any type of displacement vectors.

By referring to the type information (variable absolute_displacement) stored in this SubdivIterationInfoBox, the acquisition unit of the second information processing apparatus can easily identify whether the displacement vectors that are stored in the displacement track are the absolute displacement vectors or the relative displacement vectors. Thus, the second information processing apparatus can more easily select a displacement track corresponding to a desired layer properly and acquire the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

### <Method 1-1-1-2>

In a case where Method 1-1-1 is applied, quality information indicating quality of the displacement vectors that are stored in the displacement track or the base-mesh that is stored in the base-mesh track may be stored in the content file as shown in the fifth row from the top of the table in FIG. 5 (Method 1-1-1-2). Then, during reconstruction, the encoded data of the displacement vectors may be acquired from a displacement track corresponding to a desired layer on the basis of that quality information.

For example, in the first information processing apparatus, the control file generation unit may further store quality information indicating quality of the base mesh or the displacement vectors in the base-mesh track or the displacement track. Moreover, in the second information processing apparatus, the acquisition unit may further acquire the encoded data of the displacement vectors on the basis of quality information indicating quality of the base mesh or the displacement vectors, the quality information being stored in the base-mesh track or the displacement track.

In the V-DMC, there are no limitations on the level of detail (e.g., number of vertices or polygons) of the original or base mesh, and information on any level of detail can be stored in the base-mesh track and each displacement track in the content file. Therefore, in a case of reconstructing a mesh with a desired number of vertices and polygons, it has sometimes been difficult to identify which layer corresponds to that level of detail. In view of this, by storing the quality information in the track as described above, the acquisition unit of the second information processing apparatus can easily grasp the quality of the base mesh that is stored in the base-mesh track or the displacement vectors that are stored in the displacement track by referring to the quality information that is stored in the base-mesh track or the displacement track. That is, the second information processing apparatus can more easily identify a layer corresponding to a mesh with a desired level of detail (number of vertices and polygons). That is, the second information processing apparatus can more easily select a displacement track corresponding to a desired level of detail and acquire the encoded data of the displacement vectors necessary for reconstruction of the mesh with the level of detail. That is, the first information processing apparatus can suppress an increase in processing load related to reconstruction of 3D data including displacement vectors. Moreover, the second information processing apparatus can suppress an increase in processing load for reconstructing 3D data including displacement vectors.

The quality information may be any type of information. For example, in the first information processing apparatus, the control file generation unit may store, as the quality information, an average value in a time axis direction of the number of vertices of the mesh of the layer corresponding to the base-mesh track or the displacement track, in the base-mesh track or the displacement track. That is, the quality information that is stored in the content file may include an average value in a time axis direction of the number of vertices of the mesh of the layer corresponding to the base-mesh track or the displacement track. In the second information processing apparatus, the acquisition unit may acquire the encoded data of the displacement vectors on the basis of an average value in a time axis direction of the number of vertices of the mesh of the layer corresponding to the base-mesh track or the displacement track, the average value being stored in the base-mesh track or the displacement track as the quality information.

Moreover, in the first information processing apparatus, the control file generation unit may store, as the quality information, an average value in a time axis direction of the number of triangles of the mesh of the layer corresponding to the base-mesh track or the displacement track, in the base-mesh track or the displacement track. That is, the quality information that is stored in the content file may include an average value in a time axis direction of the number of triangles of the mesh of the layer corresponding to the base-mesh track or the displacement track. In the second information processing apparatus, the acquisition unit may acquire the encoded data of the displacement vectors on the basis of an average value in a time axis direction of the number of triangles of the mesh of the layer corresponding to the base-mesh track or the displacement track, the average value being stored in the base-mesh track or the displacement track as the quality information.

It should be noted that the quality information is not limited to such an average value, but may be any statistical value as long as it is a statistical value of a plurality of frames regarding any parameter. For example, the quality information may include a median value in the time axis direction of the number of vertices or the number of triangles of the mesh of the layer corresponding to the base-mesh track or the displacement track, may include an upper limit of the number of vertices or the number of triangles, or may include a lower limit of the number of vertices or the number of triangles.

For example, in the first information processing apparatus, the control file generation unit may store the quality information in MeshInfoBox provided in a sample entry of the base-mesh track or the displacement track. That is, in the content file, the quality information may be stored in MeshInfoBox provided in a sample entry of the base-mesh track or the displacement track. In the second information processing apparatus, the acquisition unit may acquire the quality information from MeshInfoBox provided in a sample entry of that displacement track.

An example description of MeshInfoBox provided under schi of the sample entry of the base-mesh track or the displacement track is shown in a rectangle 163 of FIG. 10. In this example, the MeshInfoBox stores variables ave_vertex_count_minus1 and ave_triangle_count_minus1 as the quality information. The variable ave_vertex_count_minus1, which is stored in the base-mesh track, indicates an average value in the time axis direction of the number of vertices of the base mesh. The variable ave_vertex_count_minus1, which is stored in the displacement track, indicates an average value in the time axis direction of the number of vertices of a mesh (displaced mesh) to which subdivision iteration and displacement corresponding to the base mesh have been applied (i.e., the number of vertices of the mesh of a layer corresponding to that displacement track). The variable ave_triangle_count_minus1, which is stored in the base-mesh track, indicates an average value in the time axis direction of the number of triangles (number of mesh triangles) of the base mesh. The variable ave_triangle_count_minus1, which is stored in the displacement track, indicates an average value in the time axis direction of the number of triangles (number of mesh triangles) of a mesh (displaced mesh) to which subdivision iteration and displacement corresponding to the base mesh have been applied (i.e., an average value in the time axis direction of the number of triangles of the mesh of a layer corresponding to that displacement track).

It should be noted that the substream of the atlas information (atlas substream) stores the number of vertices and the number of triangles of the mesh subdivided in accordance with the subdivision iteration count on a frame-by-frame basis and in units of patches. In the system layer, the average value of the entire stream is stored in units of atlas frames so that it can be used to select a track.

By referring to the quality information (e.g., the variable ave_vertex_count_minus1 and the variable ave_triangle_count_minus1) that is stored in MeshInfoBox, the acquisition unit of the second information processing apparatus can easily grasp the quality of the base mesh that is stored in the base-mesh track or the displacement vectors that are stored in the displacement track. Thus, the second information processing apparatus can more easily identify a layer corresponding to a mesh with a desired level of detail (number of vertices and polygons). That is, the second information processing apparatus can more easily select a displacement track corresponding to a desired level of detail and acquire the encoded data of the displacement vectors necessary for reconstruction of the mesh with the level of detail. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

For example, in the first information processing apparatus, the control file generation unit may store the quality information in SubdivIterationInfoBox provided in a sample entry of the base-mesh track or the displacement track. That is, in the content file, the quality information may be stored in SubdivIterationInfoBox provided in a sample entry of the base-mesh track or the displacement track. In the second information processing apparatus, the acquisition unit may acquire the quality information from SubdivIterationInfoBox provided in a sample entry of that displacement track.

By referring to the quality information (e.g., the variable ave_vertex_count_minus1 and the variable ave_triangle_count_minus1) that is stored in this SubdivIterationInfoBox, the acquisition unit of the second information processing apparatus can easily grasp the quality of the base mesh that is stored in the base-mesh track or the displacement vectors that are stored in the displacement track. Thus, the second information processing apparatus can more easily identify a layer corresponding to a mesh with a desired level of detail (number of vertices and polygons). That is, the second information processing apparatus can more easily select a displacement track corresponding to a desired level of detail and acquire the encoded data of the displacement vectors necessary for reconstruction of the mesh with the level of detail. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

### <Method 1-2>

The content file may be delivered by MPEG-DASH (Moving Picture Experts Group Dynamic Adaptive Streaming over HTTP (Hypertext Transfer Protocol)). That is, the delivery of the content file may be controlled by using MPD (Media Presentation Description) of the MPEG-DASH.

In that case, if the entire stream of displacement vectors (displacement video) is stored in a single track, it has been necessary to deliver the stream of displacement vectors of all layers when delivering the displacement vectors because the delivery is controlled on a track-by-track basis. Therefore, even in a case where a mesh lower in the level of detail than the original mesh is reconstructed (i.e., the reconstructed mesh is not of the highest level of detail), for example, it has been necessary to deliver a stream of displacement vectors of all layers from the track. That is, unnecessary information also had to be delivered, which may lead to inefficient delivery, e.g., increase the transmission bandwidth required for delivery or increase the transmission time. Moreover, the inefficient delivery may reduce the stability of delivery against external factors such as bandwidth fluctuations.

Moreover, in a case where Method 1 is applied and a displacement video is stored in content file tracks for each layer as described above, it has been difficult to know which layer's displacement vectors are stored in which track simply by storing them, which may increase unnecessary processing.

Thus, in a case where Method 1 is applied, association information between the layer of the level of detail (subdivision iteration count) and the displacement track may be stored in the MPD as shown in the sixth row from the top of the table in FIG. 5 (Method 1-2). Then, the encoded data (stream) of the displacement vectors that are stored in a displacement track corresponding to a desired layer may be delivered on the basis of that association information.

For example, a file generation apparatus (first information processing apparatus) that generates a content file that stores 3D data including displacement vectors may include: an encoding unit that encodes a base mesh and attributes and encodes displacement vectors for each of layers of levels of detail; a content file generation unit that generates a content file, stores encoded data of the base mesh in a base-mesh track of the content file, stores encoded data of the attributes in an attribute track of the content file, and stores encoded data of the displacement vectors for each of the layers in mutually different displacement tracks of the content file; and a control file generation unit that generates a control file including control information for controlling delivery of the content file and stores first association information for associating displacement adaptation sets that manage the displacement tracks with the layers in the control file.

Moreover, in a file generation apparatus (first information processing apparatus) that generates a content file that stores 3D data including displacement vectors, a base mesh and attributes may be encoded, displacement vectors may be encoded for each of layers of levels of detail, a content file may be generated, encoded data of the base mesh may be stored in a base-mesh track of the content file, encoded data of the attributes may be stored in an attribute track of the content file, encoded data of the displacement vectors for each of the layers may be stored in mutually different displacement tracks of the content file, a control file including control information for controlling delivery of the content file may be generated, and association information for associating displacement adaptation sets that manage the displacement tracks with the layers may be stored in the control file.

It should be noted that the base mesh is a mesh that is generated by decimating vertices from an original mesh as an encoding target, the original mesh being constituted by vertices and connections representing a three-dimensional structure of an object, the mesh being lower in the level of detail than the original mesh. The attribute includes a texture that is applied to surfaces of the original mesh. The displacement vector is vector information indicating displacement of vertices obtained by subdividing the base mesh.

By storing the first association information for associating the displacement tracks with the layers in this control file (e.g., MPD) in this manner, the first information processing apparatus can cause the playback apparatus that plays back the 3D data to select the displacement track on the basis of the first association information that is stored in this control file and deliver the encoded data of the displacement vectors that are stored in the displacement track. Thus, the first information processing apparatus can cause the encoded data of the displacement vectors to be delivered more efficiently. For example, the first information processing apparatus can suppress an increase in transmission bandwidth required for delivery or can suppress an increase in transmission time. Moreover, the first information processing apparatus can suppress a reduction in stability of the delivery against external factors such as bandwidth fluctuations. Moreover, the first information processing apparatus can suppress acquisition or decoding of displacement vectors of unnecessary layers by the playback apparatus. That is, the first information processing apparatus can also suppress an increase in processing load related to reconstruction in the playback apparatus. Thus, the first information processing apparatus can suppress an increase in performance requirements of hardware necessary for executing the processing or can suppress an increase in processing time. That is, the first information processing apparatus can cause the playback apparatus to execute the processing related to reconstruction more efficiently. Thus, the first information processing apparatus can also suppress a reduction in stability of the processing.

For example, a playback apparatus (second information processing apparatus) that plays back 3D data including displacement vectors may include: a selection unit that selects, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file; an acquisition unit that acquires encoded data of the base mesh and encoded data of the attributes, which are stored in the content file, and acquires encoded data of the displacement vector, which is stored in a displacement track of the content file, the displacement track being managed by the selected displacement adaptation set; a decoding unit that decodes each of the acquired encoded data of the base mesh, the acquired encoded data of the attributes, and the acquired encoded data of the displacement vectors; and a reconstruction unit that reconstructs the mesh of the desired layer by using the base mesh, the attributes, and the displacement vectors that are obtained by the decoding.

Moreover, in a playback apparatus (second information processing apparatus) that plays back 3D data including displacement vectors, on the basis of first association information for associating displacement adaptation sets with layers of levels of detail of a mesh, one of the displacement adaptation sets, which corresponds to a desired layer of the layers, may be selected, the first association information being stored in a control file including control information for controlling delivery of the content file, encoded data of the base mesh and encoded data of the attributes, which are stored in the content file, may be acquired, encoded data of the displacement vector, which is stored in a displacement track of the content file, may be acquired, the displacement track being managed by the selected displacement adaptation set, each of the acquired encoded data of the base mesh, the acquired encoded data of the attributes, and the acquired encoded data of the displacement vectors may be decoded, and the mesh of the desired layer may be reconstructed by using the base mesh, the attributes, and the displacement vectors that are obtained by the decoding.

It should be noted that the base mesh is a mesh that is generated by decimating vertices from an original mesh as an encoding target, the original mesh being constituted by vertices and connections representing a three-dimensional structure of an object, the mesh being lower in the level of detail than the original mesh. The attribute includes a texture that is applied to surfaces of the original mesh. The displacement vector is vector information indicating displacement of vertices obtained by subdividing the base mesh. The content file includes a base-mesh track that stores the encoded data of the base mesh, an attribute track that stores the encoded data of the attributes, and a plurality of the displacement tracks that stores the encoded data of the displacement vectors of the mutually different layers. The control file includes a base-mesh adaptation set that manages the base-mesh track, an attribute adaptation set that manages the attribute track, and the displacement adaptation sets that manage the displacement tracks.

By selecting the displacement adaptation set on the basis of the first association information for associating the displacement tracks with the layers, which is stored in the control file, in this manner, the second information processing apparatus can more easily select a displacement adaptation set corresponding to a desired layer. Moreover, by causing the encoded data of the displacement vectors that are stored in the displacement track corresponding to the selected displacement adaptation set to be delivered, the second information processing apparatus can more efficiently deliver the encoded data of the displacement vectors necessary for reconstruction. For example, the second information processing apparatus can suppress delivery of unnecessary information and suppress an increase in transmission bandwidth information and an increase in transmission time required for delivery. Moreover, by suppressing the delivery of unnecessary information, the second information processing apparatus can suppress a reduction in stability of the delivery against external factors such as bandwidth fluctuations. Moreover, by suppressing the delivery of unnecessary information, the second information processing apparatus can suppress an increase in unnecessary processing such as acquiring and decoding the encoded data of the displacement vectors. That is, the second information processing apparatus can suppress an increase in processing load related to reconstruction of 3D data including displacement vectors. Thus, the second information processing apparatus can suppress an increase in performance requirements of hardware necessary for executing the processing or can suppress an increase in processing time. That is, the second information processing apparatus can more efficiently execute the processing related to reconstruction. Thus, the second information processing apparatus can also suppress a reduction in stability of the processing.

### <Method 1-2-1>

In a case where Method 1-2 is applied, subdivision iteration count information indicating the corresponding layer of the displacement vectors may be stored in the displacement adaptation set of the control file (e.g., MPD) as the first association information as shown in the seventh row from the top of the table in FIG. 5 (Method 1-2-1). Then, during reconstruction, a displacement adaptation set corresponding to a desired layer may be selected on the basis of that subdivision iteration count information, and the encoded data of the displacement vectors that are stored in the displacement track that is managed by that displacement adaptation set may be delivered.

For example, in the first information processing apparatus, the control file generation unit may store, as the first association information, information (subdivision iteration count information) indicating the layers of the displacement vectors that are stored in the displacement tracks that are managed by the displacement adaptation sets, in the displacement adaptation sets of the control file. Moreover, in the second information processing apparatus, the selection unit may select one of the displacement adaptation sets on the basis of information (subdivision iteration count information) indicating the layers of the displacement vectors that are stored in the displacement tracks that are managed by the displacement adaptation sets, the information (subdivision iteration count information) being stored in the displacement adaptation sets of the control file as the first association information.

By referring to the subdivision iteration count information that is stored in the displacement adaptation sets of this control file, the selection unit of the second information processing apparatus can more easily grasp a layer (subdivision iteration count) of the displacement vectors that are stored in the displacement track managed by that displacement adaptation set. Thus, the second information processing apparatus can more easily select a displacement adaptation set corresponding to a desired layer. Moreover, by causing the encoded data of the displacement vectors that are stored in the displacement track corresponding to the selected displacement adaptation set to be delivered, the second information processing apparatus can more efficiently deliver the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load for reconstructing 3D data including displacement vectors.

For example, by extending a V3C video component descriptor, the information (subdivision iteration count information) indicating the layer of the displacement vectors may be defined and stored. Then, during reconstruction, a displacement adaptation set corresponding to a desired layer may be selected on the basis of that subdivision iteration count information that is stored in the essential property or the supplemental property of the displacement adaptation set by using that extended V3C video component descriptor, and the encoded data of the displacement vectors that are stored in the displacement track that is managed by that displacement adaptation set may be delivered.

For example, in the first information processing apparatus, the control file generation unit may store, as the information indicating the layer, a V3C video component descriptor indicating the layer in an essential property or a supplemental property of the displacement adaptation set. Moreover, in the second information processing apparatus, the selection unit may select one of the displacement adaptation sets on the basis of a V3C video component descriptor indicating the layer, the V3C video component descriptor being stored in an essential property or a supplemental property of the displacement adaptation set as the information indicating the layer.

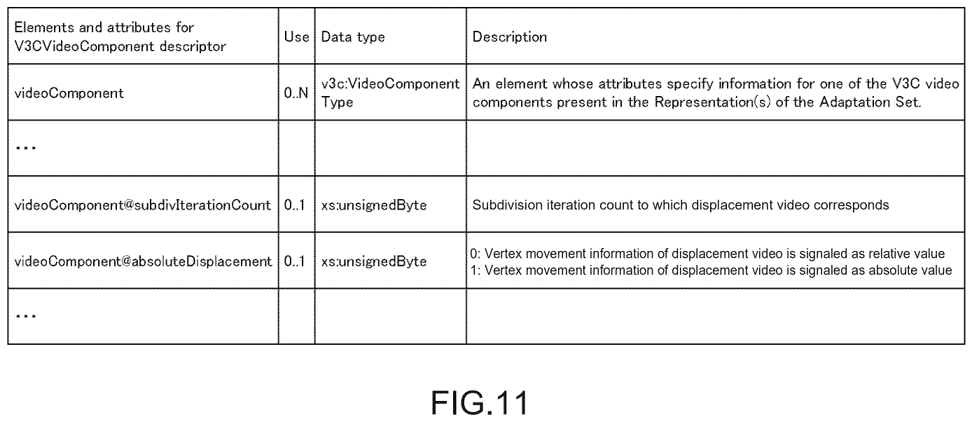

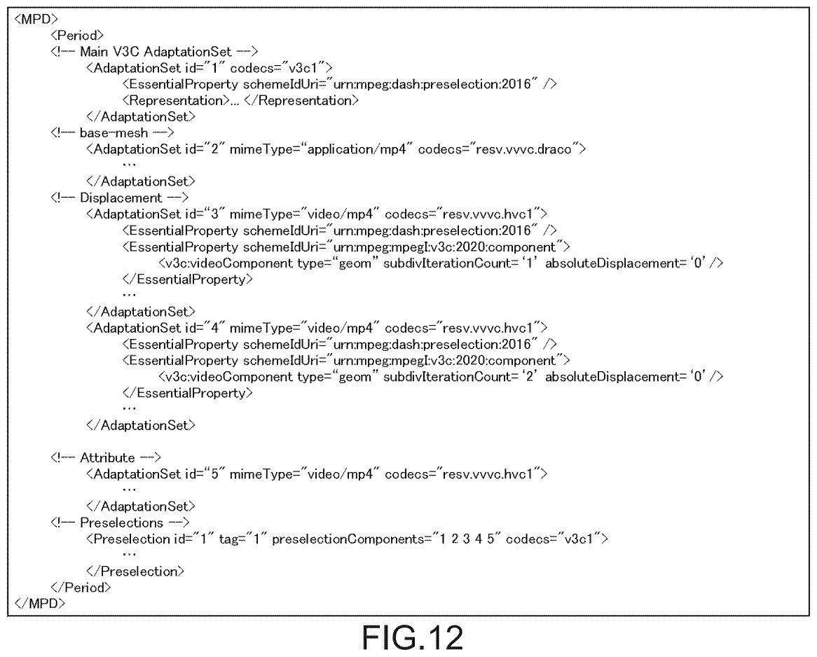

For example, as shown in FIG. 11, videoComponent@subdivIterationCount is defined as an extended V3C video component descriptor. This videoComponent@subdivIterationCount is a descriptor indicating the subdivision iteration count to which the displacement video (displacement vectors) corresponds to. Using this videoComponent@subdivIterationCount, the subdivision iteration count information is stored in the essential property or the supplemental property of the displacement adaptation set. FIG. 12 shows a description example of the MPD in that case. In the example description in FIG. 12, in an essential property (<EssentialProperty schemeIdUri=“urn:mpeg:mpegI:v3c:2020:component”>) of a displacement adaptation set (AdaptationSet id=“3”), it is shown that the subdivision iteration count is “1” (subdivisionIterationCount=‘1’). Moreover, in an essential property (<EssentialProperty schemeIdUri=“urn:mpeg:mpegI:v3c:2020:component”>) of a displacement adaptation set (AdaptationSet id=“4”), it is shown that the subdivision iteration count is “2” (subdivision iterationCount=‘2’).

Since the information (subdivision iteration count information) indicating the layers of the displacement vectors is stored in essential properties or supplemental properties of the displacement adaptation sets in the MPD in this manner, the selection unit of the second information processing apparatus can more easily grasp a layer (subdivision iteration count) of the displacement vectors that are stored in the displacement track that is managed by that displacement adaptation set by referring to this information. Thus, the second information processing apparatus can more easily select a displacement adaptation set corresponding to a desired layer. Moreover, by causing the encoded data of the displacement vectors that are stored in the displacement track corresponding to the selected displacement adaptation set to be delivered, the second information processing apparatus can more efficiently deliver the encoded data of the displacement vectors necessary for reconstruction. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

It should be noted that a new descriptor indicating the information (subdivision iteration count information) indicating the layer of the displacement vectors may be defined without the V3C video component descriptor.

### <Method 1-2-1-1>

Moreover, in a case where Method 1-2-1 is applied, it may be possible to select relative displacement vectors or absolute displacement vectors as displacement vectors that are stored in the displacement track for the vertices obtained in a lower level layer than the corresponding layer. In that case, type information specifying which of the relative displacement vectors or absolute displacement vectors are stored in the displacement track may be stored in the MPD as shown in the eighth row from the top of the table in FIG. 5 (Method 1-2-1-1). Then, during reconstruction, the encoded data of the displacement vectors may be acquired from a displacement track corresponding to a desired layer on the basis of that type information.

For example, in the first information processing apparatus, the control file generation unit may further store type information indicating whether the displacement vectors are absolute displacement vectors or relative displacement vectors, in the displacement adaptation sets of the control file. Moreover, in the second information processing apparatus, the selection unit may further select one of the displacement adaptation sets on the basis of type information indicating whether the displacement vectors are absolute displacement vectors or relative displacement vectors, the type information being stored in the displacement adaptation sets of the control file. It should be noted that the absolute displacement vectors are the displacement vectors indicating displacement of vertices from the base mesh, the vertices being obtained by subdividing the mesh, and the relative displacement vectors are the displacement vectors indicating displacement of vertices from positions in one lower-level layer, the vertices being obtained by subdividing the mesh.

By referring to the type information stored in the displacement adaptation set, the selection unit of the second information processing apparatus can easily identify whether the displacement vectors that are stored in the displacement track corresponding to the displacement adaptation set are the absolute displacement vectors or the relative displacement vectors. Thus, the second information processing apparatus can more easily select the appropriate displacement track corresponding to the desired layer and cause the encoded data of the displacement vectors necessary for reconstruction to be delivered. That is, the first information processing apparatus can suppress an increase in processing load related to reconstruction of 3D data including displacement vectors. Moreover, the second information processing apparatus can suppress an increase in processing load for reconstructing 3D data including displacement vectors.

This type information may be stored, for example, in the essential property or the supplemental property of the displacement adaptation set. For example, by extending a V3C video component descriptor, the type information may be defined and stored. Then, during reconstruction, a displacement adaptation set corresponding to a desired layer may be selected on the basis of the type information that is stored in the essential property or the supplemental property of the displacement adaptation set by using that extended V3C video component descriptor, and the encoded data of the displacement vectors that are stored in the displacement track that is managed by that displacement adaptation set may be delivered.

For example, in the first information processing apparatus, the control file generation unit may store, as the type information, a V3C video component descriptor indicating whether the displacement vectors are the absolute displacement vectors or the relative displacement vectors, in an essential property or a supplemental property of the displacement adaptation set. Moreover, in the second information processing apparatus, the selection unit may select one of the displacement adaptation sets on the basis of a V3C video component descriptor indicating whether the displacement vectors are the absolute displacement vectors or the relative displacement vectors, the V3C video component descriptor being stored in an essential property or a supplemental property of the displacement adaptation set as the type information.

For example, as shown in FIG. 11, videoComponent@absoluteDisplacement is defined as an extended V3C video component descriptor. In a case where the value of this videoComponent@absoluteDisplacement is “0,” it indicates that the relative displacement vectors are stored as the displacement vectors of the vertices obtained in a lower level layer than the corresponding layer. Moreover, in a case where the value of this videoComponent@absoluteDisplacement is “1,” it indicates that the absolute displacement vectors are stored as the displacement vectors of the vertices. It should be noted that this value example is an example. Not limited to this example, the videoComponent@absoluteDisplacement may have any value, and this value may indicate any type of displacement vectors.

In the example description in FIG. 12, in the essential property (<EssentialProperty schemeIdUri=“urn:mpeg:mpegI:v3c:2020:component”>) of the displacement adaptation set (AdaptationSet id=“3”), it is shown that the relative displacement vectors are stored (absoluteDisplacement=‘0’) as the displacement vectors of the vertices obtained in a lower level layer than the corresponding layer. Moreover, in the essential property (<EssentialProperty schemeIdUri=“urn:mpeg:mpegI:v3c:2020:component”>) of the it is shown that the relative displacement vectors are stored (absoluteDisplacement=‘0’) as the displacement vectors of the vertices obtained in a lower level layer than the corresponding layer.

Since the type information is stored in essential properties or supplemental properties of the displacement adaptation sets in the MPD in this manner, the selection unit of the second information processing apparatus can easily identify whether the displacement vectors that are stored in the displacement track that is managed by that displacement adaptation set are the absolute displacement vectors or the relative displacement vectors by referring to this type information. Thus, the second information processing apparatus can more easily select a displacement adaptation set corresponding to a desired layer properly and cause the encoded data of the displacement vectors necessary for reconstruction to be delivered. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

It should be noted that a new descriptor indicating the type information may be defined without the V3C video component descriptor.

### <Method 1-2-1-2>

In a case where Method 1-2-1 is applied, quality information indicating quality of the displacement vectors that are stored in the displacement track or the base-mesh that is stored in the base-mesh track may be stored in the control file (e.g., MPD) as shown in the ninth row from the top of the table in FIG. 5 (Method 1-2-1-2). Then, during reconstruction, encoded data of displacement vectors corresponding to a desired layer may be delivered on the basis of that quality information.

For example, in the first information processing apparatus, the control file generation unit may further store quality information indicating quality of the base mesh or the displacement vectors in a base-mesh adaptation set that manages the base-mesh track of the control file or in the displacement adaptation sets of the control file. Moreover, in the second information processing apparatus, the selection unit may further select one of the displacement adaptation sets on the basis of quality information indicating quality of the base mesh or the displacement vectors, the quality information being stored in the base-mesh adaptation set or the displacement adaptation set.

In the V-DMC, there are no limitations on the level of detail (e.g., number of vertices or polygons) of the original or base mesh, and information on any level of detail can be stored in the base-mesh track and each displacement track in the content file. Therefore, in a case of reconstructing a mesh with a desired number of vertices and polygons, it has sometimes been difficult to identify which layer corresponds to that level of detail. In view of this, by storing the quality information in the adaptation set of the control file as described above, the acquisition unit of the second information processing apparatus can easily grasp the quality of the base mesh or the displacement vectors that are stored in the base-mesh track or the displacement track that is managed by that adaptation set by referring to the quality information that is stored in the base-mesh adaptation set or the displacement adaptation set. That is, the second information processing apparatus can more easily identify a layer corresponding to a mesh with a desired level of detail (number of vertices and polygons). That is, the second information processing apparatus can more easily select a displacement adaptation set corresponding to a desired level of detail and cause the encoded data of the displacement vectors necessary for reconstruction of the mesh with the level of detail to be delivered. That is, the first information processing apparatus can suppress an increase in processing load related to reconstruction of 3D data including displacement vectors. Moreover, the second information processing apparatus can suppress an increase in processing load for reconstructing 3D data including displacement vectors.

This quality information may be stored, for example, in the essential property or the supplemental property of the displacement adaptation set. For example, a new mesh information descriptor may be defined and the quality information may be stored by using this mesh information descriptor. Then, during reconstruction, a displacement adaptation set corresponding to a desired level of detail (number of vertices and polygons) may be selected on the basis of the quality information that is stored in the essential property or the supplemental property of the displacement adaptation set by using that mesh information descriptor and the encoded data of the displacement vectors that are stored in the displacement track that is managed by that displacement adaptation set may be delivered.

For example, in the first information processing apparatus, the control file generation unit may store, as the quality information, a mesh information descriptor indicating quality of the base mesh or the displacement vectors, in an essential property or a supplemental property of the base-mesh adaptation set or the displacement adaptation set. In the second information processing apparatus, the selection unit may select one of the displacement adaptation sets on the basis of a mesh information descriptor indicating quality of the base mesh or the displacement vectors, the mesh information descriptor being stored in an essential property or a supplemental property of the base-mesh adaptation set or the displacement adaptation set as the quality information.

The quality information may be any type of information. For example, in the first information processing apparatus, the control file generation unit may store the mesh information descriptor indicating an average value in a time axis direction of the number of vertices of the mesh of the layer corresponding to the base-mesh adaptation set or the displacement adaptation set, in the essential property or the supplemental property of the base-mesh adaptation set or the displacement adaptation set. That is, the quality information that is stored in the control file may include an average value in a time axis direction of the number of vertices of the mesh of the layer corresponding to the base-mesh adaptation set or the displacement adaptation set. In the second information processing apparatus, the selection unit may select one of the displacement adaptation sets on the basis of the mesh information descriptor indicating an average value in a time axis direction of the number of vertices of the mesh of the layer corresponding to the base-mesh adaptation set or the displacement adaptation set, the mesh information descriptor being stored in the essential property or the supplemental property of the base-mesh adaptation set or the displacement adaptation set.

Moreover, in the first information processing apparatus, the control file generation unit may store the mesh information descriptor indicating an average value in a time axis direction of the number of triangles of the mesh of the layer corresponding to the base-mesh adaptation set or the displacement adaptation set, in the essential property or the supplemental property of the base-mesh adaptation set or the displacement adaptation set. That is, the quality information that is stored in the control file may include an average value in a time axis direction of the number of triangles of the mesh of the layer corresponding to the base-mesh track or the displacement track. In the second information processing apparatus, the selection unit may select one of the displacement adaptation sets on the basis of the mesh information descriptor indicating an average value in a time axis direction of the number of triangles of the mesh of the layer corresponding to the base-mesh adaptation set or the displacement adaptation set, the mesh information descriptor being stored in the essential property or the supplemental property of the base-mesh adaptation set or the displacement adaptation set.

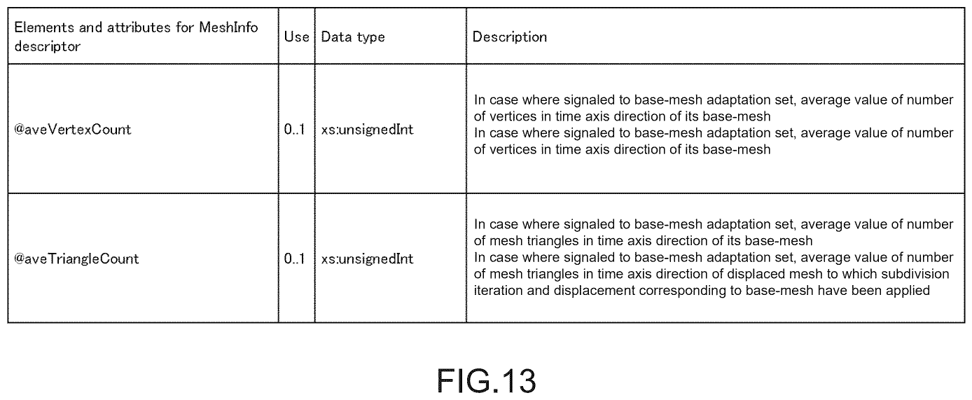

For example, as shown in FIG. 13, @aveVertexCount and @aveTriangleCount are defined as mesh information descriptors (MeshInfo descriptors). The @aveVertexCount stored in the base-mesh adaptation set indicates an average value in the time axis direction of the number of vertices of the base mesh. The @aveVertexCount stored in the displacement adaptation set indicates an average value in the time axis direction of the number of vertices of a mesh (displaced mesh) to which subdivision iteration and displacement corresponding to the base mesh have been applied (i.e., the number of vertices of the mesh of a layer corresponding to that displacement track). The @aveTriangleCount, which is stored in the base-mesh adaptation set, indicates an average value in the time axis direction of the number of triangles (number of mesh triangles) of the base mesh. The @aveTriangleCount, which is stored in the displacement adaptation set, indicates an average value in the time axis direction of the number of triangles of a mesh (displaced mesh) to which subdivision iteration and displacement corresponding to the base mesh have been applied (i.e., an average value in the time axis direction of the number of triangles (number of mesh triangles) of the mesh of a layer corresponding to that displacement track).

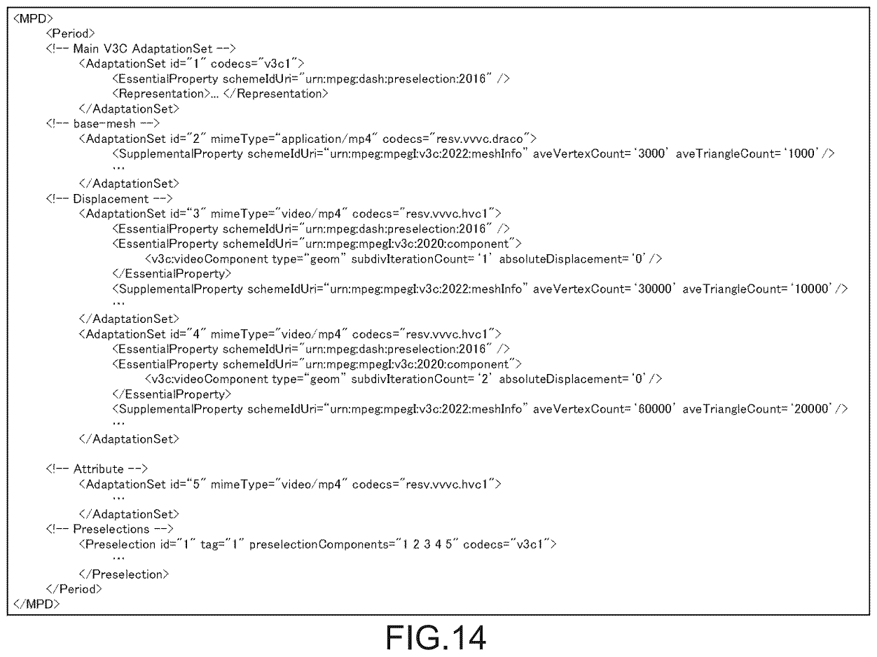

FIG. 14 shows a description example of the MPD in that case. In the example description in FIG. 14, in a supplemental property of a base-mesh adaptation set (AdaptationSet id=“2”), it is shown as the quality information that an average value (aveVertexCount) in the time axis direction of the number of vertices of the base mesh is 3000 and an average value (aveTriangleCount) in the time axis direction of the number of triangles of the base mesh is 1000 (<SupplementalProperty schemeIdUri=“urn:mpeg:mpegI:v3c:2022:meshInfo” aveVertexCount=‘3000’ aveTriangleCount=‘1000’/>).

Moreover, in the supplemental property of the displacement adaptation set (AdaptationSet id=“3”), it is shown as the quality information that an average value (aveVertexCount) in the time axis direction of the number of vertices of the mesh of that layer is 30000 and an average value (aveTriangleCount) in the time axis direction of the number of triangles of the mesh of that layer is 10000 (<SupplementalProperty schemeIdUri=“urn:mpeg:mpegI:v3c:2022:mesh Info” aveVertexCount=‘30000’ aveTriangleCount=‘10000’/>).

Moreover, in the supplemental property of the displacement adaptation set (AdaptationSet id=“4”), it is shown as the quality information that an average value (aveVertexCount) in the time axis direction of the number of vertices of the mesh of that layer is 60000 and an average value (aveTriangleCount) in the time axis direction of the number of triangles of the mesh of that layer is 20000 (<SupplementalProperty schemeIdUri=“urn:mpeg:mpegI:v3c:2022:meshInfo” aveVertexCount=‘60000’ aveTriangleCount=‘20000’/>).

Since the quality information is stored in the essential property or the supplemental property of the base-mesh adaptation set or displacement adaptation set in the MPD in this manner, the selection unit of the second information processing apparatus can easily grasp the quality of the base-mesh that is stored in the base-mesh track corresponding to the base-mesh adaptation set or the quality of the displacement vectors that are stored in the displacement track corresponding to the displacement adaptation set by referring to this quality information. Thus, the second information processing apparatus can more easily identify a layer corresponding to a mesh with a desired level of detail (number of vertices and polygons). That is, the second information processing apparatus can more easily select a base-mesh adaptation set or a displacement adaptation set corresponding to a desired level of detail and cause the encoded data of the displacement vectors necessary for reconstruction of the mesh of the level of detail delivered. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

It should be noted that the quality information may be stored by using a V3C video component descriptor instead of the mesh information descriptor. For example, in the first information processing apparatus, the control file generation unit may store, as the quality information, a V3C video component descriptor indicating quality of the base mesh or the displacement vectors, in an essential property or a supplemental property of the base-mesh adaptation set or the displacement adaptation set. In the second information processing apparatus, the selection unit may select one of the displacement adaptation sets on the basis of a V3C video component descriptor indicating quality of the base mesh or the displacement vectors, the V3C video component descriptor being stored in an essential property or a supplemental property of the base-mesh adaptation set or the displacement adaptation set as the quality information.

It should be noted that the quality information is not limited to such an average value, but may be any statistical value as long as it is a statistical value of a plurality of frames regarding any parameter. For example, the quality information may include a median value in the time axis direction of the number of vertices or the number of triangles of the mesh of the layer corresponding to the base-mesh track or the displacement track, may include an upper limit of the number of vertices or the number of triangles, or may include a lower limit of the number of vertices or the number of triangles.

### 4. PLAYBACK CONTROL FOR EACH LAYER OF ATTRIBUTES

### <Method 2>

In the method of storing and delivering the V-DMC bitstream in a file container, it is conceivable that the substream of the attributes is also stored in tracks as described above. In the V-DMC data, attributes corresponding to a mesh with the highest level of detail are provided. Thus, in general, in a case where the substream of the attributes is stored in a single track as described above.

In that case, however, the entire substream of the attributes is acquired from the track and decoded in a case of decoding. That is, the attributes corresponding to the mesh with the highest level of detail are restored. Thus, in a case where a mesh lower in the level of detail than the original mesh is reconstructed (i.e., the reconstructed mesh is not of the highest level of detail), for example, it may be impossible to easily and correctly perform texture mapping because it does not match the level of detail of the attributes (i.e., it may be difficult to correctly apply the attributes to the faces of the mesh. This may reduce the quality of the reconstructed mesh (e.g., the image quality of the reconstructed mesh in the displayed image). Moreover, if the texture mapping is adjusted to suppress a reduction in the quality of the mesh, the amount of processing may increase. Moreover, since processing related to acquiring and decoding unnecessary attributes are also performed, the load on the processing related to reconstruction may increase unnecessarily. That is, these may lead to inefficient processing, e.g., increase the performance requirements of the hardware needed to execute the processing or increase the processing time. Moreover, the inefficient processing may reduce the stability of the processing against external factors such as fluctuations in processing capacity.

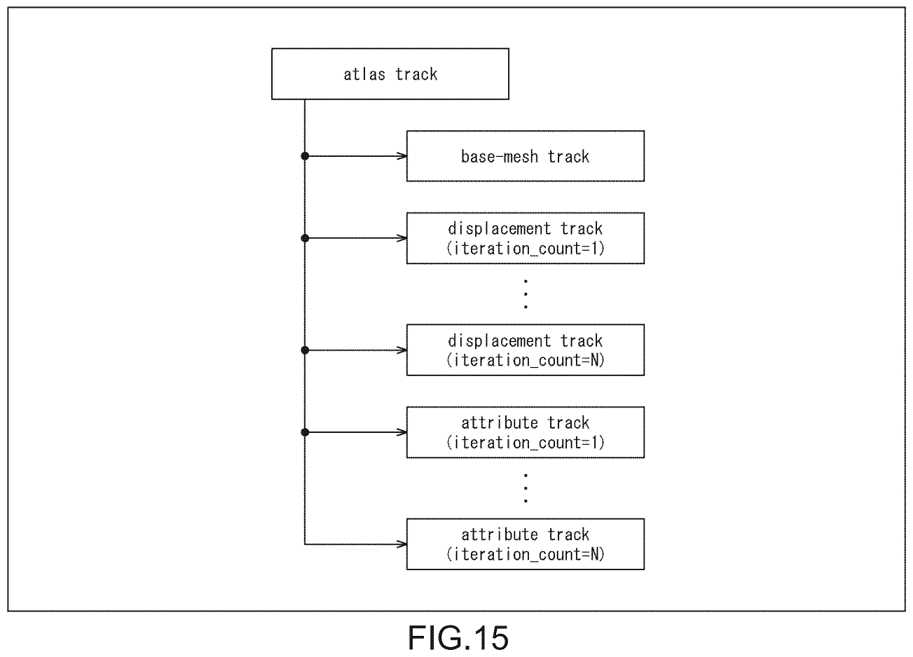

In view of this, the attributes are layered by the level of detail and are stored in tracks of the content file for each of the layers as shown in the 10th row from the top of the table in FIG. 5 (Method 2). For example, the configuration of the tracks is set to be a configuration as shown in FIG. 15. In a case of the example in FIG. 15, the content file includes a plurality of (N (N is an arbitrary natural number)) displacement tracks and a plurality of (N (N is an arbitrary natural number)) attribute tracks, in addition to the atlas track and the base-mesh track.

That is, the attributes of the V-DMC data are layered in accordance with the level of detail of the mesh, and the attributes for each layer are encoded independently of each other and stored in mutually different attribute tracks of the content file with such a track configuration.

With such a configuration, for example, the encoded data of the attributes can be acquired and decoded from some attribute tracks. For example, it is possible to make a control to select a track that stores attributes of the same level of detail as the mesh to be reconstructed and acquire and decode the encoded data of the attributes only from that selected track. With such control, it is possible to obtain attributes of the level of detail corresponding to the mesh to be reconstructed. Thus, the texture mapping can be performed easily and correctly, and a reduction in the quality of the reconstructed mesh (e.g., the image quality of the reconstructed mesh in the displayed image) can be suppressed. Moreover, an increase in processing load related to reconstruction can also be suppressed. Thus, an increase in performance requirements of hardware necessary for executing the processing can be suppressed, and an increase in processing time can be suppressed. That is, the processing related to reconstruction can be performed more efficiently. Thus, a reduction in processing stability can also be suppressed.

It should be noted that also in the case of this Method 2, the method of storing displacement vectors may be a method in which the relative displacement vectors can be stored in the tracks as in the example of FIG. 6 or may be a method in which only the absolute displacement vectors are stored in each track as in the example of FIG. 7. Moreover, it may be possible to select both of those storage methods.

Moreover, this Method 2 can be applied in combination with Method 1 described above. For example, as in the track configuration shown in FIG. 15, each of the displacement vector and attributes may be layered and stored in mutually different displacement tracks or attribute tracks for each of the layers.

### <Method 2-1>

In a case where Method 2 is applied and attributes are stored in content file tracks for each layer, it has been difficult to know which layer's attribute is stored in which attribute track simply by storing it, which may increase unnecessary processing.

In view of this, in a case where Method 2 is applied, association information between the attribute track and the displacement track may be stored in the content file as shown in the 11th row from the top of the table in FIG. 5 (Method 2-1). Then, during reconstruction, the encoded data of the attributes may be acquired from an attribute track corresponding to a displacement track corresponding to a desired layer on the basis of that association information.

For example, in the file generation apparatus (first information processing apparatus) that generates the content file that stores the 3D data including the displacement vectors, the encoding unit may encode the attributes for each of layers of the levels of detail. Moreover, the content file generation unit may store encoded data of the attributes for each of the layers in the mutually different attribute tracks of the content file and store second association information for associating the attribute tracks with the displacement tracks in the content file.

By the first information processing apparatus storing the second association information for associating the attribute tracks with the displacement tracks in the content file in this manner, the playback apparatus that plays back the 3D data can more easily select an appropriate attribute track on the basis of the second association information. That is, the playback device can more easily select an appropriate attribute track based on the second association information. That is, the playback apparatus can more easily acquire attributes of the level of detail corresponding to the mesh to be reconstructed. Thus, the playback apparatus can perform the texture mapping more easily and correctly. That is, the first information processing apparatus can suppress a reduction of the quality of the mesh to be reconstructed (e.g., the image quality of the reconstructed mesh in the displayed image). Moreover, by selecting the attribute track on the basis of the second association information, the playback apparatus can suppress an increase in unnecessary processing such as acquiring and decoding attributes of unnecessary level of detail. That is, the first information processing apparatus can suppress an increase in processing load related to reconstruction of 3D data including displacement vectors. Thus, the first information processing apparatus can suppress an increase in performance requirements of hardware necessary for executing the processing of the playback apparatus and an increase in the processing time of the playback apparatus. That is, the first information processing apparatus can cause the processing related to reconstruction to be executed more efficiently. Thus, the first information processing apparatus can also suppress a reduction in stability of the processing related to reconstruction.

Moreover, the content file may include the base-mesh track, a plurality of the attribute tracks that stores the encoded data of the attributes of the mutually different layers, and a plurality of the displacement tracks that stores the encoded data of the displacement vectors of the mutually different layers. Then, in the playback apparatus (second information processing apparatus) that plays back the 3D data including the displacement vectors, the acquisition unit may acquire, on the basis of second association information for associating the attribute tracks with the displacement tracks, the encoded data of the attributes from the attribute track corresponding to a desired layer of the layers of the content file.

By selecting the attribute track to acquire the encoded data of the attributes on the basis of the second association information for associating the attribute tracks with the displacement tracks, which is stored in the content file, in this manner, the second information processing apparatus can more easily select an attribute track corresponding to a displacement track of a desired layer. That is, the second information processing apparatus can more easily select an attribute track corresponding to the layer of the mesh to be reconstructed. Thus, the second information processing apparatus can perform the texture mapping more easily and correctly. That is, the second information processing apparatus can suppress a reduction in the quality of the mesh to be reconstructed (e.g., the image quality of the reconstructed mesh in the displayed image). Moreover, by selecting the attribute track on the basis of the second association information, the second information processing apparatus can suppress an increase in unnecessary processing such as acquiring and decoding attributes of unnecessary level of detail. That is, the second information processing apparatus can suppress an increase in processing load related to reconstruction of 3D data including displacement vectors. Thus, the second information processing apparatus can suppress an increase in performance requirements of hardware necessary for executing the processing or can suppress an increase in processing time. That is, the second information processing apparatus can more efficiently execute the processing related to reconstruction. Thus, the second information processing apparatus can also suppress a reduction in stability of the processing related to reconstruction.

### <Method 2-1-1>

In a case where Method 2-1 is applied, subdivision iteration count information indicating the layer of the attributes that are stored in the attribute track may be stored as the second association information as shown in the 12th row from the top of the table in FIG. 5 (Method 2-1-1). Then, during reconstruction, the encoded data of the attributes may be acquired from an attribute track corresponding to a desired layer on the basis of that subdivision iteration count information.

For example, in the first information processing apparatus, the content file generation unit may store, as the second association information, information (subdivision iteration count information) indicating the layer of the attributes that are stored in the attribute track, in the attribute track. Moreover, in the second information processing apparatus, the acquisition unit may acquire the encoded data of the attributes on the basis of information (subdivision iteration count information) indicating the layer of the attributes, the information (subdivision iteration count information) being stored in the attribute track as the second association information.

By referring to the subdivision iteration count information that is stored in the attribute track, the acquisition unit of the second information processing apparatus can easily grasp the layer (subdivision iteration count) of the attributes that are stored in the attribute track. Thus, the second information processing apparatus can more easily select an attribute track corresponding to a desired layer and acquire the encoded data of the attributes necessary for reconstruction. That is, the first information processing apparatus can suppress a reduction of the quality of the mesh to be reconstructed (e.g., the image quality of the reconstructed mesh in the displayed image). Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can suppress an increase in processing load related to reconstruction of 3D data including displacement vectors.

For example, in the first information processing apparatus, the content file generation unit may store the information (subdivision iteration count information) indicating the layer of the attributes in SubdivIterationInfoBox provided in a sample entry of the attribute track. That is, in the content file, the information (subdivision iteration count information) indicating the layer of the attributes may be stored in SubdivIterationInfoBox provided in a sample entry of the attribute track. In the second information processing apparatus, the acquisition unit may acquire the information (subdivision iteration count information) indicating the layer of the attributes from SubdivIterationInfoBox provided in a sample entry of the attribute track.

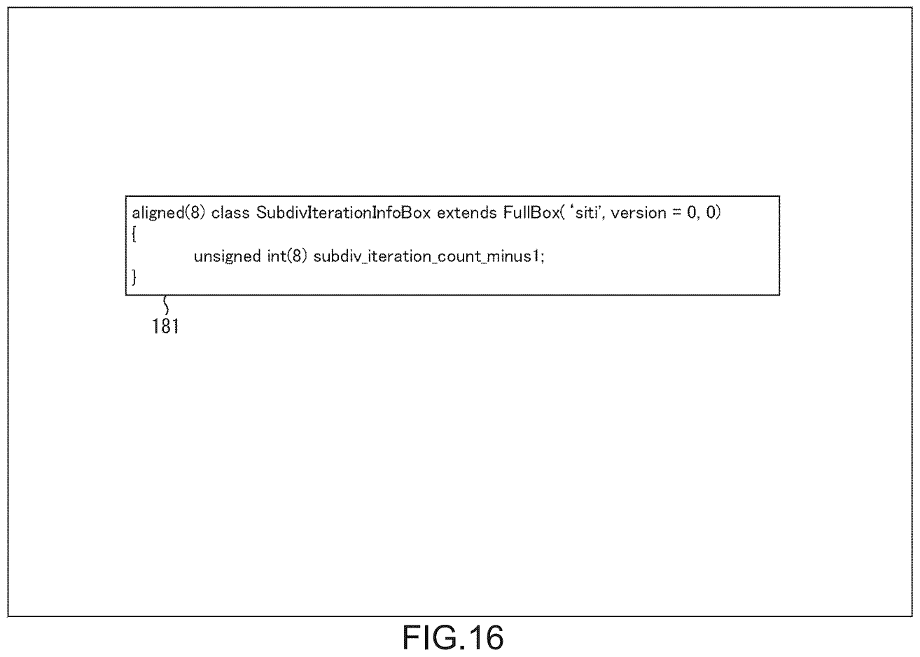

For example, as shown in FIG. 9, siti (Subdivision iteration information) is set below schi (Scheme Information), new SubdivIterationInfoBox is defined in the sample entry of the attribute track, subdivision iteration count information is stored in the SubdivIterationInfoBox. A description example of the SubdivIterationInfoBox is shown in a rectangle 181 in FIG. 16. As shown in this description example, the variable subdiv_iteration_count_minus1 indicating the layer of the attributes is stored in the SubdivIterationInfoBox as subdivision iteration count information. With the value of this variable subdiv_iteration_count_minus1 (i.e., subdivision iteration count), the attribute track and the displacement track corresponding to the same layer are grouped.

By referring to the subdivision iteration count information (variable subdiv_iteration_count_minus1) stored in this SubdivIterationInfoBox, the acquisition unit of the second information processing apparatus can easily grasp the layer (subdivision iteration count) of the attributes that are stored in the attribute track. Thus, the second information processing apparatus can more easily select an attribute track corresponding to a desired layer and acquire the encoded data of the attributes necessary for reconstruction. That is, the first information processing apparatus can suppress a reduction in the quality of the mesh to be reconstructed (e.g., the image quality of the reconstructed mesh in the displayed image). Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can suppress an increase in processing load related to reconstruction of 3D data including displacement vectors.

It should be noted that also in this case, the displacement vectors that are stored in the displacement track may be relative displacement vectors or may be absolute displacement vectors.

### <Method 2-1-2>

In a case where Method 2-1 is applied, track group information for grouping attribute tracks and displacement tracks may be stored as the second association information as shown in the 13th row from the top of the table in FIG. 5 (Method 2-1-2). Then, during reconstruction, the encoded data of the attributes may be acquired from an attribute track corresponding to a displacement track of a desired layer on the basis of that track group information. It should be noted that this track group information will be also referred to as grouping information.

For example, in the first information processing apparatus, the content file generation unit may store, as the second association information, grouping information for grouping the attribute track and the displacement track necessary for reconstruction of the mesh for each of the layers, in the content file. Moreover, in the second information processing apparatus, the acquisition unit may acquire the encoded data of the attributes on the basis of grouping information for grouping the attribute track and the displacement track necessary for reconstruction of the mesh for each of the layers, the grouping information being stored in the content file as the second association information.

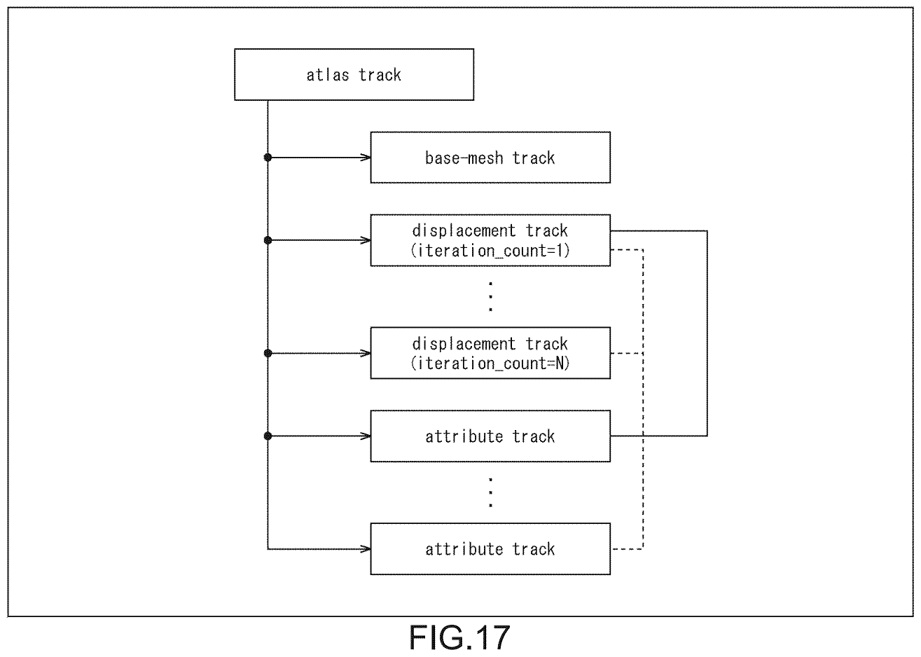

FIG. 17 is a diagram showing how the displacement tracks and the attribute tracks are grouped by the grouping information. In a case of the example in FIG. 17, the topmost attribute track is grouped with the displacement track with iteration_count=1 as shown as the solid line. Thus, this topmost attribute track is the attribute track with iteration_count=1. That is, in a case where the mesh to be reconstructed is of a layer with iteration_count=1, the encoded data is acquired and decoded from the displacement track with iteration_count=1 and the topmost attribute track, which are associated with each other by this solid line (descriptions of the base mesh and the atlas information are omitted). With such a configuration, displacement vectors and attributes necessary for reconstructing the mesh in the layer with iteration_count=1 can be obtained (there is no need to obtain displacement vectors and attributes of unnecessary layers).

Moreover, as shown in the dotted line, the bottom attribute track is grouped with the displacement tracks of all layers (iteration_count=1 to iteration_count=N). Thus, this bottom attribute track is the attribute track with iteration_count=N (i.e., highest level of detail). That is, in a case where the mesh to be reconstructed is a layer with iteration_count=N (i.e., highest level of detail), the displacement tracks with iteration_count=1 to iteration_count=N and the bottom attribute track, which are associated with each other by this dotted line, are acquired and decoded (descriptions of the base mesh and the atlas information are omitted). With such a configuration, the displacement vectors and attributes necessary for reconstructing the mesh in the layer with iteration_count=N can be obtained (there is no need to obtain displacement vectors and attributes of unnecessary layers).

By referring to this grouping information (track group information), the acquisition unit of the second information processing apparatus can grasp a combination of the displacement track and the attribute track corresponding to the same layer. Thus, the second information processing apparatus can more easily select an attribute track corresponding to a desired layer and acquire the encoded data of the attributes necessary for reconstruction. That is, the first information processing apparatus can suppress a reduction in the quality of the mesh to be reconstructed (e.g., the image quality of the reconstructed mesh in the displayed image). Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can suppress an increase in processing load related to reconstruction of 3D data including displacement vectors.

For example, in the first information processing apparatus, the content file generation unit may store the grouping information in SubdivIterationTrackGroupBox. That is, in the content file, the grouping information may be stored in SubdivIterationTrackGroupBox. In the second information processing apparatus, the acquisition unit may acquire the grouping information from the SubdivIterationTrackGroupBox.

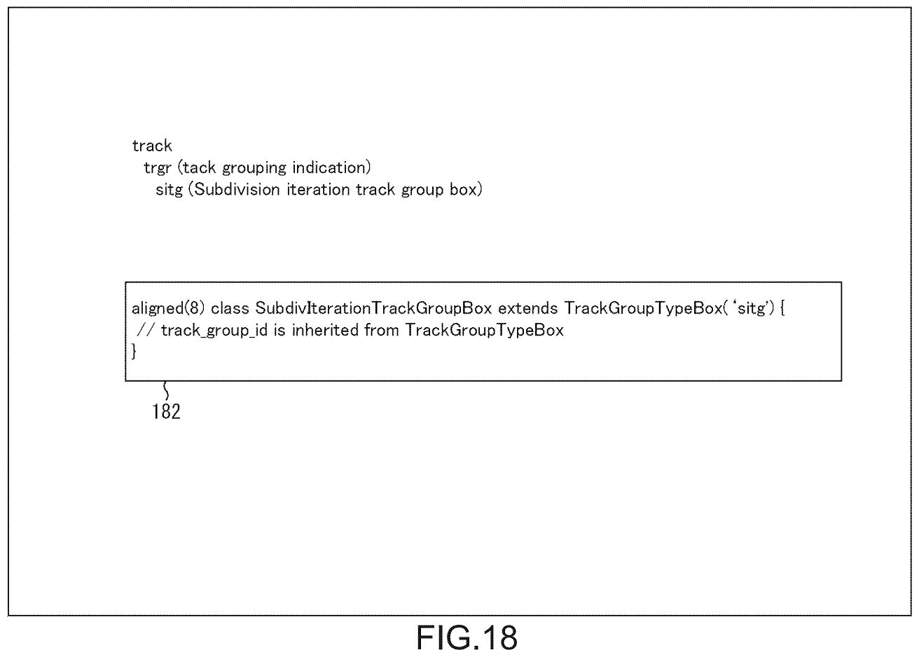

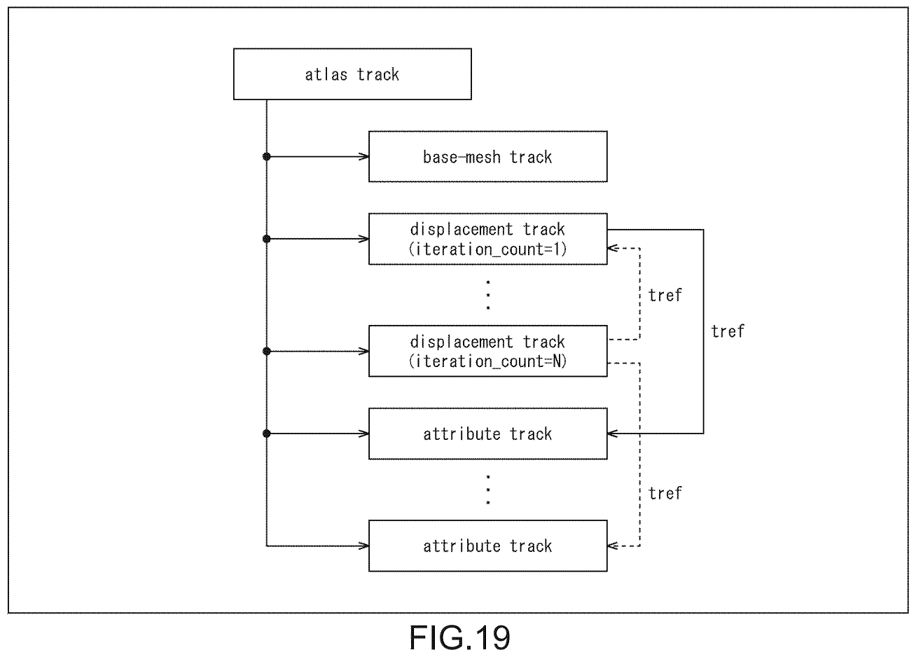

For example, as shown in FIG. 18, sitg (Subdivision iteration track group box) is set under trgr (tack grouping indication), new SubdivIterationTrackGroupBox is defined, and the grouping information is stored in the SubdivIterationTrackGroupBox. A description example of the SubdivIterationTrackGroupBox is shown in the rectangle 182 of FIG. 18. As shown in this description example, track_group_id is inherited from TrackGroupTypeBox indicating group identification information is stored in SubdivIterationTrackGroupBox as the grouping information.

TrackGroupTypeBox is stored. The attribute track and the displacement track corresponding to the same layer are grouped by identification information (track_group_id) indicated by this track_group_id is inherited from TrackGroupTypeBox.

By referring to the grouping information (track_group_id is inherited from TrackGroupTypeBox) that is stored in this SubdivIterationTrackGroupBox, the acquisition unit of the second information processing apparatus can easily identify which tracks belong to the same group. Thus, the second information processing apparatus can more easily select a displacement track and an attribute track corresponding to a desired layer and acquire the encoded data of the displacement vectors and the attributes necessary for reconstruction. That is, the first information processing apparatus can suppress a reduction in the quality of the mesh to be reconstructed (e.g., the image quality of the reconstructed mesh in the displayed image). Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can suppress an increase in processing load related to reconstruction of 3D data including displacement vectors.

It should be noted that also in this case, the displacement vectors that are stored in the displacement track may be relative displacement vectors or may be absolute displacement vectors. In a case where the relative displacement vectors are stored in the displacement track, as an example of the dotted line in FIG. 17, all displacement tracks necessary for reconstruction are associated by the grouping information.

Moreover, instead of track group identification information (track_group_id), track reference may be used as the grouping information described above. The track reference is information indicating a reference relationship between tracks. The displacement track and the attribute track corresponding to the same layer may be associated with each other by using this track reference. It should be noted that 4CC may be ‘disp’ for example.

For example, in the first information processing apparatus, the content file generation unit may store, as the grouping information, a track reference that refers to another track so as to group the attribute track and the displacement track necessary for reconstruction of the mesh for each of the layers, in the content file. Moreover, in the second information processing apparatus, the acquisition unit may acquire the encoded data of the attributes on the basis of a track reference that refers to another track so as to group the attribute track and the displacement track necessary for reconstruction of the mesh for each of the layers, the track reference being stored in the content file as the grouping information.

For example, in a case of FIG. 19, as shown in the solid arrow, a track reference (tref) that refers to the topmost attribute track is stored in the displacement track with iteration_count=1. That is, the displacement track with iteration_count=1 is associated with the topmost attribute track. Thus, this topmost attribute track is the attribute track with iteration_count=1. That is, in a case where the mesh to be reconstructed is of a layer with iteration_count=1, the encoded data is acquired and decoded from the displacement track with iteration_count=1 and the topmost attribute track, which are associated by this track reference (descriptions of the base mesh and the atlas information are omitted). With such a configuration, the displacement vectors and attributes necessary for reconstructing the mesh in the layer with iteration_count=1 can be obtained (there is no need to obtain displacement vectors and attributes of unnecessary layers).

Moreover, as shown by the dotted arrow in FIG. 19, a track reference (tref) that refers to all other displacement tracks and a track reference (tref) that refers to the bottom attribute track are stored in the displacement track with iteration_count=N. The track reference (tref) to which the bottom attribute track is referenced is stored. That is, the displacement track with iteration_count=N is associated with all other displacement tracks and the bottom attribute track. Thus, this bottom attribute track is the attribute track with iteration_count=N (i.e., the highest level of detail). That is, in a case where the mesh to be reconstructed is of a layer with iteration_count=N (i.e., highest level of detail), the encoded data is acquired and decoded from the displacement tracks with iteration_count=1 to iteration_count=N and the bottom attribute track, which are associated by this track reference (descriptions of the base mesh and the atlas information are omitted). With such a configuration, the displacement vectors and attributes necessary for reconstructing the mesh in the layer with iteration_count=N can be obtained (there is no need to obtain displacement vectors and attributes of unnecessary layers).

### <Method 2-1-2-1>

Moreover, in a case where Method 2-1-2 is applied, subdivision iteration count information may be further stored in the SubdivIterationTrackGroupBox may be stored as shown in the 14th row from the top of the table in FIG. 5 (Method 2-1-2-1). Then, during reconstruction, the layer of the displacement track or the attribute track may be identified on the basis of that subdivision iteration count information.

For example, in the first information processing apparatus, the content file generation unit may further store information (subdivision iteration count information) indicating the layer in the SubdivIterationTrackGroupBox. Moreover, in the second information processing apparatus, the acquisition unit may further acquire the encoded data of the attributes on the basis of information (subdivision iteration count information) indicating the layer stored in the SubdivIterationTrackGroupBox.

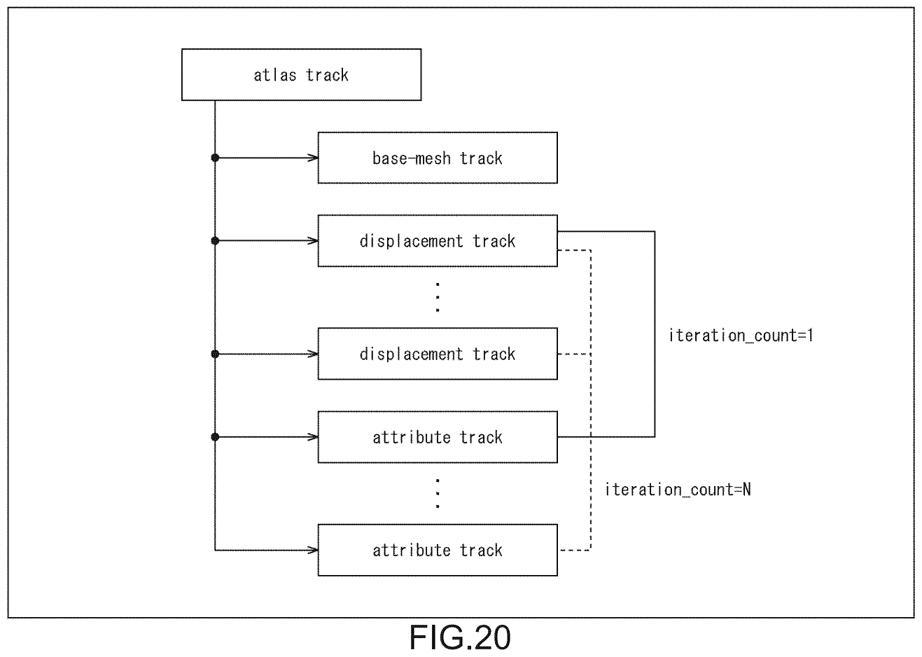

For example, as shown in FIG. 20, together with the grouping information for grouping the topmost attribute track and the displacement track with iteration_count=1, information (i.e., iteration_count=1) indicating a layer to which the topmost attribute track corresponds is stored in the SubdivIterationTrackGroupBox. Thus, on the basis of the information indicating this layer, it is possible to more easily grasp that this topmost attribute track is the attribute track with iteration_count=1.

Moreover, together with the grouping information for grouping the bottom attribute track and the displacement tracks with iteration_count=1 to iteration_count=N, information (i.e., iteration_count=N) indicating a layer to which the bottom attribute track corresponds is stored in the SubdivIterationTrackGroupBox. Thus, on the basis of the information indicating this layer, it is possible to more easily grasp that this bottom attribute track is the attribute track with iteration_count=N.

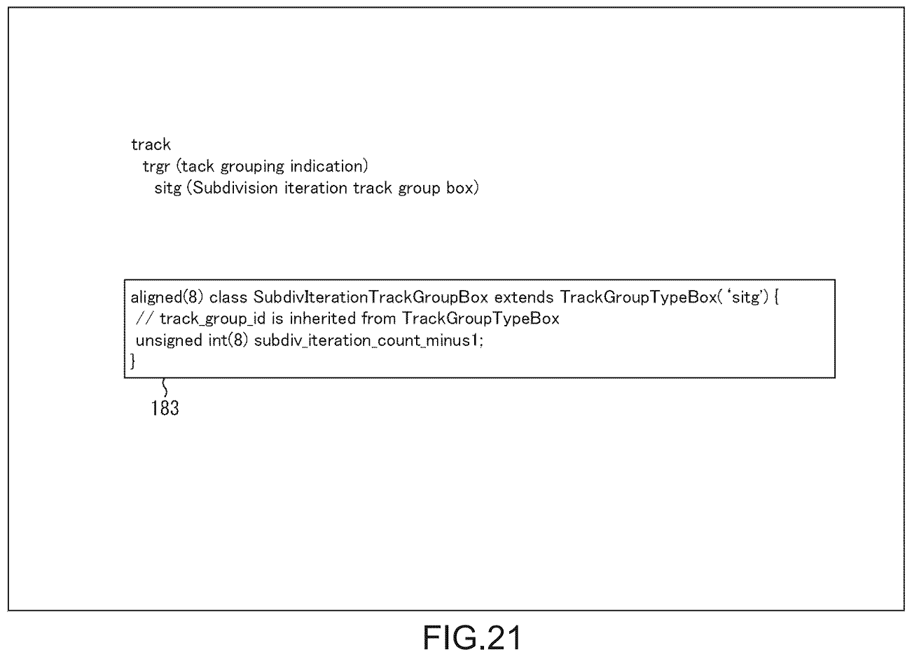

A description example of the SubdivIterationTrackGroupBox is shown in a rectangle 183 in FIG. 21. As shown in this description example, together with the grouping information (track_group_id is inherited from TrackGroupTypeBox), the variable subdiv_iteration_count_minus1 indicating the layer of the attributes as subdivision iteration count information is stored in SubdivIterationTrackGroupBox.

The acquisition unit of the second information processing apparatus can more easily identify a layer to which the attribute track corresponds by the subdivision iteration count information stored in this SubdivIterationTrackGroupBox. Thus, the second information processing apparatus can more easily select a displacement track and an attribute track corresponding to a desired layer and acquire the encoded data of the displacement vectors and the attributes necessary for reconstruction. That is, the first information processing apparatus can suppress a reduction in the quality of the mesh to be reconstructed (e.g., the image quality of the reconstructed mesh in the displayed image). Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can suppress an increase in processing load related to reconstruction of 3D data including displacement vectors.

It should be noted that also in this case, the displacement vectors that are stored in the displacement track may be relative displacement vectors or may be absolute displacement vectors. In a case where the relative displacement vectors are stored in the displacement track, as an example of the dotted line in FIG. 20, all displacement tracks necessary for reconstruction are associated by the grouping information. Moreover, in this case, SubdivIterationInfoBox may be omitted.

### <Method 2-2>

In a case of Method 2, as in a case of Method 1, the content file may be delivered by MPEG-DASH. That is, the delivery of the content file may be controlled by using MPD of the MPEG-DASH.

For example, in a case where Method 2 is applied, as shown in the 15th row from the top of the table in FIG. 5, association information between the attribute adaptation set and the displacement adaptation set may be stored in the MPD (Method 2-2). Then, the encoded data (stream) of the attributes that are stored in an attribute track corresponding to an attribute adaptation set corresponding to (a displacement adaptation set of) a desired layer may be delivered on the basis of that association information.

For example, in the file generation apparatus (first information processing apparatus) that generates the content file that stores the 3D data including the displacement vectors, the encoding unit may encode the attributes for each of layers of the levels of detail, the content file generation unit may store encoded data of the attributes for each of the layers in the mutually different attribute tracks of the content file, and the control file generation unit may store second association information for associating attribute adaptation sets that manage the attribute tracks with the displacement adaptation sets in the control file.

By storing the second association information for associating the attribute tracks with the displacement tracks in the control file (e.g., MPD), the playback apparatus that plays back the 3D data can more easily select an appropriate attribute adaptation set on the basis of the second association information. That is, the playback apparatus can cause attributes of the level of detail corresponding to the mesh to be reconstructed to be delivered more easily. Thus, the playback apparatus can perform the texture mapping more easily and correctly. That is, the first information processing apparatus can suppress a reduction in the quality of the mesh to be reconstructed (e.g., the image quality of the reconstructed mesh in the displayed image). Moreover, the first information processing apparatus can cause the encoded data of the attributes to be delivered more efficiently. For example, the first information processing apparatus can suppress an increase in transmission bandwidth required for delivery or can suppress an increase in transmission time. Moreover, the first information processing apparatus can suppress a reduction in stability of the delivery against external factors such as bandwidth fluctuations.

Moreover, by causing the attributes to be delivered on the basis of this second association information, the playback apparatus can suppress acquisition or decoding of attributes of unnecessary layers. That is, the first information processing apparatus can also suppress an increase in processing load related to reconstruction in the playback apparatus. Thus, the first information processing apparatus can suppress an increase in performance requirements of hardware necessary for executing the processing or can suppress an increase in processing time. That is, the first information processing apparatus can cause the playback apparatus to execute the processing related to reconstruction more efficiently. Thus, the first information processing apparatus can also suppress a reduction in stability of the processing.

Moreover, the content file may include the base-mesh track, a plurality of the attribute tracks that stores the encoded data of the attributes of the mutually different layers, and a plurality of the displacement tracks that stores the encoded data of the displacement vectors of the mutually different layers, and the control file may include second association information for associating the attribute adaptation sets with the displacement adaptation sets, and, in the playback apparatus (second information processing apparatus) that plays back the 3D data including the displacement vectors, the selection unit may select one of the attribute adaptation sets corresponding to the desired layer on the basis of the second association information, and the acquisition unit may acquire the encoded data of the attributes, which is stored in the attribute track of the content file, the attribute track being managed by the selected attribute adaptation set.

By storing the second association information for associating the attribute tracks with the displacement tracks in the control file (e.g., MPD) in this manner, the second information processing apparatus can more easily select an appropriate attribute adaptation set on the basis of the second association information. That is, the second information processing apparatus can cause attributes of the level of detail corresponding to the mesh to be reconstructed to be delivered more easily. Thus, the second information processing apparatus can perform the texture mapping more easily and correctly. That is, the second information processing apparatus can suppress a reduction in the quality of the mesh to be reconstructed (e.g., the image quality of the reconstructed mesh in the displayed image). Moreover, the second information processing apparatus can cause the encoded data of the attributes to be delivered more efficiently. For example, the second information processing apparatus can suppress an increase in transmission bandwidth required for delivery or can suppress an increase in transmission time. Moreover, the second information processing apparatus can suppress a reduction in stability of the delivery against external factors such as bandwidth fluctuations.

Moreover, by causing the attributes to be delivered on the basis of this second association information, the second information processing apparatus can suppress acquisition or decoding of attributes of unnecessary layers. That is, the second information processing apparatus can also suppress an increase in processing load related to reconstruction. Thus, the second information processing apparatus can suppress an increase in performance requirements of hardware necessary for executing the processing or can suppress an increase in processing time. That is, the second information processing apparatus can more efficiently execute the processing related to reconstruction. Thus, the second information processing apparatus can also suppress a reduction in stability of the processing.

### <Method 2-2-1>

In a case where Method 2-2 is applied, the subdivision iteration count information indicating the corresponding layer of the attributes may be stored in the attribute adaptation set of the control file (e.g., MPD) as the second association information as shown in the 16th row from the top of the table in FIG. 5 (Method 2-2-1). Then, an attribute adaptation set corresponding to a desired layer may be selected on the basis of that subdivision iteration count information, and the encoded data of the attributes that are stored in the attribute track that is managed by that attribute adaptation set may be delivered.

For example, in the first information processing apparatus, the control file generation unit may store, as the second association information, information (subdivision iteration count information) indicating the layers of the attributes that are stored in the attribute tracks that are managed by the attribute adaptation sets, in the attribute adaptation sets of the control file. Moreover, in the second information processing apparatus, the selection unit may select one of the attribute adaptation sets on the basis of the information (subdivision iteration count information) indicating the layers of the attributes that are stored in the attribute tracks that are managed by the attribute adaptation sets, the information (subdivision iteration count information) being stored in the attribute adaptation sets of the control file as the second association information.

By referring to the subdivision iteration count information that is stored in the attribute adaptation sets of this control file, the selection unit of the second information processing apparatus can more easily grasp a layer (subdivision iteration count) of the attributes that are stored in the attribute track that is managed by that attribute adaptation set. Thus, the second information processing apparatus can more easily select an attribute adaptation set corresponding to a desired layer and cause the encoded data of the attributes that are stored in the attribute track corresponding to the selected attribute adaptation set to be delivered. That is, the first information processing apparatus can suppress a reduction in the quality of the mesh to be reconstructed (e.g., the image quality of the reconstructed mesh in the displayed image). Moreover, the first information processing apparatus can cause the encoded data of the attributes required by the playback apparatus for reconstruction to be delivered more efficiently. Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can cause the encoded data of the attributes necessary for reconstruction to be delivered more efficiently. Moreover, the second information processing apparatus can suppress an increase in processing load related to reconstruction of 3D data including displacement vectors.

For example, in the first information processing apparatus, the control file generation unit may store, as the information indicating the layer, a V3C video component descriptor indicating the layer in an essential property or a supplemental property of the attribute adaptation set. Moreover, in the second information processing apparatus, the selection unit may select one of the attribute adaptation sets on the basis of a V3C video component descriptor indicating the layer, the V3C video component descriptor being stored in an essential property or a supplemental property of the attribute adaptation set as the information indicating the layer.

For example, information indicating the layer may be stored in the essential property or the supplemental property of the attribute adaptation set by using a V3C video component descriptor (subdivIterationCount) similar to the example described with reference to FIG. 11.

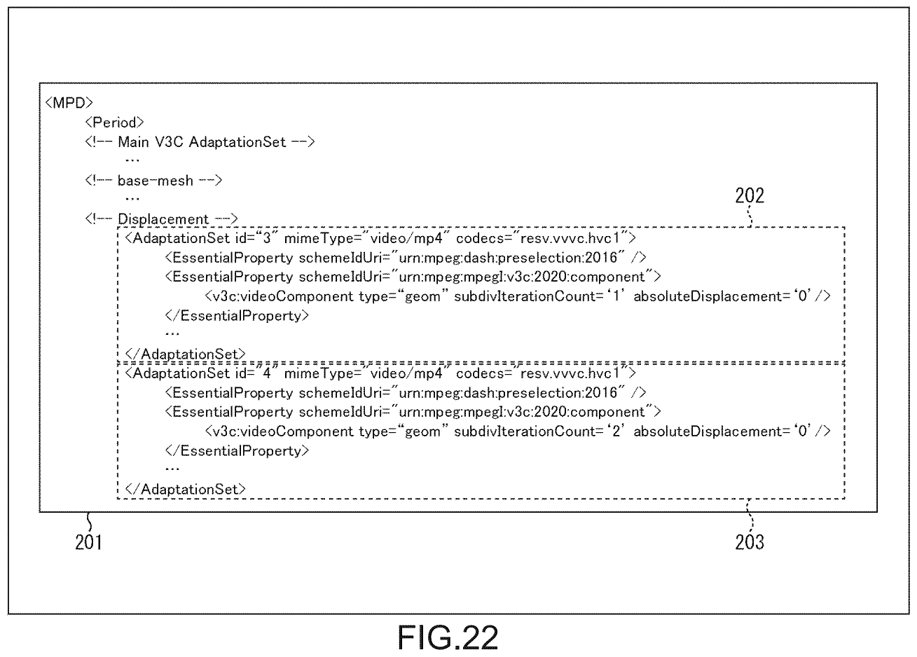

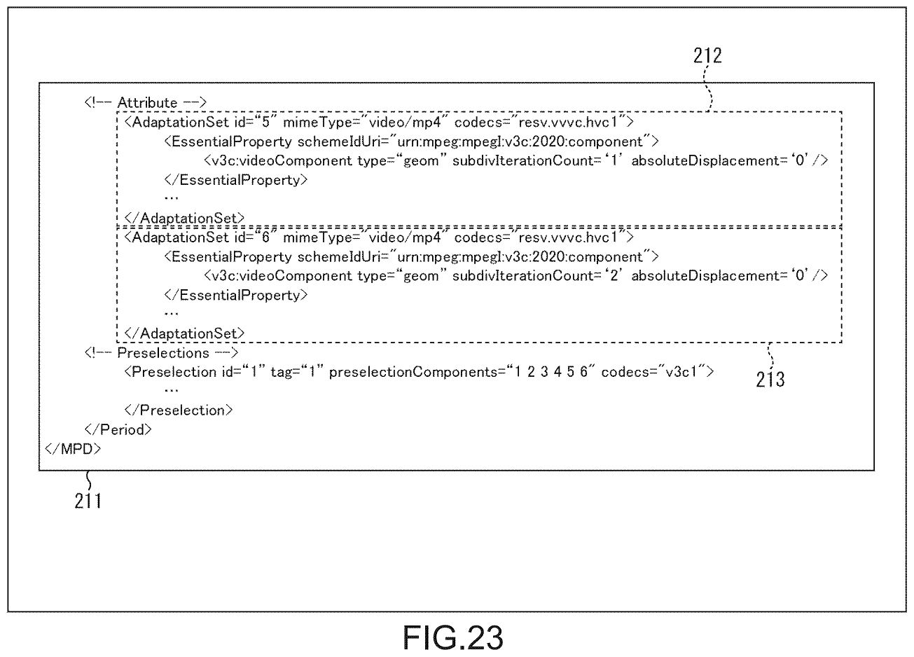

FIGS. 22 and 23 show description examples of the MPD. The description example shown in a rectangle 201 in FIG. 22 shows a description example of the first half of the MPD. A dotted-line rectangle 202 in FIG. 22 shows a description example of the displacement adaptation set (AdaptationSet id=“3”). In the essential property (<EssentialProperty schemeIdUri=“urn:mpeg:mpegI:v3c:2020:component”>) of this adaptation set, it is shown that the subdivision iteration count is “1” (subdivIterationCount=‘1’). Moreover, a dotted-line rectangle 203 in FIG. 22 shows a description example of the displacement adaptation set (AdaptationSet id=“4”). In the essential property (<EssentialProperty schemeIdUri=“urn:mpeg:mpegI:v3c:2020:component”>) of this adaptation set, it is shown that the subdivision iteration count is “2” (subdivIterationCount=‘2’).

The description example shown in a rectangle 211 of FIG. 23 shows a description example of the second half of the MPD. That is, the description example shown in a rectangle 211 of FIG. 23 is a continuation of the description example shown in the rectangle 201 of FIG. 22. A dotted-line rectangle 212 in FIG. 23 shows a description example of an attribute adaptation set (AdaptationSet id=“5”). In the essential property (<EssentialProperty schemeIdUri=“urn:mpeg:mpegI:v3c:2020:component”>) of this adaptation set, it is shown that the subdivision iteration count is “1” (subdivIterationCount=‘1’). Moreover, a dotted-line rectangle 213 in FIG. 23 shows a description example of an attribute adaptation set (AdaptationSet id=“6”). In the essential property (<EssentialProperty schemeIdUri=“urn:mpeg:mpegI:v3c:2020:component”>) of this adaptation set, it is shown that the subdivision iteration count is “2” (subdivIterationCount=‘2’). That is, the subdivision iteration count information specifies that the displacement adaptation set (AdaptationSet id=“3”) and an attribute adaptation set (AdaptationSet id=“5”) correspond to the same layer (subdivIterationCount=‘1’). That is, these adaptation sets are associated. Similarly, the subdivision iteration count information specifies that the displacement adaptation set (AdaptationSet id=“4”) and the attribute adaptation set (AdaptationSet id=“6”) correspond to the same layer (subdivIterationCount=‘2’). That is, these adaptation sets are associated.

Thus, as described above, the second information processing apparatus can more easily select an attribute adaptation set corresponding to a desired layer and cause the encoded data of the attributes that are stored in the attribute track corresponding to the selected attribute adaptation set to be delivered. That is, the first information processing apparatus can suppress a reduction in the quality of the mesh to be reconstructed (e.g., the image quality of the reconstructed mesh in the displayed image). Moreover, the first information processing apparatus can cause the encoded data of the attributes required by the playback apparatus for reconstruction to be delivered more efficiently. Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can cause the encoded data of the attributes necessary for reconstruction to be delivered more efficiently. Moreover, the second information processing apparatus can suppress an increase in processing load related to reconstruction of 3D data including displacement vectors.

It should be noted that a new descriptor indicating the information (subdivision iteration count information) indicating the layer of the displacement vectors may be defined without the V3C video component descriptor.

### <Method 2-2-1-1>

Moreover, in a case where Method 2-2-1 is applied, it may be possible to select relative displacement vectors or absolute displacement vectors as displacement vectors that are stored in the displacement track for the vertices obtained in a lower level layer than the corresponding layer. In that case, type information specifying which of the relative displacement vectors or absolute displacement vectors are stored in the displacement track may be stored in the MPD as shown in the 17th row from the top of the table in FIG. 5 (Method 2-2-1-1). Then, during reconstruction, the encoded data of the attributes that are stored in an attribute track that is managed by an attribute adaptation set corresponding to a desired layer may be delivered on the basis of that type information.

For example, in the first information processing apparatus, the control file generation unit may further store type information indicating whether the displacement vectors are absolute displacement vectors or relative displacement vectors, in the attribute adaptation sets of the control file. Moreover, in the second information processing apparatus, the selection unit may further select one of the attribute adaptation sets on the basis of type information indicating whether the displacement vectors are absolute displacement vectors or relative displacement vectors, the type information being stored in the attribute adaptation sets of the control file. It should be noted that the absolute displacement vectors are the displacement vectors indicating displacement of vertices from the base mesh, the vertices being obtained by subdividing the mesh, and the relative displacement vectors are the displacement vectors indicating displacement of vertices from positions in one lower-level layer, the vertices being obtained by subdividing the mesh.

This type information may be stored in, for example, an essential property or a supplemental property of the attribute adaptation set. For example, by extending a V3C video component descriptor, the type information may be defined and stored. Then, during reconstruction, an attribute adaptation set corresponding to a desired layer may be selected on the basis of the type information that is stored in the essential property or the supplemental property of the attribute adaptation set by using that extended V3C video component descriptor.

For example, in the first information processing apparatus, the control file generation unit may store, as the type information, a V3C video component descriptor indicating whether the displacement vectors are the absolute displacement vectors or the relative displacement vectors, in an essential property or a supplemental property of the displacement adaptation set. Moreover, in the second information processing apparatus, the selection unit may select one of the attribute adaptation sets on the basis of a V3C video component descriptor indicating whether the displacement vectors are the absolute displacement vectors or the relative displacement vectors, the V3C video component descriptor being stored in an essential property or a supplemental property of the attribute adaptation set as the type information.

For example, as described with reference to FIG. 11, videoComponent@absoluteDisplacement is defined as an extended V3C video component descriptor. In a case where the value of this videoComponent@absoluteDisplacement “0,” it indicates that the relative displacement vectors are stored as the displacement vectors of the vertices obtained in a lower level layer than the corresponding layer. Moreover, in a case where the value of this videoComponent@absoluteDisplacement “1,” it indicates that the absolute displacement vectors are stored as the displacement vectors of the vertices. It should be noted that this value example is an example. Not limited to this example, the videoComponent@absoluteDisplacement may have any value, and this value may indicate any type of displacement vectors.

As shown in a dotted-line rectangle 212 in FIG. 23, in the essential property (<EssentialProperty schemeIdUri=“urn:mpeg:mpegI:v3c:2020:component”>) of the attribute adaptation set (AdaptationSet id=“5”), it indicates that the relative displacement vectors are stored in the displacement track (absoluteDisplacement=‘0’) as the displacement vectors of the vertices obtained in a lower level layer than the corresponding layer. Moreover, in the essential property (<EssentialProperty schemeIdUri=“urn:mpeg:mpegI:v3c:2020:component”>) of the attribute adaptation set (AdaptationSet id=“6”), it indicates that the relative displacement vectors are stored in the displacement track (absoluteDisplacement=‘0’) as the displacement vectors of the vertices obtained in a lower level layer than the corresponding layer.

Since the type information is stored in essential properties or supplemental properties of the attribute adaptation sets in the MPD in this manner, the selection unit of the second information processing apparatus can easily identify whether the displacement vectors that are stored in the displacement track that is managed by the displacement adaptation set corresponding to that attribute adaptation set, are the absolute displacement vectors or the relative displacement vectors by referring to this type information. Thus, the second information processing apparatus can more easily select a displacement adaptation set corresponding to a desired layer properly and cause the encoded data of the displacement vectors necessary for reconstruction to be delivered. That is, the first information processing apparatus can suppress an increase in processing load related to reconstruction of 3D data including displacement vectors. Moreover, the second information processing apparatus can suppress an increase in processing load related to reconstruction of 3D data including displacement vectors.

It should be noted that a new descriptor indicating the type information may be defined without the V3C video component descriptor.

### <Method 2-2-2>

In a case where Method 2-2 is applied, the attribute adaptation set and the displacement adaptation set may be grouped by using a preselection of the MPD as shown in the 18th row from the top of the table in FIG. 5 (Method 2-2-2). Then, during reconstruction, an attribute adaptation set corresponding to a desired layer may be selected on the basis of that preselection, and the encoded data of the attributes that are stored in the attribute track that is managed by that attribute adaptation set may be delivered.

For example, in the first information processing apparatus, the control file generation unit may store, as the second association information, a preselection for grouping the attribute adaptation set and the displacement adaptation set that manage tracks necessary for reconstruction of the mesh for each of the layers, in the control file. Moreover, in the second information processing apparatus, the selection unit may select one of the attribute adaptation sets on the basis of a preselection for grouping the attribute adaptation set and the displacement adaptation set that manage tracks necessary for reconstruction of the mesh for each of the layers, the preselection being stored in the control file as the second association information.

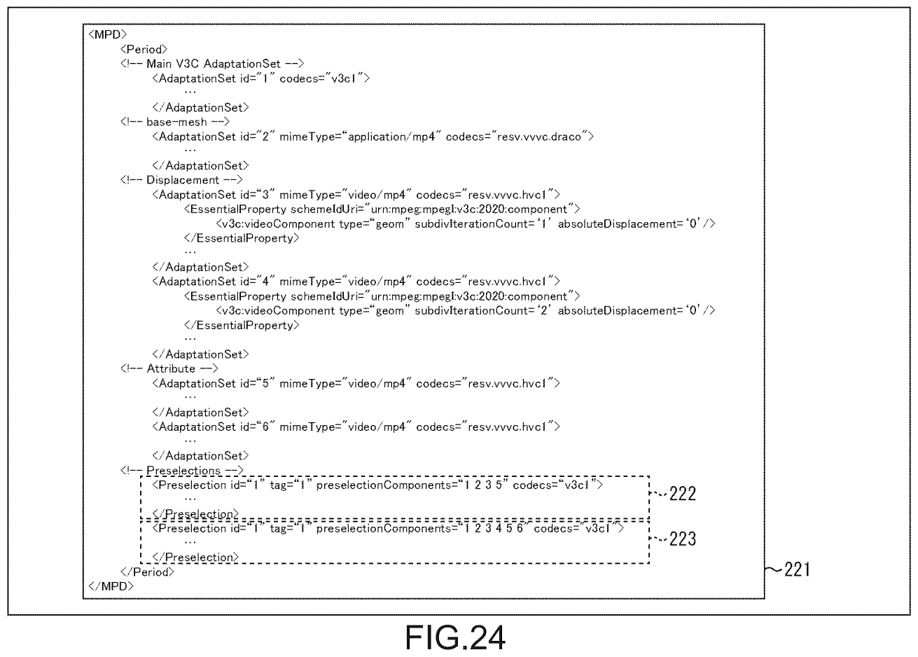

A rectangle 221 in FIG. 24 shows a description example of the MPD in that case. As shown in this description example, a preselection is provided in the MPD, and information for grouping the attribute adaptation set and the displacement adaptation set is stored in the preselection. For example, in a description shown in a dotted-line rectangle 222, it is specified that an atlas adaptation set (AdaptationSet id=“1”) that manages an atlas track, the base-mesh adaptation set (AdaptationSet id=“2”) that manages the base-mesh track, the displacement adaptation set (AdaptationSet id=“3”) that manages the displacement track, and the attribute adaptation set (AdaptationSet id=“5”) that manages the attribute track are grouped (<Preselection id=“1” tag=“1” preselectionComponents=“1 2 3 5” codecs=“v3c1”>). Moreover, in a description shown in a dotted-line rectangle 223, it is specified that the atlas adaptation set (AdaptationSet id=“1”), the base-mesh adaptation set (AdaptationSet id=“2”), the displacement adaptation set (AdaptationSet id=“3”), the displacement adaptation set (AdaptationSet id=“4”), the attribute adaptation set (AdaptationSet id=“5”), and the attribute adaptation set (AdaptationSet id=“6”) are grouped (<Preselection id=“1” tag=“1” preselectionComponents=“1 2 3 4 5 6” codecs=“v3c1”>).

Thus, the second information processing apparatus can more easily select an attribute adaptation set corresponding to a desired layer on the basis of this preselection and cause the encoded data of the attributes that is stored in the attribute track corresponding to the selected attribute adaptation set to be delivered. That is, the first information processing apparatus can suppress a reduction in the quality of the mesh to be reconstructed (e.g., the image quality of the reconstructed mesh in the displayed image). Moreover, the first information processing apparatus can cause the encoded data of the attributes required by the playback apparatus for reconstruction to be delivered more efficiently. Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can cause the encoded data of the attributes necessary for reconstruction to be delivered more efficiently. Moreover, the second information processing apparatus can suppress an increase in processing load related to reconstruction of 3D data including displacement vectors.

### <Method 2-2-2-1>

It should be noted that moreover, the information (subdivision iteration count information) indicating the layer of the displacement vectors may be stored in the control file. For example, by a method similar to the case of Method 1-2-1, the information (subdivision iteration count information) indicating the layer of the displacement vectors may be stored in the control file.

For example, in a case where Method 2-2-2 is applied, the subdivision iteration count information may be stored in the displacement adaptation set of the MPD as shown in the 19th row from the top of the table in FIG. 5 (Method 2-2-2-1). Then, during reconstruction, an attribute adaptation set corresponding to a desired layer may be selected on the basis of that subdivision iteration count information, and the encoded data of the attributes that are stored in the attribute track that is managed by that attribute adaptation set may be delivered.

For example, the subdivision iteration count information may be stored in the essential property or the supplemental property of the displacement adaptation set. Moreover, a V3C video component descriptor indicating the layer may be stored as the subdivision iteration count information. For example, as described with reference to FIG. 11, videoComponent@subdivIterationCount may be stored. For example, in a description example in FIG. 24, in the essential property (<EssentialProperty schemeIdUri=“urn:mpeg:mpegI:v3c:2020:component”> of the displacement adaptation set (AdaptationSet id=“3”), it is shown that the subdivision iteration count is “1” (subdivIterationCount=‘1’). Moreover, in the essential property (<EssentialProperty schemeIdUri=“urn:mpeg:mpegI:v3c:2020:component”>) of the it is shown that the subdivision iteration count is “1” (subdivIterationCount=‘2’).

By storing the subdivision iteration count information in the MPD in this manner, it is possible to more easily grasp a layer corresponding to the displacement adaptation set on the basis of this subdivision iteration count information.

### <Method 2-2-2-2>

Moreover, the information (subdivision iteration count information) indicating the layer of the displacement vectors may be stored in a preselection of the control file. That is, in a case where Method 2-2-2 is applied, subdivision iteration count information may be stored in a preselection of the MPD as shown in the 20th row from the top of the table in FIG. 5 (Method 2-2-2-2). Then, during reconstruction, an attribute adaptation set corresponding to a desired layer may be selected on the basis of that subdivision iteration count information, and the encoded data of the attributes that are stored in the attribute track that is managed by that attribute adaptation set may be delivered.

For example, in the first information processing apparatus, the control file generation unit may store information indicating the layer of the attributes that are stored in the attribute track that is managed by the attribute adaptation set, in the preselection. Moreover, in the second information processing apparatus, the selection unit may select one of the attribute adaptation sets on the basis of information indicating the layer of the attributes that are stored in the attribute track that is managed by the attribute adaptation set, the information being stored in the preselection.

For example, in the first information processing apparatus, the control file generation unit may store, as the information indicating the layer, a subdivision iteration information descriptor indicating the layer, in an essential property or a supplemental property of the preselection. Moreover, in the second information processing apparatus, the selection unit may select one of the attribute adaptation sets on the basis of a subdivision iteration information descriptor indicating the layer, the subdivision iteration information descriptor being stored in an essential property or a supplemental property of the preselection as information indicating the layer.

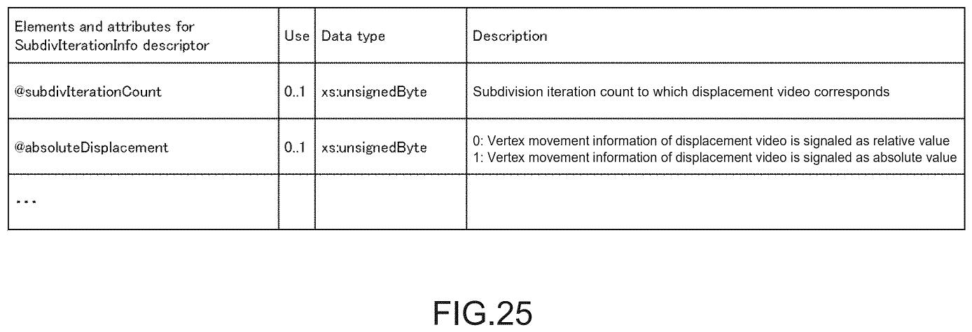

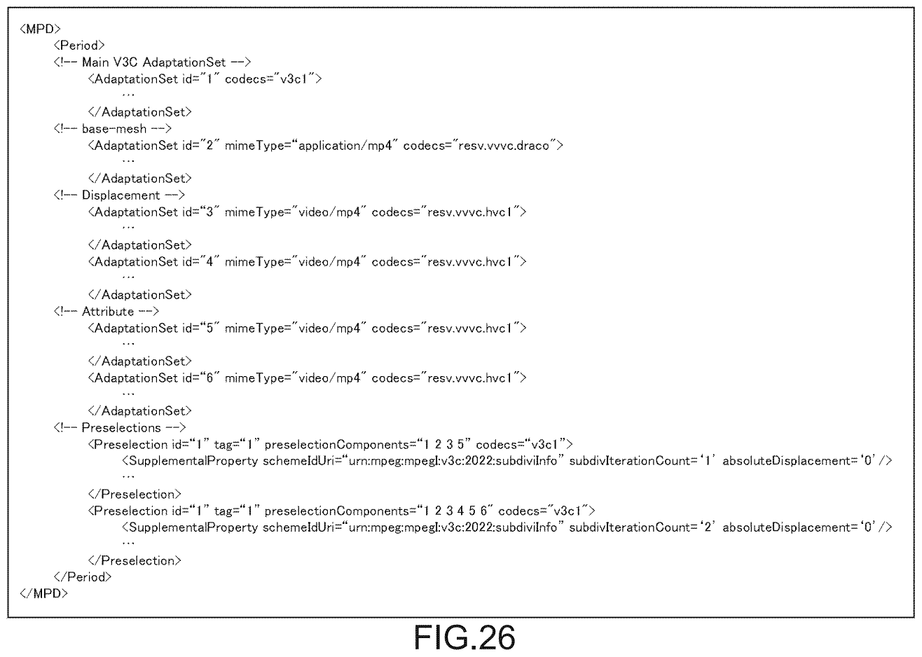

For example, as shown in FIG. 25, @subdivIterationCount may be provided as the subdivision iteration information descriptor indicating the layer, and this @subdivIterationCount may be stored in essential properties or supplemental properties of preselections. FIG. 26 shows a description example of the MPD in that case. In a case of the example in FIG. 26, in the supplemental property of the upper preselection, it is shown that subdivIterationCount=‘1’. Moreover, in the supplemental property of the lower preselection, it is shown that subdivIterationCount=‘2’.

By storing the information indicating the layers in the preselections in this manner, it is possible to easily grasp a layer to which the displacement adaptation set or the attribute adaptation set corresponds on the basis of the information indicating that layer.

It should be noted that in this case, in the displacement adaptation set or the attribute adaptation set, storing the information indicating the layer may be omitted.

### <Method 2-2-2-2-1>

In a case where Method 2-2-2-2 is applied, the type information may be stored in a preselection of the MPD as shown in the 21st row from the top of the table in FIG. 5 (Method 2-2-2-2-1). Then, during reconstruction, the encoded data of the attributes that are stored in an attribute track that is managed by an attribute adaptation set corresponding to a desired layer may be delivered on the basis of that type information.

For example, in the first information processing apparatus, the control file generation unit may store type information indicating whether the displacement vectors are absolute displacement vectors or relative displacement vectors, in the preselection. Moreover, in the second information processing apparatus, the selection unit may further select one of the attribute adaptation sets on the basis of type information indicating whether the displacement vectors are absolute displacement vectors or relative displacement vectors, the type information being stored in the preselection. It should be noted that the absolute displacement vectors are the displacement vectors indicating displacement of vertices from the base mesh, the vertices being obtained by subdividing the mesh. The relative displacement vectors are the displacement vectors indicating displacement of vertices from positions in one lower-level layer, the vertices being obtained by subdividing the mesh.

For example, in the first information processing apparatus, the control file generation unit may store, as the type information, a descriptor indicating whether the displacement vectors are the absolute displacement vectors or the relative displacement vectors, in an essential property or a supplemental property of the preselection. Moreover, in the second information processing apparatus, the selection unit may select one of the attribute adaptation sets on the basis of a descriptor indicating whether the displacement vectors are the absolute displacement vectors or the relative displacement vectors, the descriptor being stored in an essential property or a supplemental property of the preselection as the type information.

For example, as shown in FIG. 25, @absoluteDisplacement may be provided as the subdivision iteration information descriptor indicating whether the displacement vectors are the absolute displacement vectors or the relative displacement vectors, and this @absoluteDisplacement may be stored in the essential property or the supplemental property of the preselection. In a case of the example in FIG. 26, in the supplemental properties of the preselections, they indicate that the displacement vectors are the relative displacement vectors (absoluteDisplacement=‘0’).

By storing the type information in the preselections in this manner, it is possible to easily identify the displacement vectors that are stored in the displacement track that is managed by the displacement adaptation set are the absolute displacement vectors or the relative displacement vectors.

It should be noted that a new descriptor indicating the type information may be defined without the V3C video component descriptor. Moreover, in this case, in the displacement adaptation set or the attribute adaptation set, storing the type information may be omitted.

### <Method 2-2-3>

In a case where Method 2-2 is applied, the displacement adaptation set and the attribute adaptation set may be grouped by association identification information (association id) or dependency identification information (dependency id) of the MPD as shown in the bottom row of the table in FIG. 5 (Method 2-2-3). Then, during reconstruction, the encoded data of the attributes that are stored in an attribute track that is managed by an attribute adaptation set corresponding to a desired layer may be delivered on the basis of that association identification information or dependency identification information. The association identification information and the dependency identification information are information indicating another adaptation set that is associated with that adaptation set.

For example, in the first information processing apparatus, the control file generation unit may store, as the second association information, association identification information for associating the attribute adaptation set and the displacement adaptation set that manage tracks necessary for reconstruction of the mesh for each of the layers with each other, in the control file. Moreover, in the second information processing apparatus, the selection unit may select one of the attribute adaptation sets on the basis of association identification information for associating the attribute adaptation set and the displacement adaptation set that manage tracks necessary for reconstruction of the mesh for each of the layers with each other, the association identification information being stored in the control file as the second association information.

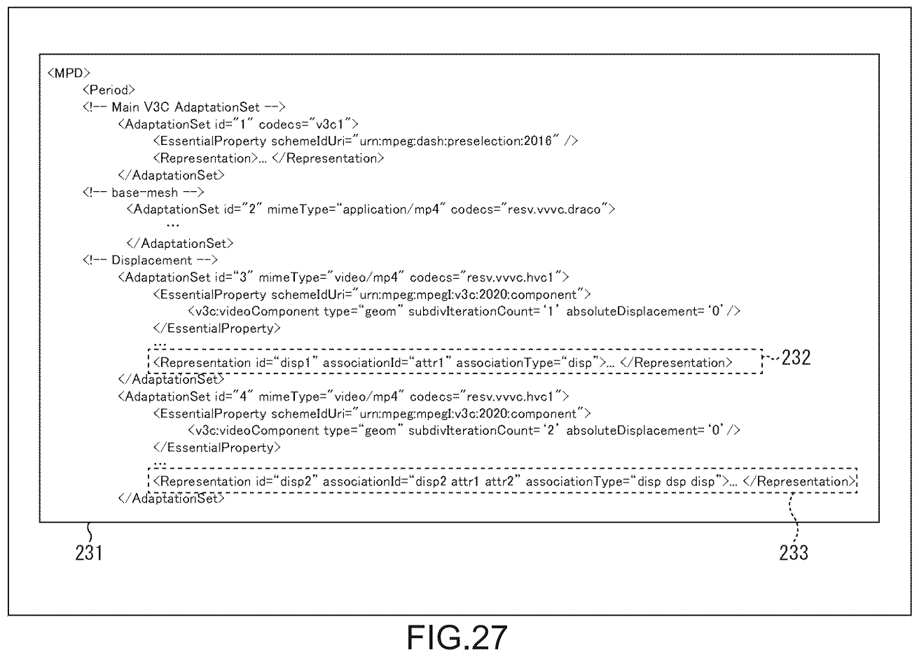

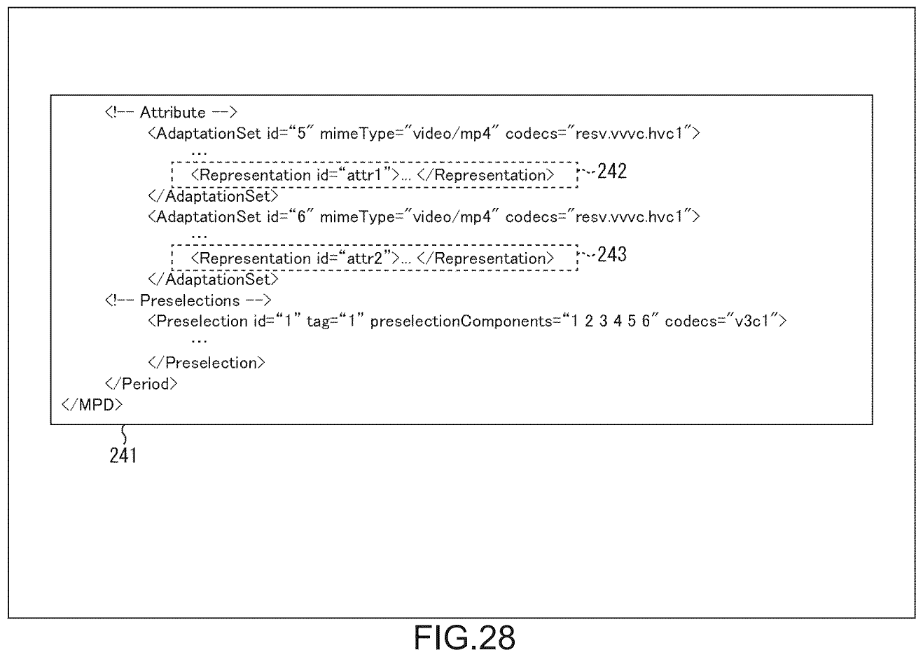

FIGS. 27 and 28 shows description examples of the MPD in that case. The description example shown in a rectangle 231 of FIG. 27 shows a description example of the first half of the MPD. A dotted-line rectangle 232 in FIG. 27 shows a description example of representation of the displacement adaptation set (AdaptationSet id=“3”). In this representation, identification (Representation id=“disp1”) of this representation is shown. Moreover, a dotted-line rectangle 233 shows a description example of representation of the displacement adaptation set (AdaptationSet id=“4”). In this representation, identification (Representation id=“disp2”) of this representation is shown.

The description example shown in a rectangle 241 of FIG. 28 shows a description example of the second half of the MPD. That is, the description example shown in a rectangle 241 of FIG. 28 is a continuation of the description example shown in the rectangle 231 of FIG. 27. A dotted-line rectangle 242 in FIG. 28 shows a description example of representation of the attribute adaptation set (AdaptationSet id=“5”). In this representation, identification (Representation id=“attr1”) of this representation is shown. Moreover, the dotted-line rectangle 243 shows a description example of representation of the attribute adaptation set (AdaptationSet id=“6”). In this representation, identification (Representation id=“attr2”) of this representation is shown.

Moreover, in a dotted-line rectangle 232 in FIG. 27, association identification information (association id=“attr1”) of this displacement adaptation set (AdaptationSet id=“3”) is shown. That is, this displacement adaptation set (AdaptationSet id=“3”) and the attribute adaptation set (AdaptationSet id=“5”) are associated with each other. Moreover, in a dotted-line rectangle 233 in FIG. 27, association identification information (association id=“disp2 attr1 attr2”) of this displacement adaptation set (AdaptationSet id=“4”) is shown. That is, this displacement adaptation set (AdaptationSet id=“4”) is associated with the attribute adaptation set (AdaptationSet id=“5”) and the attribute adaptation set (AdaptationSet id=“6”).

Regarding the dependency identification information, it can be associated in a manner similar to this association identification information.

Thus, the second information processing apparatus can more easily select an attribute adaptation set corresponding to a desired layer on the basis of this association identification information or dependency identification information and cause the encoded data of the attributes that is stored in the attribute track corresponding to the selected attribute adaptation set to be delivered. That is, the first information processing apparatus can suppress a reduction in the quality of the mesh to be reconstructed (e.g., the image quality of the reconstructed mesh in the displayed image). Moreover, the first information processing apparatus can cause the encoded data of the attributes required by the playback apparatus for reconstruction to be delivered more efficiently. Moreover, the first information processing apparatus can suppress an increase in processing load related to reconstruction of 3D data including displacement vectors. Moreover, the second information processing apparatus can suppress a reduction in the quality of the mesh to be reconstructed (e.g., the image quality of the reconstructed mesh in the displayed image). Moreover, the second information processing apparatus can cause the encoded data of the attributes necessary for reconstruction to be delivered more efficiently.

Moreover, the second information processing apparatus can suppress an increase in processing load related to reconstruction of 3D data including displacement vectors.

### <Combination>

Each of the above-mentioned methods in <3. Playback Control for Each Layer of Displacement Vectors> and <4. Playback Control for Each Layer of Attributes> may be applied in combination with any other method. That is, two or more of the above-mentioned methods may be applied in combination.

### 5. MATROSKA MEDIA CONTAINER

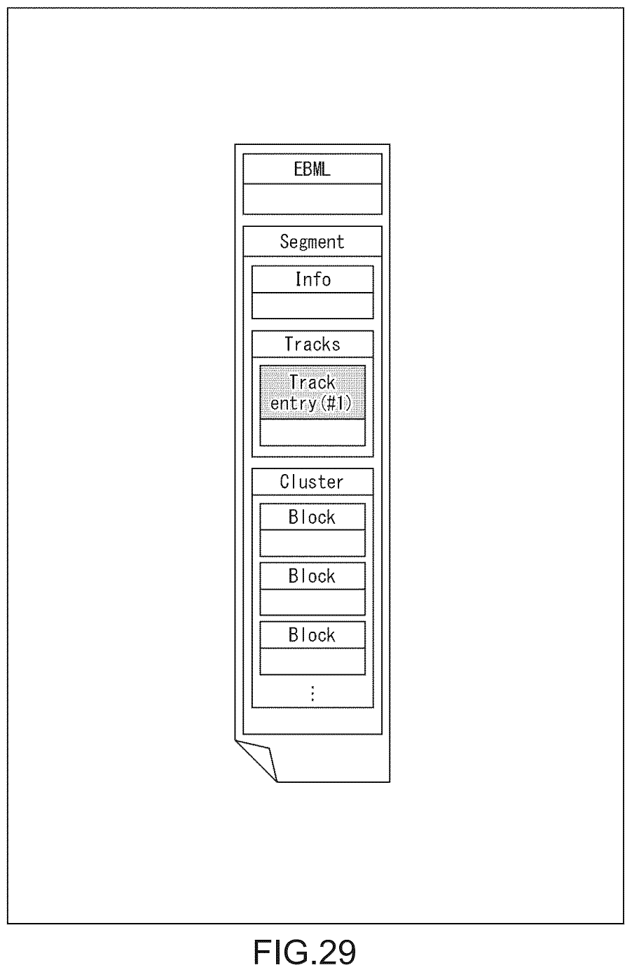

Hereinabove, the ISOBMFF has been described as an example of a file for delivery (file container), but any format or specification of the file for delivery that perform extended definitions of media associated with 3D data may be used, and is not limited to the ISOBMFF. For example, a Matroska media container as shown in FIG. 29 may be employed. As a matter of course, any other format may be employed.

### 6. FIRST EMBODIMENT

### <File Generation Apparatus>

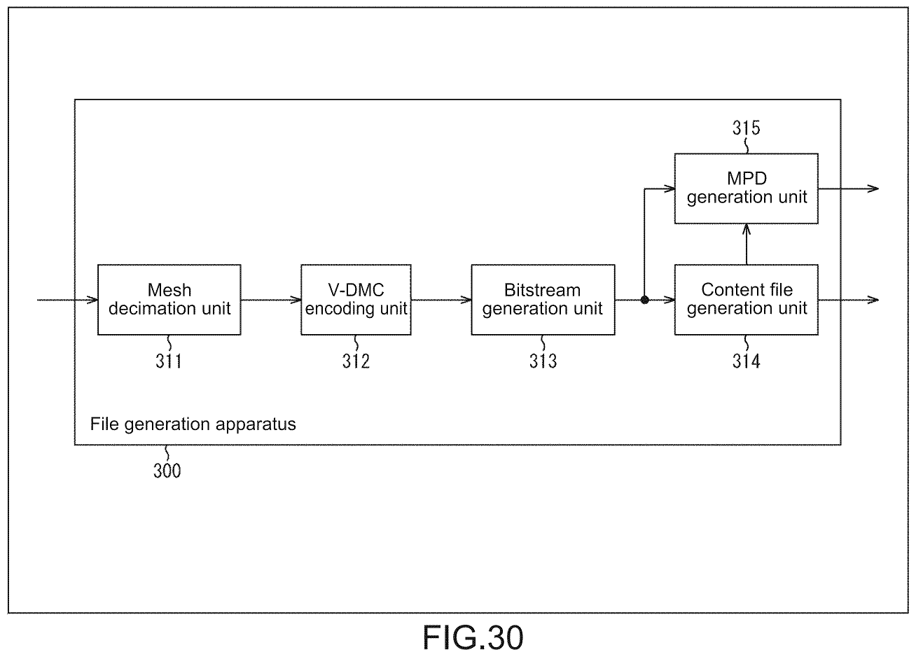

The above-mentioned present technology can be applied to any apparatus. FIG. 30 is a block diagram showing a configuration example of a file generation apparatus that is an embodiment of the information processing apparatus to which the present technology is applied. A file generation apparatus 300 shown in FIG. 30 is an apparatus that generates a content file by converting mesh data into V-DMC data, encoding it, and storing it in a file container, e.g., ISOBMFF. Moreover, the file generation apparatus 300 generates a control file (e.g., MPD of MPEG-DASH) that stores control information for controlling delivery of the content file.

It should be noted that in FIG. 30, the main processing units and data flow, etc. are shown, and the present technology is not limited to those shown in FIG. 30. That is, in the file generation apparatus 300, there may be processing units not shown as blocks in FIG. 30, or there may be processing or data flows not shown as arrows, etc. in FIG. 30.

As shown in FIG. 30, the file generation apparatus 300 includes a mesh decimation unit 311, a V-DMC encoding unit 312, a bitstream generation unit 313, a content file generation unit 314, and an MPD generation unit 315.

The mesh decimation unit 311 performs processing related to decimation of the mesh. The decimation is processing of reducing the number of faces (polygons) by decimating some vertices (and connections) from the mesh. For example, the mesh decimation unit 311 acquires the mesh data as an encoding target (delivery target) supplied to the file generation apparatus 300. The mesh decimation unit 311 generates a base mesh by decimating the acquired mesh data (original mesh). Moreover, the mesh decimation unit 311 subdivides the base mesh, thereby generating displacement vectors corresponding to the base mesh. Moreover, the mesh decimation unit 311 generates atlas information corresponding to the base mesh, displacement vectors, and attributes (textures). That is, the mesh decimation unit 311 converts the mesh data into V-DMC data. At that time, the mesh decimation unit 311 executes the subdivision as iterative processing and layers the displacement vectors by the level of detail. The mesh decimation unit 311 supplies the generated V-DMC data to the V-DMC encoding unit 312.

The V-DMC encoding unit 312 executes processing related to encoding of V-DMC data. For example, the V-DMC encoding unit 312 acquires the V-DMC data supplied by the mesh decimation unit 311. Moreover, the V-DMC encoding unit 312 encodes the acquired V-DMC data. That is, the V-DMC encoding unit 312 encodes each of the atlas information, base mesh, displacement vectors, and attributes included in the V-DMC data to generate encoded data of the atlas information, encoded data of the base mesh, encoded data of the displacement vectors, and encoded data of the attributes. The V-DMC encoding unit 312 supplies the generated encoded data of the atlas information, the generated encoded data of the base mesh, the generated encoded data of the displacement vectors, and the generated encoded data of the attributes to the bitstream generation unit 313. It can also be said that the V-DMC encoding unit 312 is an encoding unit.

The bitstream generation unit 313 executes processing related to generation of a bitstream. For example, the bitstream generation unit 313 acquires the encoded data of the atlas information, the encoded data of the base mesh, the encoded data of the displacement vectors, and the encoded data of the attributes that are supplied by the V-DMC encoding unit 312. Moreover, the bitstream generation unit 313 combines the respective types of the acquired encoded data as a substream to generate a V-DMC bitstream. The bitstream generation unit 313 supplies the generated V-DMC bitstream to the content file generation unit 314 and the MPD generation unit 315.

The content file generation unit 314 executes processing related to generation of the content file. For example, the content file generation unit 314 acquires the V-DMC bitstream supplied from the bitstream generation unit 313. Moreover, the content file generation unit 314 generates a content file such as the ISOBMFF and stores the acquired V-DMC bitstream in the content file. The content file generation unit 314 outputs the generated content file to an external device (e.g., delivery server or playback apparatus) of the file generation apparatus 300. Moreover, the content file generation unit 314 also supplies the content file to the MPD generation unit 315.

The MPD generation unit 315 executes processing related to generation of a control file (MPD) that controls the delivery of content files. For example, the MPD generation unit 315 acquires the V-DMC bitstream supplied from the bitstream generation unit 313. Moreover, the MPD generation unit 315 acquires the content file supplied from the content file generation unit 314. The MPD generation unit 315 generates an MPD corresponding to the content file on the basis of those acquired information. The MPD generation unit 315 outputs the generated MPD to the external device (e.g., delivery server or playback apparatus) of the file generation apparatus 300. It can also be said that the MPD generation unit 315 is a control file generation unit.

In the file generation apparatus 300 with the above-mentioned configuration, it may be the first information processing apparatus as described above, and the present technology described in <3. Playback Control for Each Layer of Displacement Vectors> to <5. Matroska Media Container> above may be applied. That is, the file generation apparatus 300 may apply one or more of the various methods shown in the table in FIG. 5 to generate the content file and the MPD. With such a configuration, the file generation apparatus 300 can obtain the above-mentioned effects in <3. Playback Control for Each Layer of Displacement Vectors> and <4. Playback Control for Each Layer of Attributes>. For example, the file generation apparatus 300 can suppress an increase in processing load related to reconstruction of 3D data including displacement vectors.

For example, Method 1 above may be applied to the file generation apparatus 300. Moreover, Method 1-1 above may be applied to the file generation apparatus 300. That is, the V-DMC encoding unit 312 may encode the base mesh and the attributes and encode the displacement vectors for each of layers of the levels of detail. Moreover, the content file generation unit 314 may generate a content file, store encoded data of the base mesh in a base-mesh track of the content file, store encoded data of the attributes in an attribute track of the content file, store encoded data of the displacement vectors for each layer in mutually different displacement tracks of the content file, and store first association information for associating the displacement tracks with the layers in the content file. With such a configuration, the file generation apparatus 300 can obtain the above-mentioned effects in <Method 1-1>. As a matter of course, other methods belonging to this Method 1-1 (e.g., Method 1-1-1, Method 1-1-1-1, and Method 1-1-1-2) may be applied to the file generator 300. Moreover, methods other than these may be applied.

Moreover, Method 1-2 above may be applied to file generation apparatus 300. That is, the V-DMC encoding unit 312 may encode the base mesh and the attributes and encode the displacement vectors for each of layers of the levels of detail. Moreover, the content file generation unit 314 may generate a content file, store encoded data of the base mesh in a base-mesh track of the content file, store encoded data of the attributes in an attribute track of the content file, and store encoded data of the displacement vectors for each layer in mutually different displacement tracks of the content file. Moreover, the MPD generation unit 315 may generate a control file (MPD) including control information for controlling delivery of the content file, and store first association information for associating displacement adaptation sets that manage the displacement tracks with the layers in the control file (MPD). With such a configuration, the file generation apparatus 300 can obtain the above-mentioned effects in <Method 1-2>. As a matter of course, other methods belonging to this Method 1-2 (e.g., Method 1-2-1, Method 1-2-1-1, and Method 1-2-1-2) may be applied to the file generator 300. Moreover, methods other than these may be applied.

Moreover, Method 2 above may be applied to the file generation apparatus 300. Moreover, Method 2-1 above may be applied to the file generation apparatus 300. That is, the V-DMC encoding unit 312 may encode the attributes for each of layers of the levels of detail. Moreover, the content file generation unit 314 may store encoded data of the attributes for each of the layers in mutually different attribute tracks of the content file and store second association information for associating the attribute tracks with the displacement tracks in the content file. With such a configuration, the file generation apparatus 300 can obtain the above-mentioned effects in <Method 2-1>. As a matter of course, other methods belonging to this Method 2-1 (e.g., Method 2-1-1, Method 2-1-2, and Method 2-1-2-1) may be applied to the file generator 300. Moreover, methods other than these may be applied.

Moreover, Method 2-2 above may be applied to file generation apparatus 300. That is, the V-DMC encoding unit 312 may encode the attributes for each of layers of the levels of detail. Moreover, the content file generation unit 314 may store encoded data of the attributes for each of the layers in mutually different attribute tracks of the content file. Moreover, the MPD generation unit 315 may store second association information for associating attribute adaptation sets that manage the attribute tracks with the displacement adaptation sets in the control file (MPD). With such a configuration, the file generation apparatus 300 can obtain the above-mentioned effects in <Method 2-2>. As a matter of course, other methods belonging to this Method 2-2 (e.g., Method 2-2-1, Method 2-2-1-1, Method 2-2-2, Method 2-2-2-1, Method 2-2-2-2, Method 2-2-2-2-1, and Method 2-2-3) may be applied to the file generation apparatus 300. Moreover, methods other than these may be applied.

### <Flow 1 of File Generation Processing>

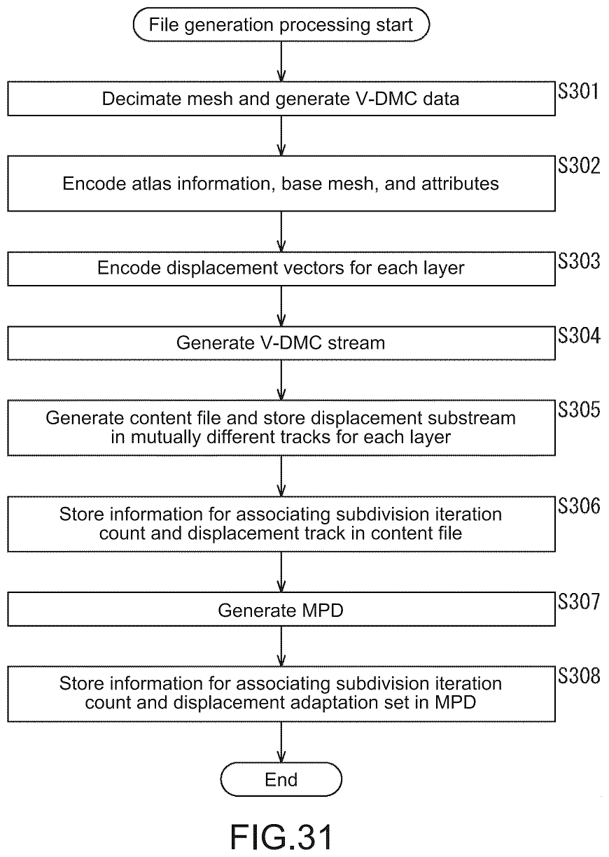

Next, an example of a flow of file generation processing executed by this file generation apparatus 300 will be described with reference to the flowchart in FIG. 31. The flowchart in FIG. 31 shows an example of the flow of the file generation processing in a case of applying Method 1 (and other methods belonging to Method 1) described above.

When the file generation processing is started, the mesh decimation unit 311 of the file generation apparatus 300 generates V-DMC data by, e.g. decimating mesh data in Step S301.

In Step S302, the V-DMC encoding unit 312 encodes atlas information, base mesh, and attribute data of the V-DMC data. In Step S303, the V-DMC encoding unit 312 encodes displacement vectors for each of layers of the levels of detail.

In Step S304, the bitstream generation unit 313 combines the encoded data of the atlas information, the encoded data of the base mesh, and the encoded data of the attributes generated in Step S302, and the encoded data of the displacement vectors for each layer generated in Step S303 as substreams to generate a V-DMC stream.

In Step S305, the content file generation unit 314 generates a content file and stores the substreams of the displacement vectors for each layer stored in the V-DMC bitstream in mutually different tracks for each layer. Moreover, the content file generation unit 314 stores the other substreams stored in the V-DMC bitstream (substream of atlas information, substream of base mesh, and substream of attributes) in the tracks, respectively.

Moreover, in Step S306, the content file generation unit 314 stores the association information for associating the displacement tracks with the layers (subdivision iteration count) in the content file generated in Step S305.

In Step S307, the MPD generation unit 315 generates a control file (MPD) that controls delivery of the content file generated in Step S305.

In Step S308, the MPD generation unit 315 stores the association information for associating the displacement tracks with the layers (subdivision iteration count) in the control file (MPD) generated in Step S307.

When the processing in Step S307 is completed, the file generation processing ends.

By executing the respective processing as described above, the file generation apparatus 300 can obtain the above-mentioned effects in <3. Playback Control for Each Layer of Displacement Vectors>. For example, the file generation apparatus 300 can suppress an increase in processing load related to reconstruction of 3D data including displacement vectors.

### <Flow 2 of File Generation Processing>

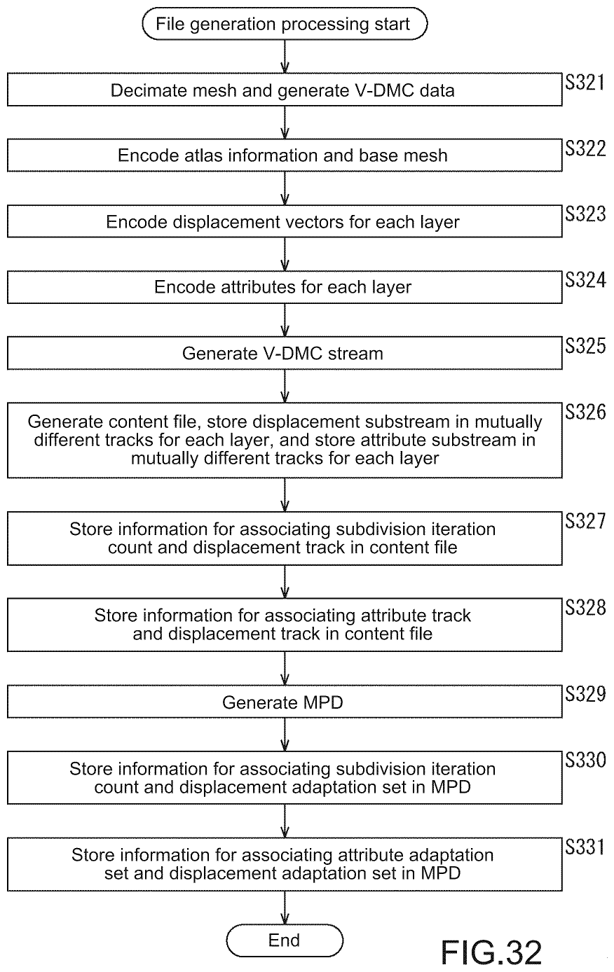

Next, an example of the flow of the file generation processing executed by this file generation apparatus 300 will be described with reference to the flowchart in FIG. 32. The flowchart in FIG. 32 shows an example of the flow of the file generation processing in a case of applying Method 2 (and other methods belonging to Method 2) described above.

When the file generation processing is started, the mesh decimation unit 311 of the file generation apparatus 300 generates V-DMC data by, e.g. decimating mesh data in Step S321.

In Step S322, the V-DMC encoding unit 312 encodes atlas information and base mesh of the V-DMC data. In Step S323, the V-DMC encoding unit 312 encodes displacement vectors for each of layers of the levels of detail. In Step S324, the V-DMC encoding unit 312 encodes attributes for each of layers of the levels of detail.

In Step S325, the bitstream generation unit 313 combines the encoded data of the atlas information and the encoded data of base mesh generated in Step S322, the encoded data of the displacement vectors for each layer generated in Step S323, the encoded data of the attributes for each layer generated in Step S324 as substreams to generate a V-DMC stream.

In Step S326, the content file generation unit 314 generates a content file and stores the substream of the displacement vectors for each layer stored in the V-DMC bitstream in mutually different tracks for each layer. Moreover, the content file generation unit 314 stores the substream of the attributes for each layer stored in the V-DMC bitstream in mutually different tracks for each layer of the content file. Moreover, the content file generation unit 314 stores the other substreams (substream of atlas information and substream of base mesh) stored in the V-DMC bitstream in the tracks, respectively.

In Step S327, the content file generation unit 314 stores first association information for associating the displacement tracks with the layers (subdivision iteration count) in the content file generated in Step S326. Moreover, in Step S328, the content file generation unit 314 stores second association information for associating the attribute tracks with the displacement tracks in the content file generated in Step S326.

In Step S329, the MPD generation unit 315 generates a control file (MPD) that controls delivery of the content file generated in Step S326.

In Step S330, the MPD generation unit 315 stores the first association information for associating the displacement tracks with the layers (subdivision iteration count) in the control file (MPD) generated in Step S329. Moreover, in Step S331, the MPD generation unit 315 stores the second association information for associating the attribute tracks to the displacement tracks in the control file (MPD) generated in Step S329.

When the processing in Step S331 is completed, the file generation processing ends.

By executing the respective processing as described above, the file generation apparatus 300 can obtain the above-mentioned effects in <4. Playback Control for Each Layer of Attributes>. For example, the file generation apparatus 300 can suppress an increase in processing load related to reconstruction of 3D data including displacement vectors.

### 7. SECOND EMBODIMENT

### <Playback Apparatus>

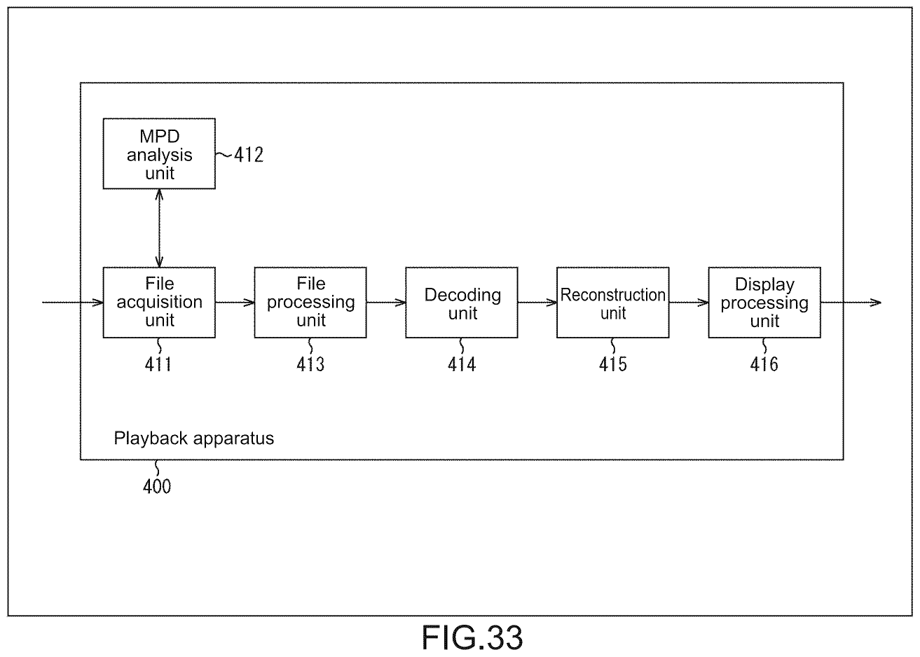

The above-mentioned present technology can be applied to any apparatus. FIG. 33 is a block diagram showing a configuration example of a playback apparatus that is an embodiment of the information processing apparatus to which the present technology is applied. A playback apparatus 400 shown in FIG. 33 is a playback apparatus that performs playback processing of mesh data (V-DMC data). For example, the playback apparatus 400 acquires a content file generated by the file generation apparatus 300 and plays back a V-DMC data stored in the content file.

It should be noted that in FIG. 33, the main processing units and data flow, etc. are shown, and the present technology is not limited to those shown in FIG. 33. That is, in the playback apparatus 400, there may be processing units not shown as blocks in FIG. 33, or there may be processing or data flows not shown as arrows, etc. in FIG. 33.

As shown in FIG. 33, the playback apparatus 400 includes a file acquisition unit 411, an MPD analysis unit 412, a file processing unit 413, a decoding unit 414, a reconstruction unit 415, and a display processing unit 416.

The file acquisition unit 411 performs processing related to acquisition of files such as content files and control files (MPD). For example, the file acquisition unit 411 acquires a control file (MPD) generated by the file generation apparatus 300 applying the present technology. The file acquisition unit 411 supplies the acquired control file (MPD) to the MPD analysis unit 412.

Moreover, the file acquisition unit 411 acquires a content file generated by the file generation apparatus 300 applying the present technology in accordance with the control of the MPD analysis unit 412. For example, the file acquisition unit 411 acquires bitstreams (substreams) stored in a content file delivered from a delivery server or the like in accordance with the control of the MPD analysis unit 412. The file acquisition unit 411 supplies the acquired bitstreams (substreams) to the file processing unit 413. It can also be said that the file acquisition unit 411 is an acquisition unit.

The MPD analysis unit 412 executes processing related to analysis of the control file (MPD). For example, the MPD analysis unit 412 acquires a control file (MPD) supplied by the file acquisition unit 411. The MPD analysis unit 412 analyzes the acquired control file (MPD) and controls the file acquisition unit 411 on the basis of the analysis result to acquire a bitstream (substream) stored in the content file. For example, in a case where some of substreams stored in content file are to be acquired, the MPD analysis unit 412 selects some substreams on the basis of the control file (MPD). It can also be said that the MPD analysis unit 412 is a selection unit.

It should be noted that delivery of the content file does not have to be controlled by the control file (MPD). For example, the file acquisition unit 411 may acquire a content file supplied from an external device of the playback apparatus 400 and supply the acquired content file to the file processing unit 413. In that case, the MPD analysis unit 412 may be omitted.

The file processing unit 413 executes processing related to the content file. For example, the file processing unit 413 acquires a content file supplied by the file acquisition unit 411. From the acquired content file, the file processing unit 413 acquires bitstreams (substreams) necessary for reconstruction of the mesh. For example, the file processing unit 413 acquires from the content file a substream of the atlas information, a substream of the base mesh, a substream of the displacement vectors, and a substream of the attributes. The file processing unit 413 supplies the acquired bitstream to the decoding unit 414. It can also be said that the file processing unit 413 is an acquisition unit.

It should be noted that in a case where bitstreams (substreams) are supplied from the file acquisition unit 411 to the file processing unit 413, the file processing unit 413 supplies the supplied bitstreams to the decoding unit 414. In that case, the file processing unit 413 may be omitted and the bitstreams may be supplied from the file acquisition unit 411 to the decoding unit 414.

The decoding unit 414 executes processing related to decoding bitstreams. For example, the decoding unit 414 acquires bitstreams (e.g., a substream of the atlas information, a substream of the base mesh, a substream of the displacement vectors, a substream of the attributes) supplied from the file processing unit 413. The decoding unit 414 decodes the acquired bitstreams by using the decoding method according to the encoding method of the bitstreams.

For example, the decoding unit 414 generates (restores) information such as the atlas information, the base mesh, the displacement vectors, and the attributes by the decoding. That is, the decoding unit 414 generates (restores) the V-DMC data. The decoding unit 414 supplies the generated V-DMC data to the reconstruction unit 415.

The reconstruction unit 415 executes processing related to reconstruction of the mesh (3D data). For example, the reconstruction unit 415 converts the V-DMC data supplied from the decoding unit 414 into mesh data and reconstructs the mesh (3D data) by using the mesh data. The reconstruction unit 415 supplies the reconstructed mesh (3D data) to the display processing unit 416.

The display processing unit 416 executes processing related to displaying the mesh. For example, the display processing unit 416 acquires the mesh (3D data) supplied by the reconstruction unit 415. The display processing unit 416 generates a display image for displaying the mesh (3D data) and supplies the display image to a display unit (not shown) such as a monitor for displaying it.

In the playback apparatus 400 with the above-mentioned configuration, it may be the second information processing apparatus as described above, and the present technology described in <3. Playback Control for Each Layer of Displacement Vectors> to <5. Matroska Media Container> above may be applied. That is, the playback apparatus 400 may apply one or more of the various methods shown in the table in FIG. 5 to reconstruct the mesh. With such a configuration, the playback apparatus 400 can obtain the above-mentioned effects in <3. Playback Control for Each Layer of Displacement Vectors> and <4. Playback Control for Each Layer of Attributes>. For example, the playback apparatus 400 can suppress an increase in processing load related to reconstruction of 3D data including displacement vectors.

For example, Method 1 above may be applied to the playback apparatus 400. Moreover, Method 1-1 above may be applied to the playback apparatus 400. That is, the file processing unit 413 may acquire the encoded data of the base mesh and the encoded data of the attributes from the content file, and may acquire, on the basis of the first association information for associating the displacement tracks with the layers of the levels of detail of the mesh, the encoded data of the displacement vectors from the encoded data of a displacement track corresponding to a desired layer of the layers of the content file. Moreover, the decoding unit 414 may decode each of the acquired encoded data of the base mesh, the acquired encoded data of the attributes, and the acquired encoded data of the displacement vectors. Moreover, the reconstruction unit 415 may reconstruct the mesh of the desired layer by using the base mesh, the attributes, and the displacement vectors obtained by the decoding. With such a configuration, the playback apparatus 400 can obtain the above-mentioned effects in <Method 1-1>. As a matter of course, other methods belonging to this Method 1-1 (e.g., Method 1-1-1, Method 1-1-1-1, and Method 1-1-1-2) may be applied to the playback apparatus 400. Moreover, methods other than these may be applied.

Moreover, Method 1-2 above may be applied to the playback apparatus 400. That is, the MPD analysis unit 412 may select, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file. Moreover, the file acquisition unit 411 may acquire encoded data of the base mesh and encoded data of the attributes, which are stored in the content file, and acquire encoded data of the displacement vector, which is stored in a displacement track of the content file, the displacement track being managed by the selected displacement adaptation set. The decoding unit 414 may decode each of the acquired encoded data of the base mesh, the acquired encoded data of the attributes, and the acquired encoded data of the displacement vectors. Moreover, the reconstruction unit 415 may reconstruct the mesh of the desired layer by using the base mesh, the attributes, and the displacement vectors obtained by the decoding. With such a configuration, the playback apparatus 400 can obtain the above-mentioned effects in <Method 1-2>. As a matter of course, other methods belonging to this Method 1-2 (e.g., Method 1-2-1, Method 1-2-1-1, and Method 1-2-1-2) may be applied to the playback apparatus 400. Moreover, methods other than these may be applied.

Moreover, Method 2 above may be applied to the playback apparatus 400. Moreover, Method 2-1 above may be applied to the playback apparatus 400. That is, the content file may include the base-mesh track, a plurality of the attribute tracks that stores the encoded data of the attributes of the mutually different layers, and a plurality of the displacement tracks that stores the encoded data of the displacement vectors of the mutually different layers. Moreover, the file processing unit 413 may acquire, on the basis of second association information for associating the attribute tracks with the displacement tracks, the encoded data of the attributes from the attribute track corresponding to a desired layer of the layers of the content file.

Moreover, Method 2-2 above may be applied to the playback apparatus 400. That is, the content file may include the base-mesh track, a plurality of the attribute tracks that stores the encoded data of the attributes of the mutually different layers, and a plurality of the displacement tracks that stores the encoded data of the displacement vectors of the mutually different layers. Moreover, the control file may include second association information for associating the attribute adaptation sets with the displacement adaptation sets. Moreover, the MPD analysis unit 412 may select one of the attribute adaptation sets corresponding to the desired layer on the basis of the second association information, and the file acquisition unit 411 may acquire the encoded data of the attributes, which is stored in the attribute track of the content file, the attribute track being managed by the selected attribute adaptation set. With such a configuration, the playback apparatus 400 can obtain the above-mentioned effects in <Method 2-2>. As a matter of course, other methods belonging to this Method 2-2 (e.g., Method 2-2-1, Method 2-2-1-1, Method 2-2-2, Method 2-2-2-1, Method 2-2-2-2, Method 2-2-2-2-1, and Method 2-2-3) may be applied to the playback apparatus 400. Moreover, methods other than these may be applied.

### <Flow 1 of Playback Processing>

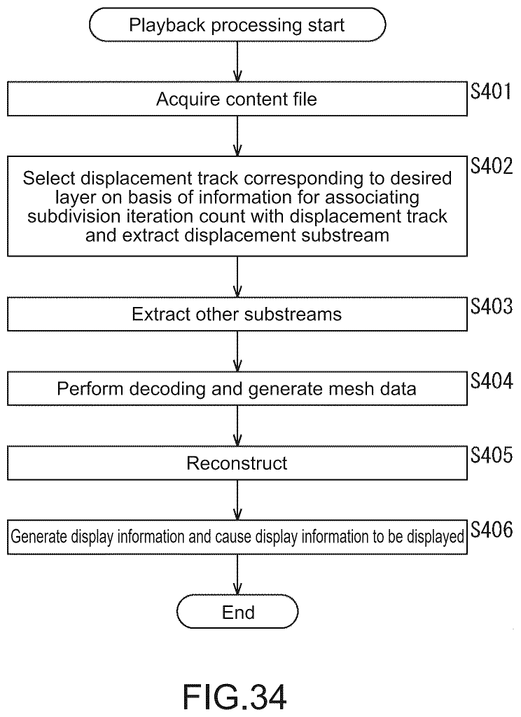

Next, an example of a flow of playback processing executed by the playback apparatus 400 will be described with reference to the flowchart in FIG. 34. The flowchart in FIG. 34 shows an example of the flow of the playback processing in a case of applying Method 1-1 above (and other methods belonging to Method 1-1).

When the playback processing is started, the file acquisition unit 411 of the playback apparatus 400 acquires a content file in Step S401.

In Step S402, the file processing unit 413 selects a displacement track corresponding to a desired layer from the acquired content file on the basis of association information for associating the displacement tracks with the layers (subdivision iteration count) of the levels of detail of the mesh, and extracts an substream of the displacement vectors that are stored in the displacement track. In Step S403, the file processing unit 413 extracts other substreams from the content file.

In Step S404, the decoding unit 414 decodes each of the extracted substreams and generates V-DMC data. The reconstruction unit 415 generates mesh data by using the V-DMC data.

In Step S405, the reconstruction unit 415 reconstructs the mesh (3D data) by using the mesh data.

In Step S406, the display processing unit 416 generates display information including the mesh and causes the display information to be displayed.

When the processing in Step S406 is completed, the playback processing ends.

By executing the respective processing as described above, the playback apparatus 400 can obtain the above-mentioned effects in <3. Playback Control for Each Layer of Displacement Vectors>. For example, the playback apparatus 400 can suppress an increase in processing load related to reconstruction of 3D data including displacement vectors.

### <Flow 2 of Playback Processing>

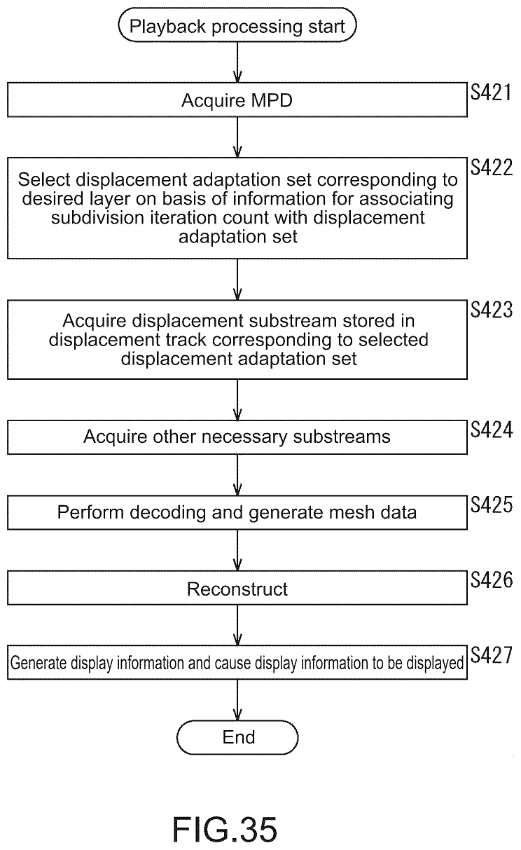

Next, an example of the flow of the playback processing executed by the playback apparatus 400 will be described with reference to the flowchart in FIG. 35. The flowchart in FIG. 35 shows an example of the flow of the playback processing in a case of applying Method 1-2 above (and other methods belonging to Method 1-2).

When the playback processing is started, the file acquisition unit 411 of the playback apparatus 400 acquires a control file (MPD) in Step S421.

In Step S422, the MPD analysis unit 412 analyzes the control file (MPD) and selects an adaptation set corresponding to a desired layer on the basis of association information for associating the displacement tracks with the layers (subdivision iteration count), the association information being stored in the control file (MPD).

In Step S423, the file acquisition unit 411 acquires a substream of the displacement vectors that are stored in the displacement track corresponding to the selected displacement adaptation set in accordance with the control of the MPD analysis unit 412. In Step S424, the file acquisition unit 411 acquires other necessary substreams (e.g., a substream of the atlas information, a substream of the base mesh, a substream of the displacement vectors, a substream of the attributes) in accordance with the control of the MPD analysis unit 412.

In Step S425, the decoding unit 414 decodes those substreams and generates V-DMC data. The reconstruction unit 415 converts the V-DMC data into mesh data.

In Step S427, the reconstruction unit 415 reconstructs the mesh (3D data) by using the mesh data.

In Step S427, the display processing unit 416 generates display information including the mesh and causes the display information to be displayed.

After the processing in Step S427 is completed, the playback processing ends.

By executing the respective processing as described above, the playback apparatus 400 can obtain the above-mentioned effects in <3. Playback Control for Each Layer of Displacement Vectors>. For example, the playback apparatus 400 can suppress an increase in processing load related to reconstruction of 3D data including displacement vectors.

### <Flow 3 of Playback Processing>

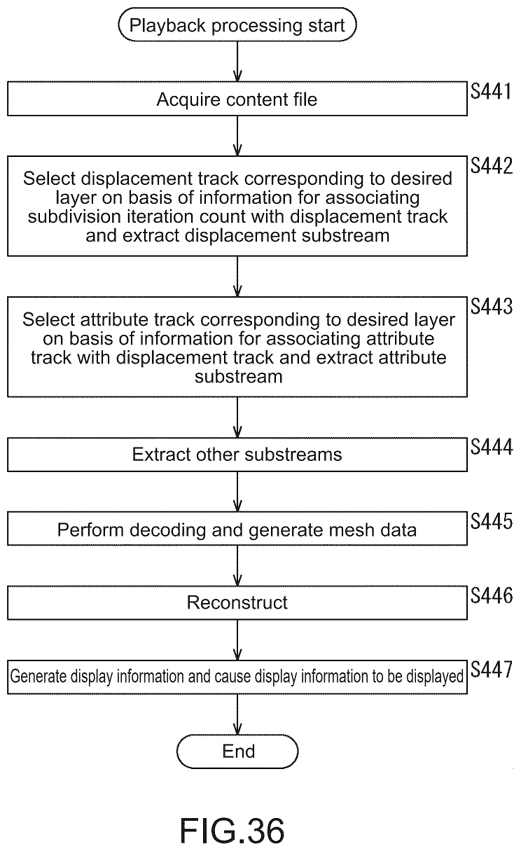

Next, an example of the flow of the playback processing executed by the playback apparatus 400 will be described with reference to the flowchart in FIG. 36. The flowchart in FIG. 36 shows an example of the flow of the playback processing in a case of applying Method 2-1 above (and other methods belonging to Method 2-1).

When the playback processing is started, the file acquisition unit 411 of the playback apparatus 400 acquires a content file in Step S441.

In Step S442, the file processing unit 413 selects a displacement track corresponding to a desired layer from the content file on the basis of first association information for associating the displacement tracks with the layers (subdivision iteration count) of the levels of detail of the mesh, and extracts an substream of the displacement vectors that are stored in the displacement track. In Step S443, the file processing unit 413 selects an attribute track corresponding to the desired layer from the content file on the basis of second association information for associating the attribute tracks with the displacement tracks, and extracts a substream of the attributes that are stored in the attribute track. In Step S444, the file processing unit 413 extracts other necessary substreams (e.g., a substream of the atlas information, a substream of the base mesh, a substream of the attributes) from the content file.

In Step S445, the decoding unit 414 decodes each of the extracted substreams and generates V-DMC data. The reconstruction unit 415 generates mesh data by using the V-DMC data.

In Step S446, the reconstruction unit 415 reconstructs the mesh (3D data) by using the mesh data.

In Step S447, the display processing unit 416 generates display information including the mesh and causes the display information to be displayed.

When the processing in Step S447 is completed, the playback processing ends.

By executing the respective processing as described above, the playback apparatus 400 can obtain the above-mentioned effects in <4. Playback Control for Each Layer of Attributes>. For example, the playback apparatus 400 can suppress an increase in processing load related to reconstruction of 3D data including displacement vectors.

### <Flow 4 of Playback Processing>

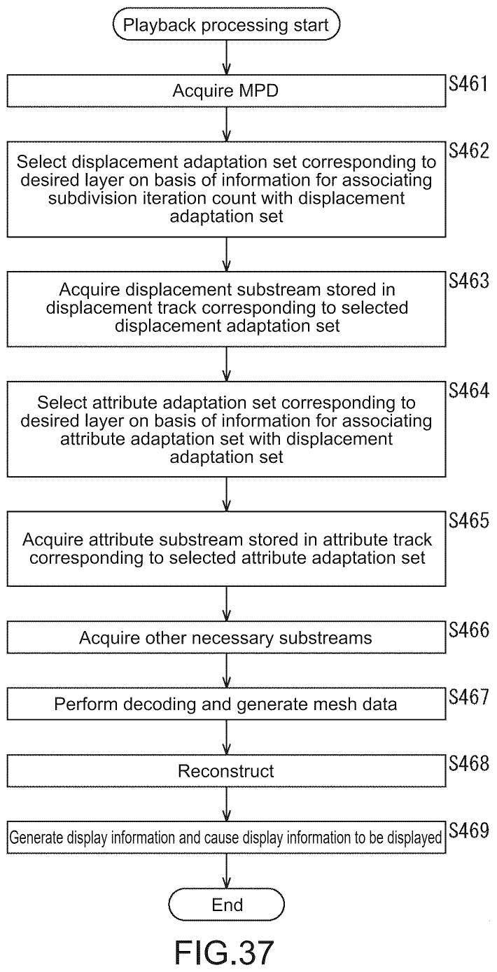

Next, an example of the flow of the playback processing executed by the playback apparatus 400 will be described with reference to the flowchart in FIG. 37. The flowchart in FIG. 37 shows an example of the flow of the playback processing in a case of applying Method 2-2 above (and other methods belonging to Method 2-2).

When the playback processing is started, the file acquisition unit 411 of the playback apparatus 400 acquires a control file (MPD) in Step S461.

In Step S462, the MPD analysis unit 412 analyzes the control file (MPD) and selects an adaptation set corresponding to a desired layer on the basis of first association information for associating the displacement tracks with the layers (subdivision iteration count) of the levels of detail of the mesh, the first association information being stored in the control file (MPD).

In Step S463, the file acquisition unit 411 acquires a substream of the displacement vectors that are stored in the displacement track corresponding to the selected displacement adaptation set in accordance with the control of the MPD analysis unit 412.

In Step S464, the MPD analysis unit 412 analyzes the control file (MPD) and selects an adaptation set corresponding to a desired layer on the basis of second association information for associating the attribute tracks with the displacement tracks, the second association information being stored in the control file (MPD).

In Step S465, the file acquisition unit 411 acquires a substream of the attributes that are stored in the attribute track corresponding to the selected attribute adaptation set in accordance with the control of the MPD analysis unit 412.

In Step S466, the file acquisition unit 411 acquires other necessary substreams (e.g., a substream of the atlas information, a substream of the base mesh, a substream of the attributes) in accordance with the control of the MPD analysis unit 412.

In Step S467, the decoding unit 414 decodes those substreams and generates V-DMC data. The reconstruction unit 415 converts the V-DMC data into mesh data.

In Step S468, the reconstruction unit 415 reconstructs the mesh (3D data) by using the mesh data.

In Step S469, the display processing unit 416 generates display information including the mesh and causes the display information to be displayed.

When the processing in Step S469 is completed, the playback processing ends.

By executing the respective processing as described above, the playback apparatus 400 can obtain the above-mentioned effects in <4. Playback Control for Each Layer of Attributes>. For example, the playback apparatus 400 can suppress an increase in processing load related to reconstruction of 3D data including displacement vectors.

### 8. APPENDIX

### <Combination>

The respective examples (respective methods) of the present technology may be applied in combination with other examples (other methods) as appropriate as long as no contradictions arise. Moreover, the respective examples of the present technology may be applied in combination with technologies other than those described above.

Moreover, hereinabove, the V-DMC data has been described as an example of the encoding target. However, the encoding target is not limited to the V-DMC data as long as the target is 3D data including displacement vectors. That is, the encoding method to which the present technology is applied may be other than the V-DMC. Moreover, although the MPD of the MPEG-DASH has been described above as an example of the control file, the control method for the content file is arbitrary and may be other than the MPEG-DASH. That is, the control file that controls delivery may be other than the MPD.

### <Computer>

The series of processing may be executed by hardware or may be executed by software. If the series of processing is executed by software, programs that configure the software are installed in a computer. Here, the computer includes a computer incorporated in dedicated hardware, a general-purpose personal computer, for example, capable of executing various functions by installing various programs, and the like.

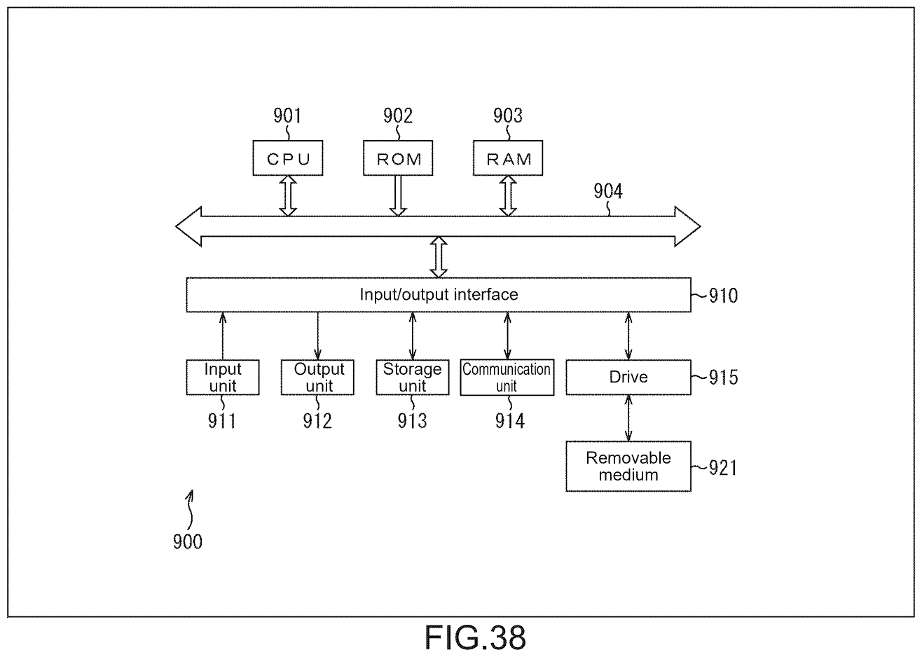

FIG. 38 is a block diagram showing a configuration example of hardware of the computer that executes the above-mentioned series of processing in accordance with the program.

In a computer 900 shown in FIG. 38, a central processing unit (CPU) 901, a read only memory (ROM) 902, and a random access memory (RAM) 903 are connected to one another through a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, and an input terminal. The output unit 912 includes, for example, a display, a loudspeaker, and an output terminal. The storage unit 913 includes, for example, a hard disk, a RAM disc, and a nonvolatile memory. The communication unit 914 includes, for example, a network interface. The drive 915 drives a removable medium 921 such as a magnetic disk, an optical disc, a magneto-optical disk, and a semiconductor memory.

In the thus configured computer, the CPU 901 loads, for example, programs stored in the storage unit 913 into the RAM 903 via the input/output interface 910 and the bus 904 and executes them. In this manner, the above-mentioned series of processing is performed. In the RAM 903, data necessary for the CPU 901 to execute various types of processing and the like are also stored as appropriate.

Programs executed by the computer can be, for example, provided recorded on the removable medium 921 that is a package medium. In that case, the program can be installed into the storage unit 913 via the input/output interface 910 by mounting the removable medium 921 on the drive 915.

Moreover, this program can be provided via a wired or wireless transmission medium such as a local area network, the Internet, and digital satellite broadcasting. In that case, the program can be received by the communication unit 914 and can be installed into the storage unit 913.

Otherwise, this program can be installed into the ROM 902 or the storage unit 913 in advance.

### <Applicable Targets of Present Technology>

The present technology can be applied to any encoding and encoding method.

Moreover, the present technology can be applied to any configuration. For example, the present technology can be applied to various electronic apparatuses.

Moreover, for example, the present technology can also be implemented as some configurations of the apparatus such as a processor (e.g., a video processor) serving as a system large scale integration (LSI) or the like, a module (e.g., a video module) using a plurality of processors and the like, a unit (e.g., a video unit) using a plurality of modules and the like, or a set (e.g., a video set) obtained by adding still other additional functions to the unit.

Moreover, for example, the present technology can also be applied to a network system which is constituted by a plurality of apparatuses. For example, the present technology may be implemented as cloud computing that is shared and commonly processed by the plurality of apparatuses via a network. For example, with respect to any terminal such as a computer, an audio visual (AV) apparatus, a portable information processing terminal, or an internet of things (IoT) device, the present technology may be implemented in a cloud service that provides a service related to an image (moving image).

It should be noted that in this specification, the system means a set of a plurality of components (apparatuses, modules (parts), etc.), regardless of whether or not all the components are in the same casing. Therefore, a plurality of apparatuses that has been stored in separate casings and connected via a network and a single apparatus with a casing in which a plurality of modules has been stored are both the system.

<Fields and Applications to which Present Technology can be Applied>

Systems, apparatuses, processing units, and the like to which the present technology is applied can be used in any field, e.g., traffics, medical care, crime prevention, agriculture, livestock industry, mining industry, beauty care, factories, home electronics, weather, and natural monitor. In addition, they are used for any applications.

For example, the present technology can be applied to systems and devices provided for providing content to be viewed and the like. Moreover, for example, the present technology can also be applied to systems and devices provided for traffics such as monitoring traffic conditions and self-driving control. In addition, for example, the present technology can also be applied to systems and devices provided for security. Moreover, for example, the present technology can be applied to systems and devices provided for automatic control on machines and the like. In addition, for example, the present technology can also be applied to systems and devices provided for agriculture and livestock industry. Moreover, the present technology can also be applied to systems and devices that monitor, for example, the conditions of the nature such as volcanoes, forests, and oceans, wild animals, and the like. In addition, for example, the present technology can also be applied to systems and devices provided for sports.

### <Others>

It should be noted that in this specification, the “flag” refers to information for identifying a plurality of states and includes not only information used when identifying two states of true (1) or false (0), but also information capable of identifying three or more states. Therefore, values that this “flag” can take may be provided be, for example, binary values of 1/0 or may be three or more values. That is, the number of bits that constitute this “flag” is arbitrary and it may be 1 bit or may be a plurality of bits. Moreover, as to the identification information (also including the flag), it is assumed not only the identification information is included in the bitstream, but also that difference information of identification information with respect to some reference information is included in the bitstream. Therefore, in this specification, as to the “flag” and the “identification information,” not only the information, but also difference information with respect to the reference information are also encompassed.

Moreover, various types of information (metadata, etc.) regarding the encoded data (bitstream) may be transmitted or recorded in any form as long as it is associated with the encoded data. Here, the term “associated” means, for example, that one piece of data can be used (can be associated) when the other data is processed. That is, the data associated with each other may be combined as single data or may be discrete pieces of data. For example, the information associated with the encoded data (image) may be transmitted on a communication channel different from the encoded data (image). Moreover, for example, the information associated with the encoded data (image) may be recorded on a recording medium different from the encoded data (image) (or another recording area of the same recording medium). It should be noted that this “association” may be not only the entire data, but also part of the data. For example, an image and information corresponding to the image may be associated with each other in any unit such as a plurality of frames, one frame, or a part of a frame.

It should be noted that in this specification, the terms “synthesize,” “multiplex,” “add,” “integrate,” “include,” “store,” “input,” “put in,” “insert,” and the like mean combining a plurality of objects into one, for example, combining the encoded data and the metadata into a single piece of data, and mean a single method of “associating” described above.

Embodiments of the present technology are not limited to the above-mentioned embodiments and various modifications can be made without departing from the gist of the present technology.

For example, the configuration described as a single apparatus (or processing unit) may be divided to constitute it as a plurality of apparatuses (or processing units). On the contrary, configurations described above as a plurality of apparatuses (or processing units) may be combined and configured as the single apparatus (or the processing unit). Moreover, configurations other than those described above may be added to the configuration of each apparatus (or respective processing unit) as a matter of course. In addition, as long as the configurations and the operations are substantially the same as a whole of the system, some configurations of a certain apparatus (or processing unit) may be included in the configurations of the other apparatus (or the other processing unit).

Moreover, for example, the above-mentioned program may be executed in any apparatus. In that case, it is sufficient to enable the apparatus to have necessary functions (functional blocks, etc.) and be capable of obtaining necessary information.

Moreover, for example, the single apparatus may be enabled to execute the respective steps of a single flowchart so that the plurality of apparatuses shares and executes them. In addition, in a case where a single step includes a plurality of processes, the plurality of processes may be executed by the single apparatus and may be shared and executed by the plurality of apparatuses. In other words, the plurality of processes included in a single step may be executed as processing of a plurality of steps. On the contrary, the processing described as a plurality of steps may be combined and executed as a single step.

Moreover, for example, as to the program executed by the computer, the processing of the step of describing the program may be executed in chronological order according to the sequence described herein, or in parallel, or individually at a necessary timing such as when a call is made. That is, as long as no contradictions arise, the processing in the respective steps may be executed in an order different from the above-mentioned order. In addition, the processing of the step of describing this program may be provided executed in parallel with processing of another program or may be executed in combination with the processing of the other program.

Moreover, for example, a plurality of technologies related to the present technology can be each independently implemented alone as long as no contradictions arise. As a matter of course, any plurality of the present technologies can also be implemented in combination. For example, some or all of the present technologies described in any embodiment can also be implemented in combination with some or all of the present technologies described in the other embodiments. Moreover, a part of or the entire any present technology described above can also be implemented at the same time as other technologies not described above.

It should be noted that the present technology can also take the following configurations.

(1) An information processing apparatus, including:
an encoding unit that encodes a base mesh and attributes and encodes displacement vectors for each of layers of levels of detail; and
a content file generation unit that generates a content file, stores encoded data of the base mesh in a base-mesh track of the content file, stores encoded data of the attributes in an attribute track of the content file, stores encoded data of the displacement vectors for each of the layers in mutually different displacement tracks of the content file, and stores first association information for associating the displacement tracks with the layers in the content file, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

(2) The information processing apparatus according to (1), in which
the content file generation unit stores, as the first association information, information indicating the layer of the displacement vectors that are stored in the displacement track, in the displacement track.

(3) The information processing apparatus according to (2), in which
the content file generation unit stores the information indicating the layer of the displacement vectors in SubdivIterationInfoBox provided in a sample entry of the displacement track.

(4) The information processing apparatus according to (2) or (3), in which
the content file generation unit stores encoded data of absolute displacement vectors of vertices obtained in the corresponding layer and relative displacement vectors of vertices obtained in a lower-level layer than the corresponding layer, in the displacement track,
the absolute displacement vectors are the displacement vectors indicating displacement of the vertices from the base mesh, and
the relative displacement vectors are the displacement vectors indicating displacement of the vertices from positions in one lower-level layer.

(5) The information processing apparatus according to (2) or (3), in which
the content file generation unit stores encoded data of absolute displacement vectors of vertices obtained in the corresponding layer and the absolute displacement vectors of vertices obtained in a lower-level layer than the corresponding layer, in the displacement track, and
the absolute displacement vectors are the displacement vectors indicating displacement of the vertices from the base mesh.

(6) The information processing apparatus according to any of (2) to (5), in which
the content file generation unit further stores type information indicating whether the displacement vectors are absolute displacement vectors or relative displacement vectors, in the displacement track,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(7) The information processing apparatus according to (6), in which
the content file generation unit stores the type information in SubdivIterationInfoBox provided in a sample entry of the displacement track.

(8) The information processing apparatus according to any of (2) to (7), in which
the content file generation unit further stores quality information indicating quality of the base mesh or the displacement vectors in the base-mesh track or the displacement track.

(9) The information processing apparatus according to (8), in which
the content file generation unit stores the quality information in MeshInfoBox provided in a sample entry of the base-mesh track or the displacement track.

(10) The information processing apparatus according to (8) or (9), in which
the content file generation unit stores the quality information in SubdivIterationInfoBox provided in a sample entry of the base-mesh track or the displacement track.

(11) The information processing apparatus according to any of (8) to (10), in which
the content file generation unit stores, as the quality information, an average value in a time axis direction of the number of vertices of the mesh of the layer corresponding to the base-mesh track or the displacement track, in the base-mesh track or the displacement track.

(12) The information processing apparatus according to any of (8) to (11), in which
the content file generation unit stores, as the quality information, an average value in a time axis direction of the number of triangles of the mesh of the layer corresponding to the base-mesh track or the displacement track, in the base-mesh track or the displacement track.

(13) The information processing apparatus according to any of (1) to (12), in which
the encoding unit encodes the attributes for each of layers of the levels of detail, and
the content file generation unit stores encoded data of the attributes for each of the layers in the mutually different attribute tracks of the content file and stores second association information for associating the attribute tracks with the displacement tracks in the content file.

(14) The information processing apparatus according to (13), in which
the content file generation unit stores, as the second association information, information indicating the layer of the attributes that are stored in the attribute track, in the attribute track.

(15) The information processing apparatus according to (14), in which
the content file generation unit stores the information indicating the layer of the attributes in SubdivIterationInfoBox provided in a sample entry of the attribute track.

(16) The information processing apparatus according to any of (13) to (15), in which
the content file generation unit stores, as the second association information, grouping information for grouping the attribute track and the displacement track necessary for reconstruction of the mesh for each of the layers, in the content file.

(17) The information processing apparatus according to (16), in which
the content file generation unit stores the grouping information in SubdivIterationTrackGroupBox.

(18) The information processing apparatus according to (17), in which
the content file generation unit further stores information indicating the layer in the SubdivIterationTrackGroupBox.

(19) The information processing apparatus according to any of (16) to (18), in which
the content file generation unit stores, as the grouping information, a track reference that refers to another track so as to group the attribute track and the displacement track necessary for reconstruction of the mesh for each of the layers, in the content file.

(20) An information processing method, including:
encoding a base mesh and attributes and encoding displacement vectors for each of layers of levels of detail; and
generating a content file, storing encoded data of the base mesh in a base-mesh track of the content file, storing encoded data of the attributes in an attribute track of the content file, storing encoded data of the displacement vectors for each of the layers in mutually different displacement tracks of the content file, and storing association information for associating the displacement tracks with the layers in the content file, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

(21) An information processing apparatus, including:
an acquisition unit that acquires encoded data of a base mesh and encoded data of attributes from a content file and acquires, on the basis of first association information for associating displacement tracks with layers of levels of detail of a mesh, encoded data of displacement vectors from the displacement track corresponding to a desired layer of the layers of the content file;
a decoding unit that decodes each of the acquired encoded data of the base mesh, the acquired encoded data of the attributes, and the acquired encoded data of the displacement vectors; and
a reconstruction unit that reconstructs the mesh of the desired layer by using the base mesh, the attributes, and the displacement vectors that are obtained by the decoding, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh, and
the content file includes a base-mesh track that stores the encoded data of the base mesh, an attribute track that stores the encoded data of the attributes, and a plurality of the displacement tracks that stores the encoded data of the displacement vectors of the mutually different layers.

(22) The information processing apparatus according to (21), in which
the acquisition unit acquires the encoded data of the displacement vectors on the basis of information indicating the layer of the displacement vectors, the information being stored in the displacement track as the first association information.

(23) The information processing apparatus according to (22), in which
the information indicating the layer of the displacement vectors is stored in SubdivIterationInfoBox provided in a sample entry of the displacement track.

(24) The information processing apparatus according to (22) or (23), in which
in the displacement track, encoded data of absolute displacement vectors of vertices obtained in the corresponding layer and relative displacement vectors of vertices obtained in a lower-level layer than the corresponding layer is stored, and
the absolute displacement vectors are the displacement vectors indicating displacement of the vertices from the base mesh,
the relative displacement vectors are the displacement vectors indicating displacement of the vertices from positions in one lower-level layer.

(25) The information processing apparatus according to (22) or (23), in which
in the displacement track, encoded data of absolute displacement vectors of vertices obtained in the corresponding layer and the absolute displacement vectors of vertices obtained in a lower-level layer than the corresponding layer is stored, and
the absolute displacement vectors are the displacement vectors indicating displacement of the vertices from the base mesh.

(26) The information processing apparatus according to any of (22) to (25), in which
the acquisition unit further acquires the encoded data of the displacement vectors on the basis of type information indicating whether the displacement vectors are absolute displacement vectors or relative displacement vectors, the type information being stored in the displacement track,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(27) The information processing apparatus according to (26), in which
the type information is stored in SubdivIterationInfoBox provided in a sample entry of the displacement track.

(28) The information processing apparatus according to any of (22) to (27), in which
the acquisition unit further acquires the encoded data of the displacement vectors on the basis of quality information indicating quality of the base mesh or the displacement vectors, the quality information being stored in the base-mesh track or the displacement track.

(29) The information processing apparatus according to (28), in which
the quality information is stored in MeshInfoBox provided in a sample entry of the base-mesh track or the displacement track.

(30) The information processing apparatus according to (28), in which
the quality information is stored in SubdivIterationInfoBox provided in a sample entry of the base-mesh track or the displacement track.

(31) The information processing apparatus according to any of (28) to (30), in which
the quality information includes an average value in a time axis direction of the number of vertices of the mesh of the layer corresponding to the base-mesh track or the displacement track.

(32) The information processing apparatus according to any of (28) to (31), in which
the quality information includes an average value in a time axis direction of the number of triangles of the mesh of the layer corresponding to the base-mesh track or the displacement track.

(33) The information processing apparatus according to any of (21) to (32), in which
the content file includes the base-mesh track, a plurality of the attribute tracks that stores the encoded data of the attributes of the mutually different layers, and a plurality of the displacement tracks that stores the encoded data of the displacement vectors of the mutually different layers, and
the acquisition unit acquires, on the basis of second association information for associating the attribute tracks with the displacement tracks, the encoded data of the attributes from the attribute track corresponding to a desired layer of the layers of the content file.

(34) The information processing apparatus according to (33), in which
the acquisition unit acquires the encoded data of the attributes on the basis of information indicating the layer of the attributes, the information being stored in the attribute track as the second association information.

(35) The information processing apparatus according to (34), in which
the information indicating the layer of the attributes is stored in SubdivIterationInfoBox provided in a sample entry of the attribute track.

(36) The information processing apparatus according to any of (33) to (35), in which
the acquisition unit acquires the encoded data of the attributes on the basis of grouping information for grouping the attribute track and the displacement track necessary for reconstruction of the mesh for each of the layers, the grouping information being stored in the content file as the second association information.

(37) The information processing apparatus according to (36), in which
the grouping information is stored in SubdivIterationTrackGroupBox.

(38) The information processing apparatus according to (37), in which
the acquisition unit further acquires the encoded data of the attributes on the basis of information indicating the layer, the information being stored in the SubdivIterationTrackGroupBox.

(39) The information processing apparatus according to any of (36) to (38), in which
the acquisition unit acquires the encoded data of the attributes on the basis of a track reference that refers to another track so as to group the attribute track and the displacement track necessary for reconstruction of the mesh for each of the layers, the track reference being stored in the content file as the grouping information.

(40) An information processing method, including:
acquiring encoded data of a base mesh and encoded data of attributes from a content file and acquiring, on the basis of association information for associating displacement tracks with layers of levels of detail of a mesh, encoded data of displacement vectors from the displacement track corresponding to a desired layer of the layers of the content file;
decoding each of the acquired encoded data of the base mesh, the acquired encoded data of the attributes, and the acquired encoded data of the displacement vectors; and
reconstructing the mesh of the desired layer by using the base mesh, the attributes, and the displacement vectors that are obtained by the decoding, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh, and
the content file includes a base-mesh track that stores the encoded data of the base mesh, an attribute track that stores the encoded data of the attributes, and a plurality of the displacement tracks that stores the encoded data of the displacement vectors of the mutually different layers.

(41) An information processing apparatus, including:
an encoding unit that encodes a base mesh and attributes and encodes displacement vectors for each of layers of levels of detail;
a content file generation unit that generates a content file, stores encoded data of the base mesh in a base-mesh track of the content file, stores encoded data of the attributes in an attribute track of the content file, and stores encoded data of the displacement vectors for each of the layers in mutually different displacement tracks of the content file; and
a control file generation unit that generates a control file including control information for controlling delivery of the content file and stores first association information for associating displacement adaptation sets that manage the displacement tracks with the layers in the control file, in which
the base mesh is a mesh that is generated by decimating vertices from an original mesh as an encoding target, the original mesh being constituted by vertices and connections representing a three-dimensional structure of an object, the mesh being lower in the level of detail than the original mesh, and
the attributes include textures that are applied to surfaces of the original mesh,
the displacement vectors are vector information indicating displacement of vertices obtained by subdividing the base mesh.

(42) The information processing apparatus according to (41), in which
the control file generation unit stores, as the first association information, information indicating the layers of the displacement vectors that are stored in the displacement tracks that are managed by the displacement adaptation sets, in the displacement adaptation sets of the control file.

(43) The information processing apparatus according to (42), in which
the control file generation unit stores, as the information indicating the layer, a V3C video component descriptor indicating the layer in an essential property or a supplemental property of the displacement adaptation set.

(44) The information processing apparatus according to (42) or (43), in which
the control file generation unit further stores type information indicating whether the displacement vectors are absolute displacement vectors or relative displacement vectors, in the displacement adaptation sets of the control file,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(45) The information processing apparatus according to (44), in which
the control file generation unit stores, as the type information, a V3C video component descriptor indicating whether the displacement vectors are the absolute displacement vectors or the relative displacement vectors, in an essential property or a supplemental property of the displacement adaptation set.

(46) The information processing apparatus according to any of (42) to (45), in which
the control file generation unit further stores quality information indicating quality of the base mesh or the displacement vectors in a base-mesh adaptation set that manages the base-mesh track of the control file or in the displacement adaptation sets of the control file.

(47) The information processing apparatus according to (46), in which
the control file generation unit stores, as the quality information, a mesh information descriptor indicating quality of the base mesh or the displacement vectors, in an essential property or a supplemental property of the base-mesh adaptation set or the displacement adaptation set.

(48) The information processing apparatus according to (47), in which
the control file generation unit stores the mesh information descriptor indicating an average value in a time axis direction of the number of vertices of the mesh of the layer corresponding to the base-mesh adaptation set or the displacement adaptation set, in the essential property or the supplemental property of the base-mesh adaptation set or the displacement adaptation set.

(49) The information processing apparatus according to (47) or (48), in which
the control file generation unit stores the mesh information descriptor indicating an average value in a time axis direction of the number of triangles of the mesh of the layer corresponding to the base-mesh adaptation set or the displacement adaptation set, in the essential property or the supplemental property of the base-mesh adaptation set or the displacement adaptation set.

(50) The information processing apparatus according to any of (46) to (49), in which
the control file generation unit stores, as the quality information, a V3C video component descriptor indicating quality of the base mesh or the displacement vectors, in an essential property or a supplemental property of the base-mesh adaptation set or the displacement adaptation set.

(51) The information processing apparatus according to any of (41) to (50), in which
the encoding unit encodes the attributes for each of layers of the levels of detail,
the content file generation unit stores encoded data of the attributes for each of the layers in the mutually different attribute tracks of the content file, and
the control file generation unit stores second association information for associating attribute adaptation sets that manage the attribute tracks with the displacement adaptation sets in the control file.

(52) The information processing apparatus according to (51), in which
the control file generation unit stores, as the second association information, information indicating the layers of the attributes that are stored in the attribute tracks that are managed by the attribute adaptation sets, in the attribute adaptation sets of the control file.

(53) The information processing apparatus according to (52), in which
the control file generation unit stores, as the information indicating the layer, a V3C video component descriptor indicating the layer in an essential property or a supplemental property of the attribute adaptation set.

(54) The information processing apparatus according to (52) or (53), in which
the control file generation unit further stores type information indicating whether the displacement vectors are absolute displacement vectors or relative displacement vectors, in the attribute adaptation sets of the control file,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(55) The information processing apparatus according to (54), in which
the control file generation unit stores, as the type information, a V3C video component descriptor indicating whether the displacement vectors are the absolute displacement vectors or the relative displacement vectors, in an essential property or a supplemental property of the displacement adaptation set.

(56) The information processing apparatus according to any of (51) to (55), in which
the control file generation unit stores, as the second association information, a preselection for grouping the attribute adaptation set and the displacement adaptation set that manage tracks necessary for reconstruction of the mesh for each of the layers, in the control file.

(57) The information processing apparatus according to (56), in which
the control file generation unit stores information indicating the layer of the attributes that are stored in the attribute track that is managed by the attribute adaptation set, in the preselection.

(58) The information processing apparatus according to (57), in which
the control file generation unit stores, as the information indicating the layer, a subdivision iteration information descriptor indicating the layer, in an essential property or a supplemental property of the preselection.

(59) The information processing apparatus according to (57) or (58), in which
the control file generation unit further stores type information indicating whether the displacement vectors are absolute displacement vectors or relative displacement vectors, in the preselection,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(60) The information processing apparatus according to (59), in which
the control file generation unit stores, as the type information, a descriptor indicating whether the displacement vectors are the absolute displacement vectors or the relative displacement vectors, in an essential property or a supplemental property of the preselection.

(61) The information processing apparatus according to any of (51) to (60), in which
the control file generation unit stores, as the second association information, association identification information for associating the attribute adaptation set and the displacement adaptation set that manage tracks necessary for reconstruction of the mesh for each of the layers with each other, in the control file.

(62) An information processing method, including:
encoding a base mesh and attributes and encoding displacement vectors for each of layers of levels of detail;
generating a content file, storing encoded data of the base mesh in a base-mesh track of the content file, storing encoded data of the attributes in an attribute track of the content file, and storing encoded data of the displacement vectors for each of the layers in mutually different displacement tracks of the content file; and
generating a control file including control information for controlling delivery of the content file and storing association information for associating displacement adaptation sets that manage the displacement tracks with the layers in the control file, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

(71) An information processing apparatus, including:
a selection unit that selects, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file;
an acquisition unit that acquires encoded data of the base mesh and encoded data of the attributes, which are stored in the content file, and acquires encoded data of the displacement vector, which is stored in a displacement track of the content file, the displacement track being managed by the selected displacement adaptation set;
a decoding unit that decodes each of the acquired encoded data of the base mesh, the acquired encoded data of the attributes, and the acquired encoded data of the displacement vectors; and
a reconstruction unit that reconstructs the mesh of the desired layer by using the base mesh, the attributes, and the displacement vectors that are obtained by the decoding, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh,
the content file includes a base-mesh track that stores the encoded data of the base mesh, an attribute track that stores the encoded data of the attributes, and a plurality of the displacement tracks that stores the encoded data of the displacement vectors of the mutually different layers, and
the control file includes a base-mesh adaptation set that manages the base-mesh track, an attribute adaptation set that manages the attribute track, and the displacement adaptation sets that manage the displacement tracks.

(72) The information processing apparatus according to (71), in which
the selection unit selects one of the displacement adaptation sets on the basis of information indicating the layer of the displacement vectors that are stored in the displacement track that is managed by the displacement adaptation set, the information being stored in the displacement adaptation sets of the control file as the first association information.

(73) The information processing apparatus according to (72), in which
the selection unit selects one of the displacement adaptation sets on the basis of a V3C video component descriptor indicating the layer, the V3C video component descriptor being stored in an essential property or a supplemental property of the displacement adaptation set as the information indicating the layer.

(74) The information processing apparatus according to (72) or (73), in which
the selection unit further selects one of the displacement adaptation sets on the basis of type information indicating whether the displacement vectors are absolute displacement vectors or relative displacement vectors, the type information being stored in the displacement adaptation sets of the control file,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(75) The information processing apparatus according to (74), in which
the selection unit selects one of the displacement adaptation sets on the basis of a V3C video component descriptor indicating whether the displacement vectors are the absolute displacement vectors or the relative displacement vectors, the V3C video component descriptor being stored in an essential property or a supplemental property of the displacement adaptation set as the type information.

(76) The information processing apparatus according to any of (72) to (75), in which
the selection unit further selects one of the displacement adaptation sets on the basis of quality information indicating quality of the base mesh or the displacement vectors, the quality information being stored in the base-mesh adaptation set or the displacement adaptation set.

(77) The information processing apparatus according to (76), in which
the selection unit selects one of the displacement adaptation sets on the basis of a mesh information descriptor indicating quality of the base mesh or the displacement vectors, the mesh information descriptor being stored in an essential property or a supplemental property of the base-mesh adaptation set or the displacement adaptation set as the quality information.

(78) The information processing apparatus according to (77), in which
the selection unit selects one of the displacement adaptation sets on the basis of the mesh information descriptor indicating an average value in a time axis direction of the number of vertices of the mesh of the layer corresponding to the base-mesh adaptation set or the displacement adaptation set, the mesh information descriptor being stored in the essential property or the supplemental property of the base-mesh adaptation set or the displacement adaptation set.

(79) The information processing apparatus according to (77) or (78), in which
the selection unit selects one of the displacement adaptation sets on the basis of the mesh information descriptor indicating an average value in a time axis direction of the number of triangles of the mesh of the layer corresponding to the base-mesh adaptation set or the displacement adaptation set, the mesh information descriptor being stored in the essential property or the supplemental property of the base-mesh adaptation set or the displacement adaptation set.

(80) The information processing apparatus according to any of (76) to (79), in which
the selection unit selects one of the displacement adaptation sets on the basis of a V3C video component descriptor indicating quality of the base mesh or the displacement vectors, the V3C video component descriptor being stored in an essential property or a supplemental property of the base-mesh adaptation set or the displacement adaptation set as the quality information.

(81) The information processing apparatus according to any of (71) to (80), in which
the content file includes the base-mesh track, a plurality of the attribute tracks that stores the encoded data of the attributes of the mutually different layers, and a plurality of the displacement tracks that stores the encoded data of the displacement vectors of the mutually different layers,
the control file includes second association information for associating the attribute adaptation sets with the displacement adaptation sets,
the selection unit selects one of the attribute adaptation sets corresponding to the desired layer on the basis of the second association information, and
the acquisition unit acquires the encoded data of the attributes, which is stored in the attribute track of the content file, the attribute track being managed by the selected attribute adaptation set.

(82) The information processing apparatus according to (81), in which
the selection unit selects one of the attribute adaptation sets on the basis of information indicating the layer of the attributes that are stored in the attribute track that is managed by the attribute adaptation set, the information being stored in the attribute adaptation set of the control file as the second association information.

(83) The information processing apparatus according to (82), in which
the selection unit selects one of the attribute adaptation sets on the basis of a V3C video component descriptor indicating the layer, the V3C video component descriptor being stored in an essential property or a supplemental property of the attribute adaptation set as the information indicating the layer.

(84) The information processing apparatus according to (82) or (83), in which
the selection unit further selects one of the attribute adaptation sets on the basis of type information indicating whether the displacement vectors are absolute displacement vectors or relative displacement vectors, the type information being stored in the attribute adaptation sets of the control file,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(85) The information processing apparatus according to (84), in which
the selection unit selects one of the attribute adaptation sets on the basis of a V3C video component descriptor indicating whether the displacement vectors are the absolute displacement vectors or the relative displacement vectors, the V3C video component descriptor being stored in an essential property or a supplemental property of the attribute adaptation set as the type information.

(86) The information processing apparatus according to any of (81) to (85), in which
the selection unit selects one of the attribute adaptation sets on the basis of a preselection for grouping the attribute adaptation set and the displacement adaptation set that manage tracks necessary for reconstruction of the mesh for each of the layers, the preselection being stored in the control file as the second association information.

(87) The information processing apparatus according to (86), in which
the selection unit selects one of the attribute adaptation sets on the basis of information indicating the layer of the attributes that are stored in the attribute track that is managed by the attribute adaptation set, the information being stored in the preselection.

(88) The information processing apparatus according to (87), in which
the selection unit selects one of the attribute adaptation sets on the basis of a subdivision iteration information descriptor indicating the layer, the subdivision iteration information descriptor being stored in an essential property or a supplemental property of the preselection as information indicating the layer.

(89) The information processing apparatus according to (87) or (88), in which
the selection unit further selects one of the attribute adaptation sets on the basis of type information indicating whether the displacement vectors are absolute displacement vectors or relative displacement vectors, the type information being stored in the preselection,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

(90) The information processing apparatus according to (89), in which
the selection unit selects one of the attribute adaptation sets on the basis of a descriptor indicating whether the displacement vectors are the absolute displacement vectors or the relative displacement vectors, the descriptor being stored in an essential property or a supplemental property of the preselection as the type information.

(91) The information processing apparatus according to any of (81) to (90), in which
the selection unit selects one of the attribute adaptation sets on the basis of association identification information for associating the attribute adaptation set and the displacement adaptation set that manage tracks necessary for reconstruction of the mesh for each of the layers with each other, the association identification information being stored in the control file as the second association information.

(92) An information processing method, including:
selecting, on the basis of first association information for associating displacement adaptation sets with layers of levels of detail of a mesh, one of the displacement adaptation sets, which corresponds to a desired layer of the layers, the first association information being stored in a control file including control information for controlling delivery of the content file;
acquiring encoded data of the base mesh and encoded data of the attributes, which are stored in the content file, and acquiring encoded data of the displacement vector, which is stored in a displacement track of the content file, the displacement track being managed by the selected displacement adaptation set;
decoding each of the acquired encoded data of the base mesh, the acquired encoded data of the attributes, and the acquired encoded data of the displacement vectors; and
reconstructing the mesh of the desired layer by using the base mesh, the attributes, and the displacement vectors that are obtained by the decoding, in which
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh,
the content file includes a base-mesh track that stores the encoded data of the base mesh, an attribute track that stores the encoded data of the attributes, and a plurality of the displacement tracks that stores the encoded data of the displacement vectors of the mutually different layers, and
the control file includes a base-mesh adaptation set that manages the base-mesh track, an attribute adaptation set that manages the attribute track, and the displacement adaptation sets that manage the displacement tracks.

### REFERENCE SIGNS LIST

300 file generation apparatus
311 mesh decimation unit
312 V-DMC encoding unit
313 bitstream generation unit
314 content file generation unit
315 MPD generation unit
400 playback apparatus
411 file acquisition unit
412 MPD analysis unit
413 file processing unit
414 decoding unit
415 reconstruction unit
416 display processing unit
900 computer

1. An information processing apparatus, comprising:
an encoding unit that encodes a base mesh and attributes and encodes displacement vectors for each of layers of levels of detail; and
a content file generation unit that generates a content file, stores encoded data of the base mesh in a base-mesh track of the content file, stores encoded data of the attributes in an attribute track of the content file, stores encoded data of the displacement vectors for each of the layers in mutually different displacement tracks of the content file, and stores first association information for associating the displacement tracks with the layers in the content file, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

2. The information processing apparatus according to claim 1, wherein
the content file generation unit stores, as the first association information, information indicating the layer of the displacement vectors that are stored in the displacement track, in the displacement track.

3. The information processing apparatus according to claim 2, wherein
the content file generation unit further stores type information indicating whether the displacement vectors are absolute displacement vectors or relative displacement vectors, in the displacement track,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

4. The information processing apparatus according to claim 2, wherein
the content file generation unit further stores quality information indicating quality of the base mesh or the displacement vectors in the base-mesh track or the displacement track.

5. The information processing apparatus according to claim 1, wherein
the encoding unit encodes the attributes for each of layers of the levels of detail, and
the content file generation unit stores encoded data of the attributes for each of the layers in the mutually different attribute tracks of the content file and stores second association information for associating the attribute tracks with the displacement tracks in the content file.

6. The information processing apparatus according to claim 5, wherein
the content file generation unit stores, as the second association information, grouping information for grouping the attribute track and the displacement track necessary for reconstruction of the mesh for each of the layers, in the content file.

7. The information processing apparatus according to claim 6, wherein
the content file generation unit further stores information indicating the layer in the content file.

8. An information processing method, comprising:
encoding a base mesh and attributes and encoding displacement vectors for each of layers of levels of detail; and
generating a content file, storing encoded data of the base mesh in a base-mesh track of the content file, storing encoded data of the attributes in an attribute track of the content file, storing encoded data of the displacement vectors for each of the layers in mutually different displacement tracks of the content file, and storing association information for associating the displacement tracks with the layers in the content file, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

9. An information processing apparatus, comprising:
an acquisition unit that acquires encoded data of a base mesh and encoded data of attributes from a content file and acquires, on a basis of first association information for associating displacement tracks with layers of levels of detail of a mesh, encoded data of displacement vectors from the displacement track corresponding to a desired layer of the layers of the content file;
a decoding unit that decodes each of the acquired encoded data of the base mesh, the acquired encoded data of the attributes, and the acquired encoded data of the displacement vectors; and
a reconstruction unit that reconstructs the mesh of the desired layer by using the base mesh, the attributes, and the displacement vectors that are obtained by the decoding, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh, and
the content file includes a base-mesh track that stores the encoded data of the base mesh, an attribute track that stores the encoded data of the attributes, and a plurality of the displacement tracks that stores the encoded data of the displacement vectors of the mutually different layers.

10. An information processing method, comprising:
acquiring encoded data of a base mesh and encoded data of attributes from a content file and acquiring, on a basis of association information for associating displacement tracks with layers of levels of detail of a mesh, encoded data of displacement vectors from the displacement track corresponding to a desired layer of the layers of the content file;
decoding each of the acquired encoded data of the base mesh, the acquired encoded data of the attributes, and the acquired encoded data of the displacement vectors; and
reconstructing the mesh of the desired layer by using the base mesh, the attributes, and the displacement vectors that are obtained by the decoding, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh, and
the content file includes a base-mesh track that stores the encoded data of the base mesh, an attribute track that stores the encoded data of the attributes, and a plurality of the displacement tracks that stores the encoded data of the displacement vectors of the mutually different layers.

11. An information processing apparatus, comprising:
an encoding unit that encodes a base mesh and attributes and encodes displacement vectors for each of layers of levels of detail;
a content file generation unit that generates a content file, stores encoded data of the base mesh in a base-mesh track of the content file, stores encoded data of the attributes in an attribute track of the content file, and stores encoded data of the displacement vectors for each of the layers in mutually different displacement tracks of the content file; and
a control file generation unit that generates a control file including control information for controlling delivery of the content file and stores first association information for associating displacement adaptation sets that manage the displacement tracks with the layers in the control file, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

12. The information processing apparatus according to claim 11, wherein
the control file generation unit further stores type information indicating whether the displacement vectors are absolute displacement vectors or relative displacement vectors, in the displacement adaptation sets of the control file,
the absolute displacement vectors are the displacement vectors indicating displacement of vertices from the base mesh, the vertices being obtained by subdividing the mesh, and
the relative displacement vectors are the displacement vectors indicating displacement of vertices from positions in one lower-level layer, the vertices being obtained by subdividing the mesh.

13. The information processing apparatus according to claim 11, wherein
the control file generation unit further stores quality information indicating quality of the base mesh or the displacement vectors in a base-mesh adaptation set that manages the base-mesh track of the control file or in the displacement adaptation sets of the control file.

14. The information processing apparatus according to claim 11, wherein
the control file generation unit stores, as second association information for associating attribute adaptation sets that manage the attribute tracks with the displacement adaptation sets, information indicating the layers of the attributes that are stored in the attribute tracks that are managed by the attribute adaptation sets, in the attribute adaptation sets of the control file.

15. The information processing apparatus according to claim 11, wherein
the control file generation unit stores, as second association information for associating attribute adaptation sets that manage the attribute tracks with the displacement adaptation sets, a preselection for grouping the attribute adaptation set and the displacement adaptation set that manage tracks necessary for reconstruction of the mesh for each of the layers, in the control file.

16. The information processing apparatus according to claim 15, wherein
the control file generation unit stores information indicating the layer of the attributes that are stored in the attribute track that is managed by the attribute adaptation set, in the preselection.

17. The information processing apparatus according to claim 11, wherein
the control file generation unit stores, as second association information for associating attribute adaptation sets that manage the attribute tracks with the displacement adaptation sets, association identification information for associating the attribute adaptation set and the displacement adaptation set that manage tracks necessary for reconstruction of the mesh for each of the layers with each other, in the control file.

18. An information processing method, comprising:
encoding a base mesh and attributes and encoding displacement vectors for each of layers of levels of detail;
generating a content file, storing encoded data of the base mesh in a base-mesh track of the content file, storing encoded data of the attributes in an attribute track of the content file, and storing encoded data of the displacement vectors for each of the layers in mutually different displacement tracks of the content file; and
generating a control file including control information for controlling delivery of the content file and storing association information for associating displacement adaptation sets that manage the displacement tracks with the layers in the control file, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh, and
the displacement vectors are vector information indicating displacement of vertices obtained by subdividing the base mesh.

19. An information processing apparatus, comprising:
a selection unit that selects, on a basis of first association information for associating displacement adaptation sets with layers of levels of detail of a mesh, one of the displacement adaptation sets, which corresponds to a desired layer of the layers, the first association information being stored in a control file including control information for controlling delivery of the content file;
an acquisition unit that acquires encoded data of the base mesh and encoded data of the attributes, which are stored in the content file, and acquires encoded data of the displacement vector, which is stored in a displacement track of the content file, the displacement track being managed by the selected displacement adaptation set;
a decoding unit that decodes each of the acquired encoded data of the base mesh, the acquired encoded data of the attributes, and the acquired encoded data of the displacement vectors; and
a reconstruction unit that reconstructs the mesh of the desired layer by using the base mesh, the attributes, and the displacement vectors that are obtained by the decoding, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh,
the content file includes a base-mesh track that stores the encoded data of the base mesh, an attribute track that stores the encoded data of the attributes, and a plurality of the displacement tracks that stores the encoded data of the displacement vectors of the mutually different layers, and
the control file includes a base-mesh adaptation set that manages the base-mesh track, an attribute adaptation set that manages the attribute track, and the displacement adaptation sets that manage the displacement tracks.

20. An information processing method, comprising:
selecting, on a basis of first association information for associating displacement adaptation sets with layers of levels of detail of a mesh, one of the displacement adaptation sets, which corresponds to a desired layer of the layers, the first association information being stored in a control file including control information for controlling delivery of the content file;
acquiring encoded data of the base mesh and encoded data of the attributes, which are stored in the content file, and acquiring encoded data of the displacement vector, which is stored in a displacement track of the content file, the displacement track being managed by the selected displacement adaptation set;
decoding each of the acquired encoded data of the base mesh, the acquired encoded data of the attributes, and the acquired encoded data of the displacement vectors; and
reconstructing the mesh of the desired layer by using the base mesh, the attributes, and the displacement vectors that are obtained by the decoding, wherein
the base mesh is a mesh that is generated by decimating vertices from an original mesh as an encoding target, the original mesh being constituted by vertices and connections representing a three-dimensional structure of an object, the mesh being lower in the level of detail than the original mesh,
the attributes include textures that are applied to surfaces of the original mesh,
the displacement vectors are vector information indicating displacement of vertices obtained by subdividing the base mesh,
the content file includes a base-mesh track that stores the encoded data of the base mesh, an attribute track that stores the encoded data of the attributes, and a plurality of the displacement tracks that stores the encoded data of the displacement vectors of the mutually different layers, and
the control file includes a base-mesh adaptation set that manages the base-mesh track, an attribute adaptation set that manages the attribute track, and the displacement adaptation sets that manage the displacement tracks.
